(19) United States
(12) Patent Application Publication
(10) Pub. No.: US 2006/0281429 A1
(43) Pub. Date: Dec. 14, 2006

(54) Downconverter and upconverter

(75) Inventors: Takahiko Kishi, Tsurumi-ku (JP); Takahiro Sato, Tsurumi-ku (JP)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/414,078

(22) Filed: Apr. 28, 2006

(30) Foreign Application Priority Data
Apr. 28, 2005 (JP) 2005-133240

(51) Int. Cl. H04B 1/26

(52) U.S. Cl. 455/313

(57) ABSTRACT

A downconverter and upconverter are provided which can obtain a satisfactory image rejection ratio in a low-Intermediate Frequency (IF) scheme while reducing power consumption, and can improve Error Vector Magnitude (EVM) in a zero-IF scheme. A complex-coefficient transversal filter rejects one side of a positive or negative frequency, and converts a Radio Frequency (RF) signal to a complex RF signal configured by real and imaginary parts. A local oscillator outputs a complex local signal in which a set frequency is set as a center frequency. A full-complex mixer, connected to the complex-coefficient transversal filter and the local oscillator, perform a frequency conversion process by multiplying a complex signal output from the complex-coefficient transversal filter and the complex local signal output from the local oscillator, and outputs a complex signal of a frequency separated by the set frequency from a frequency of the RF signal.

### PRIORITY

This application claims priority under 35 U.S.C. § 119 to an application entitled “Downconverter and Upconverter” filed in the Japan Patent Office on Apr. 28, 2005 and assigned Serial No. 2005-133240, the contents of which are incorporated herein by reference.

### BACKGROUND OF THE INVENTION

1. Field of the Invention

The present invention relates to a downconverter for performing frequency conversion in a receiver and an upconverter for performing frequency conversion in a transmitter.

2. Description of the Related Art

a. Background Technology of Downconverter of Low-Intermediate Frequency (IF) Scheme

A communication device which functions both as a receiver and a transmitter like a mobile phone receives a modulated Radio Frequency (RF) signal carrying speech content and data communication content and converts the received RF signal to a frequency to be input to a demodulator. Front-end structures for selecting a channel to select a target signal include a heterodyne scheme for converting an RF signal to an Intermediate Frequency (IF) signal, and a low-IF scheme for converting an RF signal to an IF signal using an image rejection mixer (or a half-complex mixer for a real input and a complex output) for rejecting an image frequency signal.

The heterodyne scheme increases the frequency of an IF signal and increases a difference between a frequency of a target signal and an image frequency in an RF part before frequency conversion, thereby rejecting an image frequency signal by means of an RF filter and avoiding interference of the image frequency signal (hereinafter, referred to as image frequency interference).

A concrete example of the heterodyne scheme, is a full-duplex radio device for simultaneously performing transmission and reception operations that rejects a transmission frequency signal or a transmission signal (hereinafter, referred to as an image frequency signal) close to an image frequency when a local signal is common between transmission and reception. If a filter of an RF signal (hereinafter, referred to as an RF filter) cannot completely reject a generated image frequency signal when the RF signal is converted to an IF signal, a frequency of the IF signal is changed between all radio communication schemes and a frequency of the image frequency signal is changed, such that the RF filter can reject the image frequency signal. For this reason, a multi-mode radio device for supporting multiple communication schemes changes the frequency of the IF signal in every mode according to channel bandwidths different between the modes (or communication schemes). Moreover, the multi-mode radio device needs to be provided with a filter of the IF signal (hereinafter, referred to as an IF filter) different between center frequencies or pass frequencies of the modes. In this case, there is a problem in that circuit size significantly increases.

A downconverter 8 of the low-IF scheme as illustrated in FIG. 34 performs frequency conversion using an image rejection mixer (corresponding to a mixer for a real input and a complex output (or a type of half-complex mixer) configured as a mixer-I 814 and a mixer-Q 815 that are provided with a multiplier connected to a local oscillator (Localb) 813 for outputting a local signal, respectively. The local oscillator (Localb) 813 and the above-described image rejection mixer configure a frequency converter. An undesired signal present in a symmetric position of the low frequency side corresponding to a frequency value of the IF signal with respect to the frequency of the target signal (i.e., an image frequency signal) is rejected on the basis of a frequency of the local signal without depending on frequency characteristics of the RF and IF filters. Here, a rejection ratio of an image frequency signal is expressed by an image rejection ratio, as described below. The image rejection ratio can decrease the frequency of the IF signal, because dependency on the characteristics of the RF filter is low.

Because a frequency corresponding to twice an IF signal frequency is a frequency interval between the target signal frequency and the image frequency, an image frequency of a target channel is the next channel adjacent to the target channel when the frequency of the IF signal is equal to a channel interval.

For example, the downconverter 8 satisfies the specification of an associated radio scheme when an image rejection ratio associated with a requirement specification, such as blocking for an image frequency signal separated by twice a frequency of the IF signal from a frequency of a target IF signal, is less than the image rejection ratio of the downconverter 8 of the low-IF scheme in a radio communication scheme using the downconverter.

Because the structure of the low-IF scheme can decrease the frequency of the IF signal, the IF filter can be configured by an active filter and an integrated circuit (IC) device can be easily miniaturized. Further because the frequency of the IF signal does not need to be changed according to each radio communication scheme in the multi-mode radio device, the IF filter can be commonly employed.

Also because the channel bandwidths are different between the communication schemes in the above-described multi-mode radio device, the bandwidth of the IF filter must be changed according to each radio communication scheme. However, the low-IF scheme can easily vary characteristics of the IF filter using a transconductance-capacitor (gmC) filter for varying transconductance (gm) of a transistor, if needed. When a structure of the low-IF scheme is applied to the multi-mode radio device, one IF filter can be provided because multiple IF filters are not needed. Consequently such that the multi-mode radio device can be realized in a small circuit size.

The structure of the low-IF scheme may ensure only the image rejection ratio of about 30 dB as described in Phillips SA1920 data sheet and Phillips SA1921 data sheet. The structure of the low-IF scheme can be applied to the radio communication scheme whose specifications such as blocking for an image frequency signal, etc. are not strict. However, there is a problem in that an associated requirement specification cannot be satisfied and the low-IF scheme cannot be applied, when the robustness to interference of more than 30 dB is required.

For example, the low-IF scheme can be applied because a requirement specification of the interference robustness such as blocking for an image frequency signal at a frequency within 300 kHz from a target signal frequency is 18 dB in Global System for Mobile Communication (GSM™). On the other hand, because a requirement specification of interference robustness for an adjacent channel separated by 5 MHz from a frequency of a target signal is 33 dB in Wideband Code Division Multiple Access (W-CDMA), this is borderline performance with respect to the image rejection ratio of 30 dB as described above when practical use is considered. A need exists for precision improvement for better selection of a mixer used in a device or an image rejection ratio, such that the low-IF scheme can satisfy an associated requirement specification. To achieve precision improvement, a large chip area may be required and costs may increase. The image rejection ratio of about 30 dB is not a value capable of being easily realized. To realize the image rejection ratio of about 30 dB, a size of an associated transistor needs to be increased such that the image rejection ratio of a mixer due to performance variation of a used transistor can be prevented from being reduced. In this case, there is a problem in that all characteristics except the image rejection ratio are degraded due to an increase in consumption power and a decrease in a transition frequency, fT.

The GSM™ or W-CDMA uses a digital tuner or a software radio front-end for converting a frequency in an RF part and selecting a channel from a plurality of channels in a digital part. In this case, a requirement specification of interference robustness such as blocking for an image frequency signal at a frequency separated by more than 300 kHz from a frequency of a target signal is more than 50 dB, for example, in the GSM™. When the same requirement specification exceeds the image rejection ratio capable of being realized by the image rejection mixer also in the W-CDMA, the channel selection of the digital part is actually impossible. Accordingly, the low-IF scheme cannot be applied to the digital tuner or the software radio front-end.

A radio communication scheme requiring the robustness to image frequency interference of more than 30 dB, while solving the above-described problem, employs a structure of the low-IF scheme. The scheme may include following method to obtain an image rejection ratio of more than 40 dB using the above-described image rejection mixer.

A method can be considered that rejects an image frequency signal through an RF filter by increasing a frequency of an IF signal and increasing a difference between a target signal frequency and an image frequency in the RF part before frequency conversion. However, when the IF signal frequency is increased, existing radio device for performing frequency processing through digital processing have a problem in that power consumption increases due to a clock increase in an analog-to-digital converter (ADC) for converting an IF signal to a digital signal and a digital signal processor for processing an output of the ADC. A sub-nyquist sampling technique, used for the clock reduction in the ADC, is well known. In this case, an input frequency band of the ADC is widened, such that power consumption increases as before the clock reduction in the ADC. There is a problem in that power consumption increases if the IF signal frequency also increases when the IF signal is processed in an analog form.

Next, there can be considered a method for correcting characteristics of the image rejection mixer through a correction process based on a digital process as in a dual-band RF front-end IC described in Phillips SA1920 data sheet and Phillips SA1921 data sheet, and a correction process based on an analog circuit process described in Japanese Patent No. 298827 and Japanese Patent Laid-Open No. 2000-224497. However, there is a problem in that power consumption increases according to a computational process in a digital using a digital correction process. There is another problem in that a size of a correction circuit for a correction based on an analog process increases and correction precision is poor.

Next, a method can be considered for rejecting an image frequency signal by providing a phase shifter in an RF part, obtaining a phase difference of 90 degrees in an associated phase shifter, generating a complex RF signal, and performing frequency conversion by multiplying the complex RF signal by a complex local signal as described in “Mixer Topology Selection for a Multi-Standard High Image-Reject Front-End”, Vojkan Vidojkovic, Johan van der Tang, Arjan Leeuwenburgh and Arthur van Roermumd, ProRISC Workshop on Circuits, Systems and Signal Processing, pp. 526-530, 2002 (hereinafter “Mixer Topology Selection for a Multi-Standard High Image-Rejected Front End”) and FIG. 3.25(b) of “CMOS WIRELESS TRANSCEIVER DESIGN”, Jan Crols, Michiel Steyaert, Kluwer International Series in Engineering and Computer Science, 1997 (hereinafter “CMOS WIRELESS TRANSCEIVER DESIGN”). This method has a problem in that loss occurs in the phase shifter. The loss in the phase shifter increases, for example, when a degree of the phase shifter is increased to widen a band. Due to this loss, reception sensitivity is degraded. The method has another problem in that practical precision cannot be obtained in the phase shifter configured as a Resistor-Capacitor (RC) circuit when input/output impedance is considered because R and C values are small in the RF of a high frequency.

Next, a method can be considered for rejecting an image frequency signal by frequency-converting an RF signal, generating a complex signal, and performing complex multiplication with a complex local signal through a mixer using the complex local signal as illustrated in FIG. 3.28 and FIG. 3.31 of “CMOS WIRELESS TRANSCEIVER DESIGN”. However, there are problems in that power consumption increases because the number of mixers and the number of local signal oscillators are increased to generate complex signals from the mixers using complex local signals and spurious reception occurs due to the increased number of local signal oscillators.

b. Background Technology of Dual-Conversion Downconverter of Low-IF Scheme

There is a dual-conversion downconverter for converting an RF signal to an IF signal through two frequency conversion processes as another example of the above-described heterodyne scheme. As described above, a downconverter for converting an RF signal to an IF signal through one frequency conversion process is referred to as a single-conversion downconverter.

If a frequency of an IF signal (hereinafter, referred to as a first IF signal) generated by the first frequency conversion process is lower than an RF signal frequency when an RF signal of a wide frequency range is received in the dual conversion downconverter, an image frequency is close to a frequency of a target signal. Therefore, a pass band varies with a received frequency. When a variable RF filter for obtaining an attenuation amount required for the image frequency is not used, an image rejection ratio cannot be ensured. It is difficult for spurious reception to be avoided according to a combination of an IF signal, an N multiple of the IF signal, a local signal, and an M multiple of the local signal where N and M are integers. When the image frequency is close to the target signal frequency as described above, a pass band of the variable RF filter requires steep characteristics. Therefore, a filter size increases and fine adjustment is required for pass band characteristics of the filter, because an allowable error is small when variation or tuning is made in relation to cutoff characteristics.

This problem can be addressed when a frequency of the first IF signal is higher than the RF signal frequency and the image frequency is far away from the target signal frequency. After up-converting the frequency of the first IF signal to more than the RF signal frequency, the dual-conversion downconverter down-converts the frequency according to the second frequency conversion process. Here, an IF signal generated by the second frequency conversion process is referred to as a second IF signal.

To avoid image frequency interference of the second IF signal occurring at the time of frequency conversion from the first IF signal to the second IF signal, a first IF filter is required to have a sufficient attenuation amount for the image frequency of the second IF signal. When the frequency of the second IF signal is low, the first IF filter is required to have very steep transition band characteristics and has a problem in that a filter size or filter insertion loss increases. Because the frequency of the first IF signal is high, the first IF filter is required to widen a pass band by considering a change due to the variation of a center frequency or temperature. In this case, there is a problem in that a requirement specification for the first IF filter is strict. For this reason, is a method is adopted for mitigating the strict requirement of the first IF filter by increasing the frequency of the second IF signal.

When the frequency of the second IF signal increases, a clock frequency of the ADC for a demodulation process needs to be high. There is a problem in that power consumption increases due to an increase in a clock frequency of the ADC or an increase in an input bandwidth of the ADC adopting the sub-nyquist sampling.

It is considered that a structure based on the low-IF scheme in the single-conversion downconverter is introduced for the second IF signal in the dual-conversion downconverter to address the above-described problem. That is, an image rejection mixer is considered for rejecting image frequency interference to the target signal by converting the first IF signal to the second IF signal on the basis of a complex local signal. Therefore, a desired image rejection ratio can be ensured without steeply varying the characteristics of the first IF filter. In this case, the first IF signal and the second IF signal correspond to an RF signal and an IF signal of the single-conversion downconverter.

However, the structure based on the low-IF scheme has a problem in that the image rejection ratio of about 30 dB is only ensured as in the single-conversion downconverter. A method for improving the image rejection ratio is followed by an increase in power consumption like the improvement method for the single-conversion downconverter.

c. Background Technology of Upconverter of Low-IF Scheme

For a transmitter of a mobile phone, an upconverter has a structure for converting a baseband signal including speech content and data communication content to an RF signal. That is, the structure generates a real IF signal by mixing a complex baseband signal with a complex local signal and generates a real RF signal by mixing the real IF signal with a real local signal.

To reject an image frequency signal of an IF signal in an RF filter of the upconverter, an IF signal frequency needs to be increased according to a broad system bandwidth and needs to be further increased according to a broad RF band corresponding to a broad channel band due to a high communication rate. Therefore, there is a problem in that cost and power consumption increase in an IF signal processor. Moreover, there is a problem in that a strict requirement specification is applied for the RF filter when the IF signal frequency is desired to be reduced.

To address these problems, the upconverter rejects an image frequency signal and adopts the low-IF scheme in which a low IF is possible by converting a complex baseband signal to a complex IF signal in a full-complex mixer serving as a type of image rejection mixer, and mixing the complex IF signal with a complex local signal in a half-complex mixer like the downconverter based on the above-described low-IF scheme. According to the effect of rejecting the image frequency signal in the image rejection mixer of this structure, an RF filter for rejecting the image frequency signal of the IF signal is unnecessary. A requirement specification for a Surface Acoustic Wave (SAW) filter of an RF signal is significantly mitigated. This structure requires only a one-step SAW filter rather than two-step SAW filters conventionally needed for the RF signal. In some cases, a SAW filter for the RF signal is unnecessary.

From Phillips, SA1920 data sheet and Phillips, SA1921 data sheet, it can be seen that an image frequency signal of −30 dBc is estimated as a spurious transmission component in terms of the performance of an image rejection ratio of the image rejection mixer used for reception. This exceeds an allowable mask of the spurious transmission component and does not satisfy the specification.

Because the upconverter of the structure based on the low-IF scheme cannot completely remove the image frequency signal, the image frequency signal appears at a target frequency. FIG. 38 illustrates a spectrum of a complex IF signal with a center frequency of 5 MHz frequency-converted from a Double Side Band (DSB) signal with a carrier interval of 1.6 MHz of a complex baseband in a conventional upconverter 38 of the low-IF scheme of FIG. 37. FIG. 39 illustrates a spectrum of a real signal output when the complex IF signal is mixed with a complex local signal (of 795 MHz) in which an error of 10% is present between amplitudes (or levels) of a real part signal I corresponding to a real part (of an in-phase component) and an imaginary part signal Q corresponding to an imaginary part (of a quadrature phase component). In FIG. 39, an image frequency signal of −26 dBc occurs with respect to a target signal (800 MHz) at the image frequency (790 MHz).

If the image rejection ratio of only about −30 dBc can be ensured, a spurious mask near a target signal does not satisfy an associated specification, as in the upconverter of the low-IF scheme. There is a problem in that an associated specification may not be stably satisfied because the image rejection ratio may be reduced due to variation of the image rejection mixer or variation of environment conditions, even though the specification of an associated spurious mask can be almost satisfied.

To obtain an image rejection ratio of more than 40 dB using the above-described image rejection mixer, the following method is considered. First, use of the RF filter to improve the image rejection ratio is considered. However, the frequency of the IF signal cannot be reduced to mitigate the requirement of the RF filter. As described above, there is a problem in that the cost and power consumption of the IF signal processor increase.

To reduce degradation of the image rejection ratio of a mixer due to variation of a transistor used therefor, a method may be attempted increasing transistor size. According to this method, as the power consumption of the transistor increases, the transition frequency, fT, decreases, and all characteristics except the image rejection ratio are degraded. Because of the inaccuracy of an analog circuit, it is difficult for an image rejection ratio for satisfying the specification to be obtained.

As illustrated in “Mixer Topology Selection for a Multi-Standard High Image-Reject Front-End” and FIG. 3.28 and FIG. 3.31 of “CMOS WIRELESS TRANSCEIVER DESIGN”, a method is adopted in which a signal process using a polyphase filter of an RF signal used in a receiver is applied in a transmitter. That is, a mixer for mixing a complex IF signal and a complex local signal is set as a full-complex mixer for outputting a complex RF signal. The polyphase filter rejects a negative frequency component of the complex RF signal of the mixer output. However, because the method is theoretically excellent but the polyphase filter is implemented with an RC circuit, loss becomes large and a band becomes narrow. There are problems in that loss is further increased, the image rejection ratio of a filter output is reduced, and utility is degraded when the number of steps increases to obtain a high attenuation level or a wide band.

Next, there is considered a method for obtaining a complex IF signal to be input to the above-described full-complex mixer by converting a baseband signal to a complex signal in the half-complex mixer, as illustrated in FIG. 3.28 and FIG. 3.31 of “CMOS WIRELESS TRANSCEIVER DESIGN”. However, this method has a problem of an increase of consumption power and a problem of spurious reception occurs due to the increased number of local signal oscillators because the number of mixers and the number of local signal oscillators are increased.

d. Background Technology of Downconverter of Zero-IF Scheme

Among downconverters for converting an RF or IF signal to a complex baseband signal, a downconverter 68 based on the zero-IF scheme illustrated in FIG. 57 is an example in which a circuit is very simplified and is easily miniaturized. The downconverter 68 multiplies a real RF signal by a complex local signal with the same frequency as that of the real RF signal, performs a frequency conversion process in which a center frequency is frequency zero (or a direct current (DC) component), and generates a complex signal.

The downconverter of the zero-IF scheme has an advantage in that it can be miniaturized, as compared with the single-conversion and dual-conversion downconverters for performing the above-described multi-step frequency conversion. A problem of a DC offset occurs when leakage of the local signal is self-received in the mixer. When the second-order intermodulation (IM2) occurs due to non-linearity of the mixer, a problem of interference to a target signal occurs due to distortion. In this case, a problem of the Error Vector Magnitude (EVM)-related degradation occurs. When multi-level modulation is performed at a high communication rate, EVM-related degradation becomes an important problem.

When real and imaginary part signals I and Q of a local signal are not completely orthogonal after processing in the mixer, the problem of the EVM-related degradation due to incompleteness occurs as described above.

To prevent the EVM-related degradation, technology is being developed to improve characteristics of a circuit that reduces an amplitude error and a phase error between the real and imaginary part signals I and Q of the local signal and reduces an error between transistors configuring the mixer. Many technologies are being developed to prevent the EVM-related degradation by compensating for an error between the real and imaginary part signals I and Q utilizing digital signal processing after a complex baseband signal is converted to a digital signal.

However, the improvement of circuit characteristics is limited because of incompleteness of an analog circuit. Specifically, degradation due to interference between codes in the multi-level modulation and degradation due to interference between carriers in Orthogonal Frequency Division Multiplexing (OFDM) occur. As described in “Analysis on Characteristic Deterioration of a MIMO Communication System Due to Incompleteness of an RF System”, Hiroyuki Kamada, Kei Mizutani, Kei Sakaguchi, Kiyomichi Araki, the 2004 Institute of Electronics, Information and Communication Engineers (IEICE) Communications Society Conference, pp. 357, 2004, a Multiple-Input Multiple-Output (MIMO) scheme serving as a communication scheme for a wireless Local Area Network (LAN) aims to perform high-speed communication in a limited frequency band as compared with the conventional communication scheme. There is a problem in that a practical communication rate is less than a theoretical upper limit and high-speed communication is interrupted because of a limit of error improvement.

Moreover, compensation technology in a digital signal process has a problem in that an increase in throughput is followed by an increase in power consumption.

e. Background Technology of Upconverter of Zero-IF Scheme

Among upconverters for converting a complex baseband signal to an RF signal, an upconverter of the zero-IF scheme is an example in which a circuit is very simple and is easily miniaturized. The upconverter based on the zero-IF scheme multiplies a complex baseband signal by a complex local signal with the same frequency as that of a real RF signal in a mixer, performs frequency conversion to a frequency of an RF signal, and outputs the real RF signal.

As compared with the upconverters for performing the above-described multi-step frequency conversion, the upconverter of the zero-IF scheme has an advantage in that it can be miniaturized, but has the following problems. That is, there is a problem in that carrier leakage associated with the DC offset in the downconverter of the zero-IF scheme occurs. Like the downconverter of the zero-IF scheme, the upconverter of the zero-IF scheme has a problem in that the EVM-related degradation due to incompleteness occurs when real and imaginary part signals I and Q of a local signal are not completely orthogonal after processing in the mixer. Like the downconverter of the zero-IF scheme, the upconverter of the zero-IF scheme has a problem in EVM improvement.

The problems of the downconverter and upconverter of the respective schemes are summarized as follows. The important problems in the downconverter and upconverter of the low-IF scheme occur when a sufficient image rejection ratio cannot be obtained and power consumption increases. The important problems in the downconverter and upconverter of the zero-IF scheme are EVM-related degradation at a high communication rate and an increase in power consumption.

There are increasing market needs for the downconverter and upconverter of the low-IF scheme and the zero-IF scheme capable of processing a broadband or multi-band RF signal. The problems of the low-IF scheme and the zero-IF scheme must be able to be addressed and a broadband or multi-band must be provided.

### SUMMARY OF THE INVENTION

Accordingly, the present invention has been designed to solve the above and other problems. Therefore, it is an object of the present invention to provide a downconverter and upconverter that can reduce power consumption, obtain a sufficient image rejection ratio in a low-Intermediate Frequency (IF) scheme, and improve Error Vector Magnitude (EVM) in a zero-IF scheme.

In accordance with an aspect of the present invention, there is provided a downconverter for converting a Radio Frequency (RF) signal to a low frequency, including a complex-coefficient transversal filter for generating a real part of a complex RF signal by performing a convolution integral according to a generated impulse response based on an even function for an input RF signal, generating an imaginary part of the complex RF signal by performing a convolution integral according to a generated impulse response based on an odd function for the input RF signal, rejecting one side of a positive or negative frequency, and outputting the complex RF signal; a local oscillator for outputting a complex local signal with a predetermined frequency; and a complex mixer, connected to the complex-coefficient transversal filter and the local oscillator, for performing a frequency conversion process by multiplying the complex RF signal output from the complex-coefficient transversal filter and the complex local signal output from the local oscillator, and outputting a complex signal of a frequency separated by the predetermined frequency from a frequency of the RF signal.

In accordance with another aspect of the present invention, there is provided an upconverter for converting a complex signal to a frequency of a Radio Frequency (RF) signal, including a local oscillator for outputting a complex local signal with a predetermined frequency; a complex mixer, connected to the local oscillator, for performing a frequency conversion process by multiplying an input complex signal and the complex local signal output from the local oscillator, and outputting a complex RF signal; and a complex-coefficient transversal filter, connected to the complex mixer, for performing a convolution integral according to a generated impulse response based on an even function for a real part of the complex RF signal output from the complex mixer, performing a convolution integral according to a generated impulse response based on an odd function for an imaginary part of the complex RF signal output from the complex mixer, rejecting one side of a positive or negative frequency, and outputting a real RF signal.

### BRIEF DESCRIPTION OF THE DRAWINGS

The above and other objects and advantages of the present invention will be more clearly understood from the following detailed description taken in conjunction with the accompanying drawings, in which:

FIG. 1 is a block diagram illustrating a structure of a downconverter 1 of a first basic structure of a single-conversion downconverter based on a low-Intermediate Frequency (IF) scheme in accordance with the present invention;

FIG. 2 is a block diagram illustrating a structure of a downconverter 1a of a first basic structure of a dual-conversion downconverter based on the low-IF scheme in accordance with the present invention;

FIG. 3 illustrates an impulse response of a real part of a complex-coefficient transversal filter 115 used in the downconverters 1 and 1a;

FIG. 4 illustrates an impulse response of an imaginary part of the complex-coefficient transversal filter 115 used in the downconverters 1 and 1a;

FIG. 5 illustrates a spectrum of a complex signal S11B from output terminals OrpI and OrpQ of the complex-coefficient transversal filter 115 and frequency characteristics of the complex-coefficient transversal filter 115 within the downconverters 1 and 1a;

FIG. 6 illustrates a process for rejecting an image frequency signal on a complex frequency axis in a half-complex mixer within conventional downconverters 8 and 8a based on the low-IF scheme;

FIG. 7 illustrates a spectrum of a complex signal S11C from output terminals OcmI and OcmQ of a full-complex mixer 117 within the downconverters 1 and 1a based on the low-IF scheme in accordance with the present invention;

FIG. 8 illustrates a process for rejecting an image frequency signal on a complex frequency axis in the complex-coefficient transversal filter 115 and the full-complex mixer 117 within the downconverters 1 and 1a;

FIG. 9 illustrates a spectrum of a complex signal S11C corresponding to an output signal of the full-complex mixer 117 when a frequency of the complex signal S11C corresponding to an IF signal is set to 25 MHz within the downconverters 1 and 1a;

FIG. 10 illustrates an internal structure of a complex-coefficient Surface Acoustic Wave (SAW) filter 150 within the downconverters 1 and 1a;

FIG. 11 illustrates an internal structure of a complex-coefficient SAW filter 157 within the downconverters 1 and 1a;

FIG. 12 is a block diagram illustrating a structure of a downconverter 2 of a second basic structure of the single-conversion downconverter based on the low-IF scheme in accordance with the present invention;

FIG. 13 illustrates a structure of a complex-coefficient transversal filter used as a complex-coefficient filter 134 in the downconverters 2 and 2a;

FIG. 14 illustrates an impulse response of a real part of a complex-coefficient transversal filter used as a complex-coefficient filter 134 in the downconverters 2 and 2a;

FIG. 15 illustrates an impulse response of an imaginary part of the complex-coefficient transversal filter used as the complex-coefficient filter 134 in the downconverters 2 and 2a;

FIG. 16 illustrates a spectrum of a complex signal S12A from output terminals of the complex-coefficient transversal filter used as the complex-coefficient filter 134 in the downconverters 2 and 2a;

FIG. 17 is a block diagram illustrating a structure of the downconverter 2a of a second basic structure of the dual-conversion downconverter based on the low-IF scheme in accordance with the present invention;

FIG. 18 illustrates an internal structure of a complex coefficient SAW filter 340 within downconverters 4 and 5 in accordance with first and second embodiments of the present invention;

FIG. 19 is a block diagram illustrating a structure of a downconverter 3 of a third basic structure of the single-conversion downconverter based on the low-IF scheme in accordance with the present invention;

FIG. 20 is a block diagram illustrating a structure of a downconverter 3a of a third basic structure of the dual-conversion downconverter based on the low-IF scheme in accordance with the present invention;

FIG. 21 is a block diagram illustrating a structure of an upconverter 31 of a first basic structure of an upconverter based on the low-If scheme in accordance with the present invention;

FIG. 22 illustrates a spectrum of a complex signal S30E from input terminals IrpI and IrpQ of a complex-coefficient transversal filter 310 of the upconverter 31 and frequency characteristics of the complex-coefficient transversal filter 310;

FIG. 23 illustrates a spectrum of a signal from output terminals of the complex-coefficient transversal filter 310 within the upconverter 31;

FIG. 24 illustrates an internal structure of a complex-coefficient SAW filter 360 within upconverters 34 and 35 in accordance with first and second embodiments of the present invention;

FIG. 25 illustrates a structure of a single-conversion downconverter 4 based on the low-IF scheme in accordance with a first embodiment of the present invention;

FIG. 26 is a block diagram illustrating a structure of a single-conversion downconverter 5 based on the low-IF scheme in accordance with a second embodiment of the present invention;

FIG. 27 is a block diagram illustrating a structure of a single-conversion downconverter 6 based on the low-IF scheme in accordance with a third embodiment of the present invention;

FIG. 28 illustrates an internal structure of a complex-coefficient SAW filter 350 within the downconverter 6;

FIG. 29 is a block diagram illustrating a structure of a dual-conversion downconverter 6a based on the low-IF scheme in accordance with a third embodiment of the present invention;

FIG. 30 is a block diagram illustrating a structure of a single-conversion downconverter 7 based on the low-IF scheme in accordance with a fourth embodiment of the present invention;

FIG. 31 is a block diagram illustrating a structure of a dual-conversion downconverter 7a based on the low-IF scheme in accordance with a fourth embodiment of the present invention;

FIG. 32 is a block diagram illustrating a structure of the upconverter 34 based on the low-IF scheme in accordance with the first embodiment of the present invention;

FIG. 33 is a block diagram illustrating a structure of the upconverter 35 based on the low-IF scheme in accordance with the second embodiment of the present invention;

FIG. 34 is a block diagram illustrating an example of a structure of a conventional single-conversion downconverter 8 based on the low-IF scheme;

FIG. 35 is a block diagram illustrating an example of a structure of a conventional dual-conversion downconverter 8a based on the low-IF scheme;

FIG. 36 illustrates a spectrum of a signal from output terminals of a half-complex mixer within the downconverters 8 and 8a;

FIG. 37 is a block diagram illustrating an example of a structure of a conventional upconverter 38 based on the low-IF scheme;

FIG. 38 illustrates spectra of signals from input terminals of a half-complex mixer 313 within the upconverter 38 and input terminals of a full-complex mixer 309 within the upconverter 31 in the example of the basic structure in accordance with the present invention;

FIG. 39 illustrates a spectrum of a signal from output terminals of the half-complex mixer 313 within the upconverter 38;

FIG. 40 is a block diagram illustrating an example of a structure of a downconverter 40 corresponding to an example of a basic structure of a downconverter based on a zero-IF scheme or a quasi-zero-IF scheme in accordance with the present invention;

FIG. 41 illustrates frequency characteristics of a complex-coefficient transversal filter used as a complex-coefficient filter 513 within the downconverter 40;

FIG. 42 illustrates an impulse response of a real part of the complex-coefficient transversal filter used as the complex-coefficient filter 513 within the downconverter 40;

FIG. 43 illustrates an impulse response of an imaginary part of the complex-coefficient transversal filter used as the complex-coefficient filter 513 within the downconverter 40;

FIG. 44 illustrates a process for suppressing Error Vector Magnitude (EVM)-related degradation on the complex frequency axis in a half-complex mixer 517 within a conventional downconverter 48 based on the zero-IF scheme;

FIG. 45 illustrates a process for suppressing EVM-related degradation on the complex frequency axis in the complex-coefficient filter 513 and the full-complex mixer 515 within the downconverter 40;

FIG. 46 is a block diagram illustrating an example of a structure of the upconverter 60 based on the zero-IF scheme corresponding to an example of a basic structure in accordance with the present invention;

FIG. 47 illustrates a process for suppressing EVM-related degradation on the complex frequency axis in a half-complex mixer 713 within a conventional upconverter 68 based on the zero-IF scheme;

FIG. 48 illustrates a process for suppressing EVM-related degradation on the complex frequency axis in a full-complex mixer 706 and a complex-coefficient filter 707 within the upconverter 60;

FIG. 49 is a block diagram illustrating an example of a structure of an upconverter 63 based on the quasi-zero-IF scheme corresponding to the example of the basic structure in accordance with the present invention;

FIG. 50 is a block diagram illustrating an example of a structure of the downconverter 44 based on the zero-IF scheme or the quasi-zero-IF scheme in accordance with an embodiment of the present invention;

FIG. 51 illustrates an internal structure of a complex-coefficient SAW filter 518 within a downconverter 44;

FIG. 52 illustrates an internal structure of a complex-coefficient SAW filter 187 within the downconverter 44;

FIG. 53 is a block diagram illustrating an example of a structure of an upconverter 64 based on the zero-IF scheme or the quasi-zero-IF scheme in accordance with an embodiment of the present invention;

FIG. 54 illustrates an internal structure of a complex-coefficient SAW filter 740 within the upconverter 64;

FIG. 55 illustrates an internal structure of a complex-coefficient SAW filter 750 within the upconverter 64;

FIG. 56 is a block diagram illustrating an example of a structure of the conventional downconverter 48 based on the zero-IF scheme; and

FIG. 57 is a block diagram illustrating an example of a structure of the conventional upconverter 68 based on the zero-IF scheme.

### DETAILED DESCRIPTION OF THE PREFERRED EMBODIMENTS

A preferred embodiment of the present invention will now be described in detail with reference to the annexed drawings. In the drawings, the same or similar elements are denoted by the same reference numerals even though they are depicted in different drawings. In the following description, a detailed description of known functions and configurations incorporated herein has been omitted for conciseness.

A. Principle of Single or Dual-Conversion Downconverter of Low-Intermediate Frequency (IF) Scheme

Here, the principle of rejecting an image frequency signal in a single or dual-conversion converter of the present invention will be described with reference to an example of a basic structure of the single-conversion downconverter.

B. Example of First Basic Structure of Downconverter of Low-IF Scheme

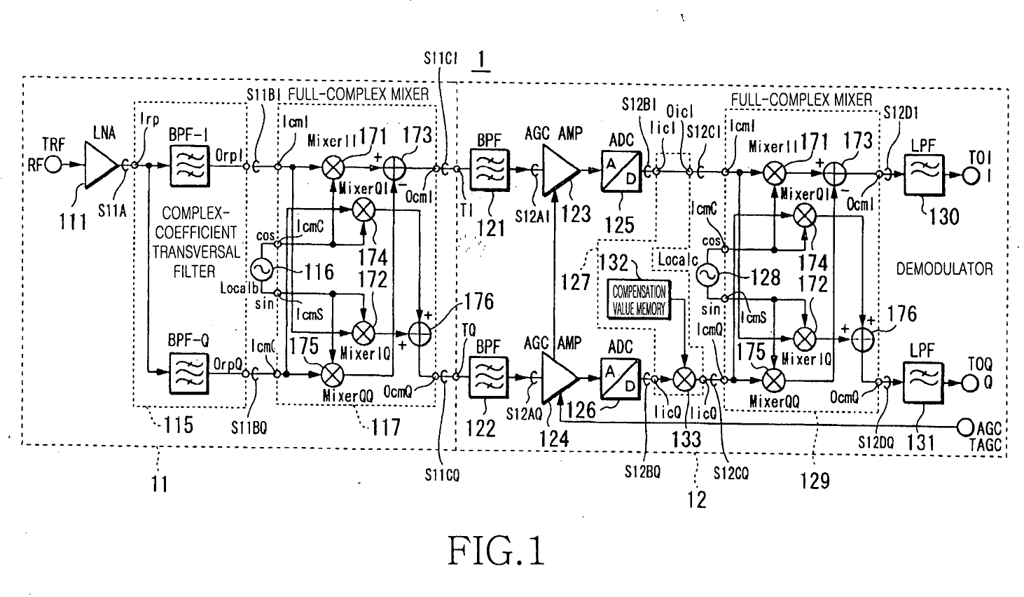

An example of a first basic structure of a downconverter based on a low-IF scheme in accordance with the present invention will be described with reference to FIG. 1. The single-conversion downconverter 1 is provided with an IF generator 11 for converting, for example, a Radio Frequency (RF) signal, input from an input terminal TRF connected to an antenna, to an IF signal and a baseband generator 12 for converting an IF signal coupled to a demodulator to a baseband signal. For example, the baseband generator 12 outputs a modulation signal multiplied by an RF signal to output terminals TOI and TOQ. The IF generator 11 and the baseband generator 12 are connected to terminals TI and TQ.

The IF generator 11 is provided with a Low Noise Amplifier (LNA) 111, a complex-coefficient transversal filter 115, a local oscillator (Localb) 116, and a full-complex mixer (or complex mixer) 117. The complex-coefficient transversal filter 116 rejects an image frequency as described below.

The complex-coefficient transversal filter 115 is provided with a Band Pass Filter (BPF)-I and a BPF-Q. An input terminal Irp of the complex-coefficient transversal filter 115 is commonly connected between input terminals of the BPF-I and the BPF-Q. An output terminal OrpI of the complex-coefficient transversal filter 115 is connected to an output terminal of the BPF-I and an output terminal OrpQ of the complex-coefficient transversal filter 115 is connected to an output terminal of the BPF-Q.

The complex-coefficient transversal filter 115 receives a real signal S11A from the input terminal Irp, and outputs a real part S11BI and an imaginary part S11BQ of a complex signal S11B with a phase difference of 90 degrees from output terminals OrpI and OrpQ.

The local oscillator (Localb) 116 has a frequency of a difference between the RF signal frequency and the IF signal frequency, and sets the frequency to A1. The local oscillator (Localb) 116 outputs a complex local signal constructed by a real part of cos and an imaginary part of sin. Hereinafter, the complex local signal output from the local oscillator (Localb) 116 is referred to as the complex local signal of the frequency A1. The above-described local oscillator (Localb) 813 has the same frequency as that of the local oscillator (Localb) 116. All complex local signals mentioned below are constructed by a real part of cos and an imaginary part of sin, respectively.

The full-complex mixer 117 frequency-converts the complex signal S11B corresponding to an RF signal to a predetermined frequency of a complex signal S11C corresponding to an IF signal. For example, the full-complex mixer 117 is configured by a mixer-II 171, a mixer-IQ 172, a mixer-QI 174, and a mixer-QQ 175 serving as multipliers, a subtractor 173, and an adder 176. The full-complex mixer 117 receives the real part of the complex local signal of the frequency A1 from the local oscillator (Localb) 116 through an input terminal IcmC and receives the imaginary part of the complex local signal of the frequency A1 from the local oscillator (Localb) 116 through an input terminal IcmS. The full-complex mixer 117 frequency-converts the complex signal S11B input from the input terminals IcmI and IcmQ to a signal close to Direct Current (DC), and then outputs a complex signal S11C from output terminals OcmI and OcmQ.

The mixer-II 171 multiplies the real part S11BI of the complex signal S11B input from the input terminal IcmI by the real part of the complex local signal of the frequency A1 input from the input terminal IcmC, and outputs a multiplying result to a positive input terminal of the subtractor 173. The mixer-IQ 172 multiplies the real part S11BI of the complex signal S11B input from the input terminal IcmI by the imaginary part of the complex local signal of the frequency A1 input from the input terminal IcmS, and outputs a multiplying result to one input terminal of the adder 176.

The mixer-QI 174 multiplies the imaginary part S11BQ of the complex signal S11B input from the input terminal IcmQ by the real part of the complex local signal of the frequency A1 input from the input terminal IcmC, and outputs a multiplying result to the other input terminal of the adder 176. The mixer-QQ 175 multiplies the imaginary part S11BQ of the complex signal S11B input from the input terminal IcmQ by the imaginary part of the complex local signal of the frequency A1 input from the input terminal IcmS, and outputs a multiplication result to a negative input terminal of the subtractor 173.

The subtractor 173 subtracts an output signal of the mixer-QQ 175 from an output signal of the mixer-II 171 and outputs a real part S11CI of the complex signal S11C from the output terminal OcmI. The adder 176 adds an output signal of the mixer-IQ 172 and an output signal of the mixer-QI 174 and outputs an imaginary part S11CQ of the complex signal S11C from the output terminal OcmQ.

The baseband generator 12 is configured as BPFs 121 and 122, Auto Gain Control (AGC) amplifiers 123 and 124, Analog-to-Digital Converters (ADCs) 125 and 126, an imbalance corrector 127, a local oscillator (Localc) 128, a full-complex mixer 129, and low pass filters (LPFs) 130 and 131.

The BPFs 121 and 122 limit the input complex signal S11C to a frequency band of a predetermined range based on a frequency of the positive/negative IF signal, and then output a complex signal S12A. The AGC amplifiers 123 and 124 control a gain according to a voltage applied from an input terminal TAGC. Alternatively, the BPFs 121 and 122 may be replaced with LPFs.

The ADCs 125 and 126 perform A/D conversion operations on a complex signal output from the AGC amplifiers 123 and 124 and output a complex signal S12B to the imbalance corrector 127 such that a demodulator connected to a rear stage of the baseband generator 12 can process a digital signal.

The imbalance corrector 127 is configured by a compensation value memory 132 and a multiplier 133. The imbalance corrector 127 digitally corrects a difference (or imbalance) between the amplitude of an output signal S12CI of the ADC 125 and the amplitude of an output signal S12CQ of the ADC 126 on the basis of a difference between the amplitude of an output signal of the AGC amplifier 123 and the amplitude of an output signal of the AGC amplifier 124. The imbalance corrector 127 can obtain a good image rejection ratio in a target signal band while preventing image frequency interference from occurring in the target signal band.

For example, the compensation value memory 132 stores, in advance, a value (or compensation value) of a ratio between the amplitude of the output signal S12BQ of the ADC 126 and the amplitude of the output signal S12BI of the ADC 125 on the basis of the amplitude of the output signal S12BQ of the ADC 126. The multiplier 133 multiplies the amplitude of the output signal S12BQ of the ADC 126 from an input terminal IicQ and the compensation value based on the amplitude input from the compensation value memory 132, and then outputs an output signal S12CQ serving as a multiplication result to an output terminal OicQ. The output signal S12BI of the ADC 125 in the input terminal IicI is output, to an output terminal OicI, as an output signal S12CI.

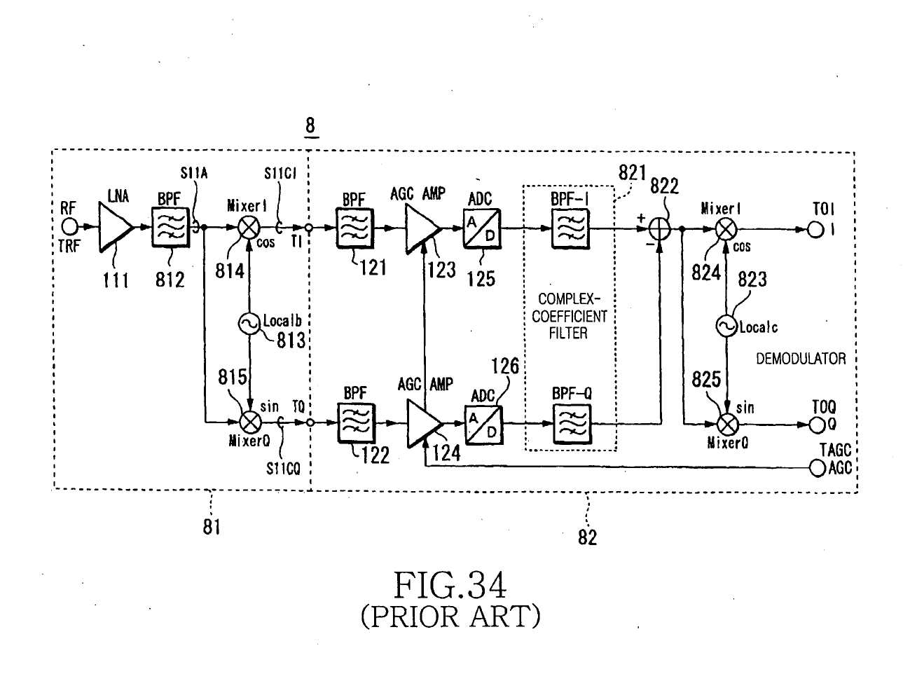

The local oscillator (Localc) 128 has the same frequency as an IF, and sets the frequency to A2. The local oscillator (Localc) 128 outputs a complex local signal with the frequency A2. Hereinafter, the complex local signal output from the local oscillator (Localc) 128 is referred to as the complex local signal of the frequency A2. A local oscillator (Localc) 823 illustrated in FIG. 34 has the same frequency as the local oscillator (Localc) 128.

The full-complex mixer 129 has the same structure as the full-complex mixer 117. The full-complex mixer 129 receives a real part of the complex local signal of the frequency A2 from the local oscillator (Localc) 128 through an input terminal IcmC, and receives an imaginary part of the complex local signal of the frequency A2 from the local oscillator (Localc) 128 through an input terminal IcmS. The full-complex mixer 129 frequency-converts a complex signal S12C, input from the imbalance corrector 127 through input terminals IcmI and IcmQ, to a baseband signal including a frequency zero component, and outputs a complex signal S12D from output terminals OcmI and OcmQ.

The downconverter 1 corresponding to the first basic structure of the downconverter based on the low-IF scheme, as illustrated in FIG. 1 in accordance with the present invention, is compared with the conventional downconverter 8 illustrated in FIG. 34. The following differences are present between the downconverters 1 and 8. The downconverter 8 is configured by an IF generator 81 and a baseband generator 82. A Band Pass Filter (BPF) 812 of the IF generator 81 is replaced with the complex-coefficient transversal filter 115 of the IF generator 11. The local oscillator (Localb) 813 and a half-complex mixer configured as a mixer-I 814 and a mixer-Q 815 in the IF generator 81 are replaced with the local oscillator (Localb) 116 and the full-complex mixer 117 in the IF generator 11.

A complex-coefficient filter 821 of the baseband generator 82 is deleted in the baseband generator 12. The local oscillator (Localc) 823, a subtractor 822, and a half-complex mixer configured as a mixer-I 824 and a mixer-Q 825 are replaced with the local oscillator (Localc) 128 and the full-complex mixer 129. The LPFs 130 and 131 are additionally inserted between the output terminals OcmI and OcmQ of the full-complex mixer 129 and output terminals TOI and TOQ of the baseband generator 12.

The local oscillators (Localb and Localc) 116, 813, 128, and 823 and a local oscillator (Localc) 136 described below output a complex local signal with a spectrum at a negative frequency −f_{c} on a complex frequency axis. That is, a frequency of the complex local signal becomes the negative frequency −f_{c}.

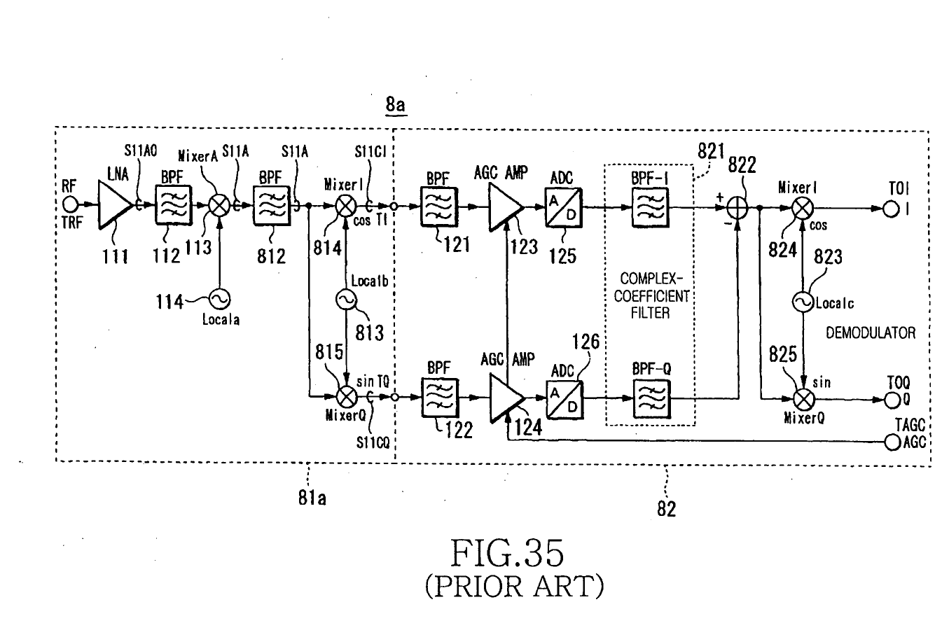

As illustrated in FIG. 35, a conventional dual-conversion downconverter 8a includes an IF generator 81a. In the IF generator 81a, a frequency converter including a BPF 112, a mixer-A 113 and a local oscillator (Locala) 114 is inserted between the LNA 111 and the BPF 812 of the IF generator 81 of the conventional single-conversion downconverter 8.

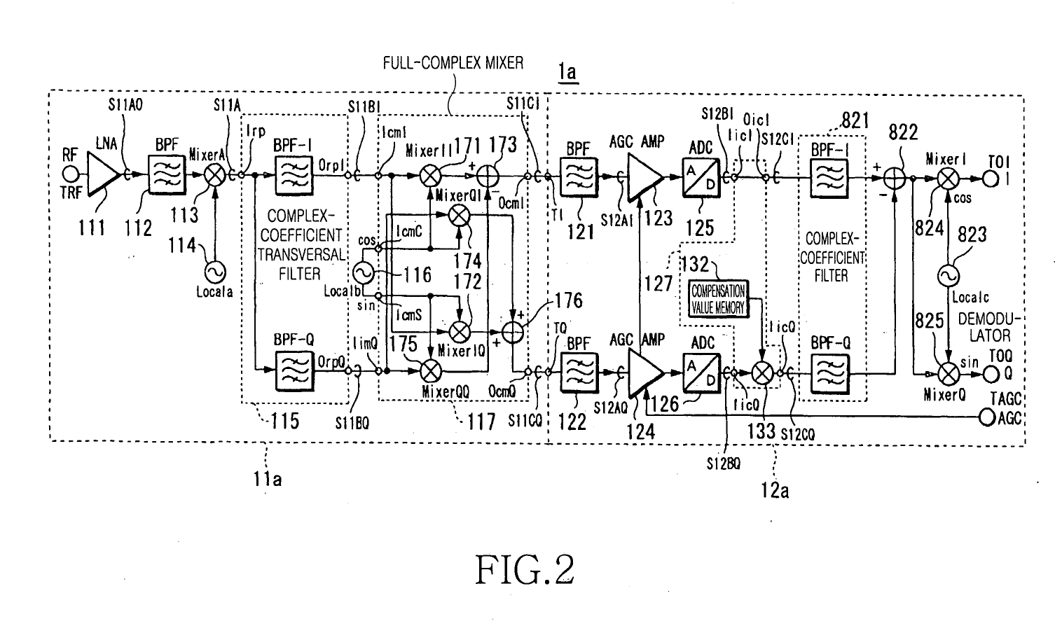

As illustrated in FIG. 2, a dual conversion downconverter 1a corresponding to an example of a first structure of the present invention is provided by replacing the IF generator 11 of the single-conversion downconverter 1 with an IF generator 11a. In the IF generator 11a, the above-described frequency converter is inserted between the LNA 111 and the complex-coefficient transversal filter 115.

In FIG. 2, a baseband generator 12a is provided in place of the baseband generator 12. The baseband generator 12a includes a complex-coefficient filter 821, a local oscillator (Localc) 823, and a subtractor 822, and a half-complex mixer configured by a mixer-I 824 and a mixer-Q 825 in place of the full-complex mixer 129 and the LPFs 130 and 131.

Referring to FIG. 1, the overall operation of the above-described downconverter 1 will be briefly described. The LNA 111 amplifies a real RF signal input from an antenna to the input terminal TRF and then outputs a real signal S11A. The complex-coefficient transversal filter 115 receives the signal and outputs a complex signal S11B to the full-complex mixer 117. The full-complex mixer 117 performs frequency conversion to a signal (or IF signal) close to a DC component according to the complex local signal of the frequency A1 input from the local oscillator (Localb) 116, and outputs a complex signal S11C to the BPFs 121 and 122.

The BPFs 121 and 122 band-limit the complex signal S11C, and output a complex signal S12A to the AGC amplifiers 123 and 124. The AGC amplifiers 123 and 124 adjust amplitudes of a real part S12AI and an imaginary part S12AQ to levels suitable for inputs to the ADCs 125 and 126. The AGC amplifiers 123 and 124 output a signal to the ADCs 125 and 126. The ADCs 125 and 126 convert an input signal to a digital signal and then output a complex signal S12B to the imbalance corrector 127.

The imbalance corrector 127 receives the complex signal S12B, digitally corrects a difference between a real part S12BI and an imaginary part S12BQ of the input complex signal S12B, and outputs a complex signal S12C. The full-complex mixer 129 frequency-converts a complex signal S12D to a baseband signal including the DC component according to the complex local signal of the frequency A2 output from the local oscillator (Localc) 128. The full-complex mixer 129 outputs the complex signal S12D to the LPFs 130 and 131. The LPFs 130 and 131 band-limit the complex signal S12D and output a baseband signal to a demodulator.

In the dual-conversion downconverter 1a corresponding to the example of the first structure of the present invention as illustrated in FIG. 2, the BPF 112 band-limits a real signal S11A0 output from the LNA 111, and the mixer-A 113 mixes an output signal of the BPF 112 with a real local signal output from the local oscillator (Locala) 114, performs frequency conversion to a frequency of a sum or difference between a frequency of the real signal S11A0 and a frequency of the local oscillator (Locala) 114, and outputs a signal after a first frequency conversion process, i.e., a real signal S11A corresponding to a first IF signal, to the complex-coefficient transversal filter 115. The complex-coefficient transversal filter 115 band-limits the real signal S11A. The full-complex mixer 117 performs frequency conversion by mixing an output signal of the complex-coefficient transversal filter 115 with the complex local signal output from the local oscillator (Localb) 116. The full-complex mixer 117 outputs a signal after a second frequency conversion process, i.e., a complex signal S11B corresponding to a second IF signal, to the baseband generator 12a.

When the structure of the downconverter 1a is compared with that of the downconverter 1, it can be seen that the first IF signal of the real signal S11A and the second IF signal of the complex signal S11B in the downconverter 1a correspond to the RF signal of the real signal S11A and the IF signal of the complex signal S11B in the downconverter 1. Operation will be briefly described for the downconverter 1a in which the RF signal of the real signal S11A and the IF signal of the complex signal S11B in the downconverter 1 are replaced with the first IF signal of the real signal S11A and the second IF signal of the complex signal S11B.

In the above-described downconverter 1a, the complex-coefficient filter 821 band-limits a complex signal S12C, outputs a real part S12CI to a positive input terminal of the subtractor 822, and outputs an imaginary part S12CQ to a negative input terminal of the subtractor 822. The subtractor 822 subtracts the imaginary part S12CQ from the real part S12CI, and outputs a real signal to the mixer-I 824 and the mixer-Q 825. The mixer-I 824 multiples the real signal input from the subtractor 822 by a real part of the complex local signal of the frequency A2 input from the local oscillator (Localc) 823. The mixer-Q 825 multiplies the real signal input from the subtractor 822 by an imaginary part of the complex local signal of the frequency A2 input from the local oscillator (Localc) 823. A complex signal corresponding to a signal of a frequency of a difference between a frequency of the real signal and a frequency of the local oscillator (Localc) 823 is output to terminals TOI and TOQ.

C. Complex-Coefficient Transversal Filter 115 of Downconverter of Low-IF Scheme

Next, there will be described the overview and design method of the complex-coefficient transversal filter 115 within the IF generators 11 and 11a.

The complex-coefficient transversal filter 115 converts an RF signal from a real signal to a complex signal. The complex-coefficient transversal filter 115 is configured as a transversal filter for performing a convolution integral with an even symmetric impulse to generate a real part S11BI of a complex signal S11B after conversion and a transversal filter for performing a convolution integral with an odd symmetric impulse to generate an imaginary part S11BQ of the complex signal S11B. Characteristics of the above-described transversal filters are optional. The transversal filters output a signal with a phase difference of 90 degrees between a part for the convolution integral with the even symmetric impulse and a part for the convolution integral with the odd symmetric impulse. The operation for converting the RF signal from the real signal to the complex signal is realized by the conventional phase shifter.

The complex-coefficient transversal filter 115 is designed, for example, using a frequency shift method. A real-coefficient LPF of a predetermined pass bandwidth Bw/2 and a stop-band attenuation amount ACT is designed and a coefficient of the real-coefficient LPF is multiplied by e^{jax}, such that a filter of a center frequency c, a pass bandwidth Bw, and a stop-band attenuation amount ATT can be obtained. In this case, the complex-coefficient transversal filter 115 is designed on the basis of the center frequency ω=800 MHz and the stop-band attenuation amount ATT=39 dB.

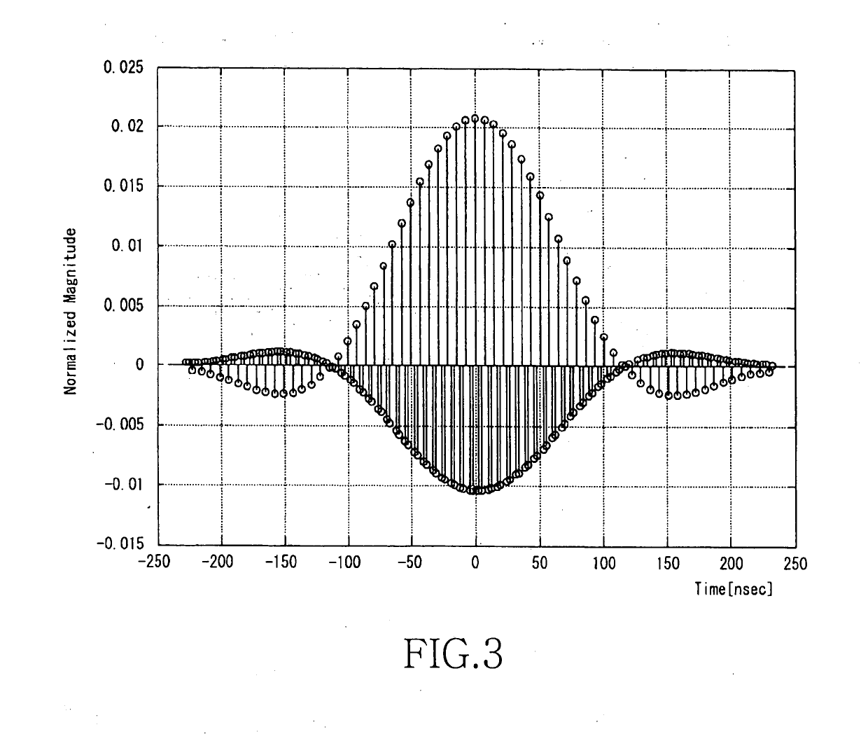

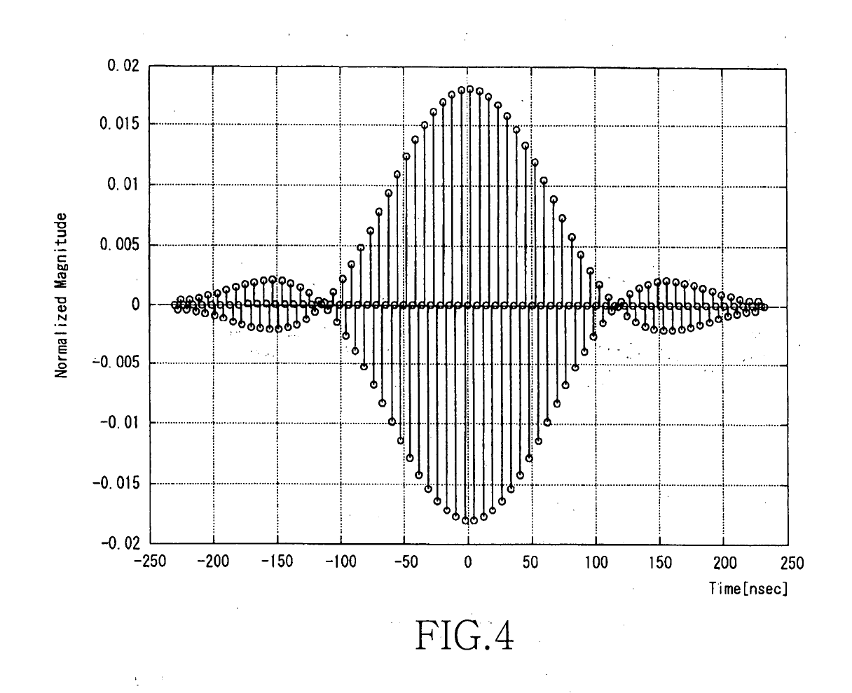

FIG. 3 illustrates an impulse response of a real part of the complex-coefficient transversal filter 115 that has an even-symmetric impulse response with respect to the center of the impulse response. FIG. 4 illustrates an impulse response of an imaginary part of the complex-coefficient transversal filter 115 that has an odd-symmetric impulse response with respect to the center of the impulse response. The above-described complex-coefficient transversal filter 115 has a sampling frequency of 2.4 GHz.

Next, the operation of the complex-coefficient transversal filter 115 within the IF generators 11 and 11a will be described in more detail.

When a real RF signal is received from the input terminal TRF in FIG. 1, the complex-coefficient transversal filter 115 receives a real signal S11A from the LNA 111 through an input terminal Irp and outputs a real part S11BI and an imaginary part S11BQ of a complex signal S11B through output terminals OrpI and OrpQ.

At this time, two real RF signals are input to the input terminal TRF such that the real signal S11A includes two signals. That is, one signal is a Double Side Band (DSB) signal where a center frequency=800 MHz, a carrier interval=1.6 MHz, and carrier power=−20 dB. This signal is a target signal. The other signal is a Continuous Wave (CW) signal where a frequency=790 MHz that is 10 MHz less than the above-described target signal, and power=0 dB. This signal is a non-target signal, i.e., an image frequency signal.

Two real RF signals are input to the input terminal TRF such that the first IF signal, i.e., the real signal S11A, corresponding to a signal after the first frequency conversion process in the downconverter 1a is equal to a signal in the downconverter 1. That is, one signal is a DSB signal where a center frequency=400 MHz, a carrier interval=1.6 MHz, and carrier power=−20 dB. This signal is a target signal. The other signal is a CW signal where a frequency=390 MHz that is 10 MHz less than the above-described target signal, and power=0 dB. This signal is a non-target signal. A frequency of the local oscillator (Locala) 114 is set to 400 MHz. As in the downconverter 1, the non-target signal is an image frequency signal when conversion from the first IF signal to the second IF signal is performed.

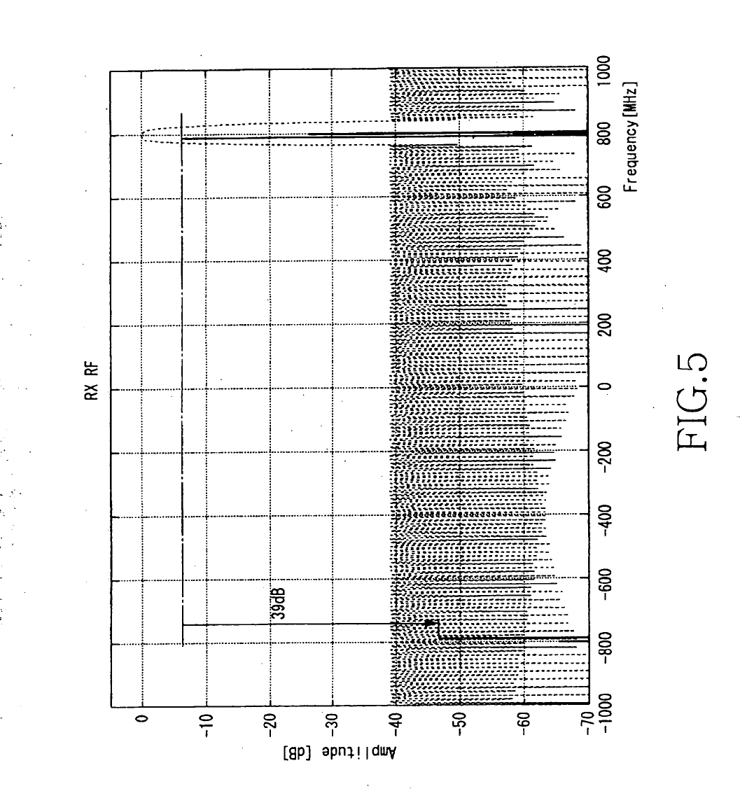

FIG. 5 illustrates a spectrum of the complex signal S11B observed in the output terminals OrpI and OrpQ. In FIG. 5, the dashed line denotes frequency characteristics of the complex-coefficient transversal filter 115. The above-described target signal and the image frequency signal are in a pass band of the complex-coefficient transversal filter 115. The image frequency signal present at a negative frequency is out of a pass band of the complex-coefficient transversal filter 115. It can be seen that the image frequency signal is a signal in which 39 dB is rejected.

D. Detailed Operation of Full-Complex Mixer 117 in Downconverter of Low-IF Scheme

Next, the operation of the full-complex mixer 117 within the IF generators 11 and 11a will be described in more detail. The same process (or a time-domain process for a frequency shift operation) is performed between the full-complex mixer 117 and the half-complex mixer configured by the local oscillator (Localb) 813, the mixer-I 814, and the mixer-Q 815 as illustrated in FIG. 34. The half-complex mixer of FIG. 34 will be described.

It is ideal that a spectrum of the complex local signal is present at a negative frequency of −f_{c}. Because an error occurs between amplitudes of real and imaginary parts of the complex local signal, a low-level spectrum is present at a positive frequency of f_{c} as described below.

First, assuming that the real signal S11A corresponding to the real RF signal is s_{rf}(t), the complex signal S11C is s_{if}(t), the amplitude of the complex local signal is A, the complex local signal is A(Lₒᵢ(t)−jL_{oq}(t)), and an amplitude error between the real and imaginary parts of the complex local signal is Aₑ, s_{if}(t) is computed by Equation (1).

$$\begin{matrix}{s}_{if} ( t ) = {s}_{rf} ( t ) ( ( A + {A}_{e} ) {L}_{oi} ( t ) - j ( A - {A}_{e} ) {L}_{oq} ( t ) ) \\ = {s}_{rf} ( t ) ( A ( {L}_{oi} ( t ) - j {L}_{oq} ( t ) ) + {A}_{e} ( {L}_{oi} ( t ) + j {L}_{oq} ( t ) ) )\end{matrix} \qquad Equation ( 1 )$$

As shown in the second term, a frequency conversion process (reverse to a desired frequency conversion process) is performed according to an error signal occurring due to the amplitude error Aₑ between the real and imaginary parts of the complex local signal. In this case, Equation (2) is obtained because the real signal S11A is a combination of complex signals s_{rfp}(t) and s_{rfm}(t) that are complex conjugates to each other.

$$\begin{matrix}{s}_{if} ( t ) = \frac{( ( {s}_{rfi} ( t ) + j {s}_{rfq} ( t ) ) + ( {s}_{rfi} ( t ) - j {s}_{rfq} ( t ) ) )}{2} \\ ( A ( {L}_{oi} ( t ) - j {L}_{oq} ( t ) ) + {A}_{e} ( {L}_{oi} ( t ) + j {L}_{oq} ( t ) ) ) \\ = \frac{1}{2} A ( {L}_{oi} ( t ) - j {L}_{oq} ( t ) ) ( ( {s}_{rfi} ( t ) + \\ j {s}_{rfq} ( t ) ) + ( {s}_{rfi} ( t ) - j {s}_{rfq} ( t ) ) ) + \\ \frac{1}{2} {A}_{e} ( {L}_{oi} ( t ) + j {L}_{oq} ( t ) ) ( ( {s}_{rfi} ( t ) + \\ j {s}_{rfq} ( t ) ) + ( {s}_{rfi} ( t ) - j {s}_{rfq} ( t ) ) )\end{matrix} \qquad Equation ( 2 )$$

From Equation (2), it can be seen that a frequency conversion process in a plus direction is performed due to an error signal component of a local signal, and a frequency conversion process in a minus direction is performed due to a non-error signal component except the error signal component of the local signal. When the BPFs 121 and 122 reject other terms (i.e., the second and third terms) except the terms (i.e., the first and fourth terms) of the down-conversion operation (corresponding to conversion to a frequency close to a DC component), Equation (3) is produced.

$${s}_{if} ( t ) = \frac{1}{2} A ( {L}_{oi} ( t ) - j {L}_{oq} ( t ) ) ( {s}_{rfi} ( t ) + j {s}_{rfq} ( t ) ) + \frac{1}{2} {A}_{e} ( {L}_{oi} ( t ) + j {L}_{oq} ( t ) ) ( {s}_{rfi} ( t ) - j {s}_{rfq} ( t ) ) \qquad Equation ( 3 )$$

As shown in the first term of Equation (3), a local signal includes an error signal in a frequency conversion process for a target signal frequency-shifted in the minus direction with respect to a positive frequency signal of the real signal S11A. As shown in the second term of Equation (3), a frequency occurs in the plus direction with respect to a negative frequency signal corresponding to a complex conjugate signal of the positive frequency signal of the real signal S11A. When a signal is present at a frequency that is a value of twice an IF lower than the frequency of the target real signal S11A, a signal frequency shifted in the plus direction of the negative frequency corresponds to the frequency of the target signal to be converted to the IF, and image frequency interference occurs.

When the reduction of an image rejection ratio due to a phase error φₑ is considered, an image rejection ratio IMRₘᵢₓ can be computed as shown in Equation (4).

$${IMR}_{mix} = 20 {log}_{10} \sqrt{\frac{1 + {( 1 + {A}_{e} )}^{2} + 2 ( 1 + {A}_{e} ) cos {ϕ}_{e}}{1 + {( 1 + {A}_{e} )}^{2} - 2 ( 1 + {A}_{e} ) cos {ϕ}_{e}}} \qquad Equation ( 4 )$$

When an error of 10% is present between amplitudes of the real and imaginary parts I and Q and the phase error φₑ=0 (indicating the case where no phase error is present) in an example in which an image rejection ratio is reduced, Aₑ=0.1 and cos φₑ=1. In this case, the image rejection ratio IMRₘᵢₓ in an output of the above-described half-complex mixer is 26 dB according to the computation of Equation (4).

On the other hand, the first IF signal and the second IF signal of the conventional dual-conversion downconverter 8a correspond to an RF signal and an IF signal of the conventional downconverter 8, respectively. The local oscillator (Localb) 813 for generating the second IF signal in the half-complex mixer of the downconverter 8a corresponds to the local oscillator (Localb) 813 for generating the IF signal in the half-complex mixer of the downconverter 8. Accordingly, the first IF signal, the second IF signal, and the complex local signal output from the local oscillator (Localb) 116 are replaced with the RF signal, the IF signal, and the complex local signal output from the local oscillator (Localb) 116 in the downconverter 8. Equations (1) to (4) are established also in the downconverter 8a. For convenience of explanation, it is assumed that the BPF 112 completely rejects image interference associated with the first IF signal.

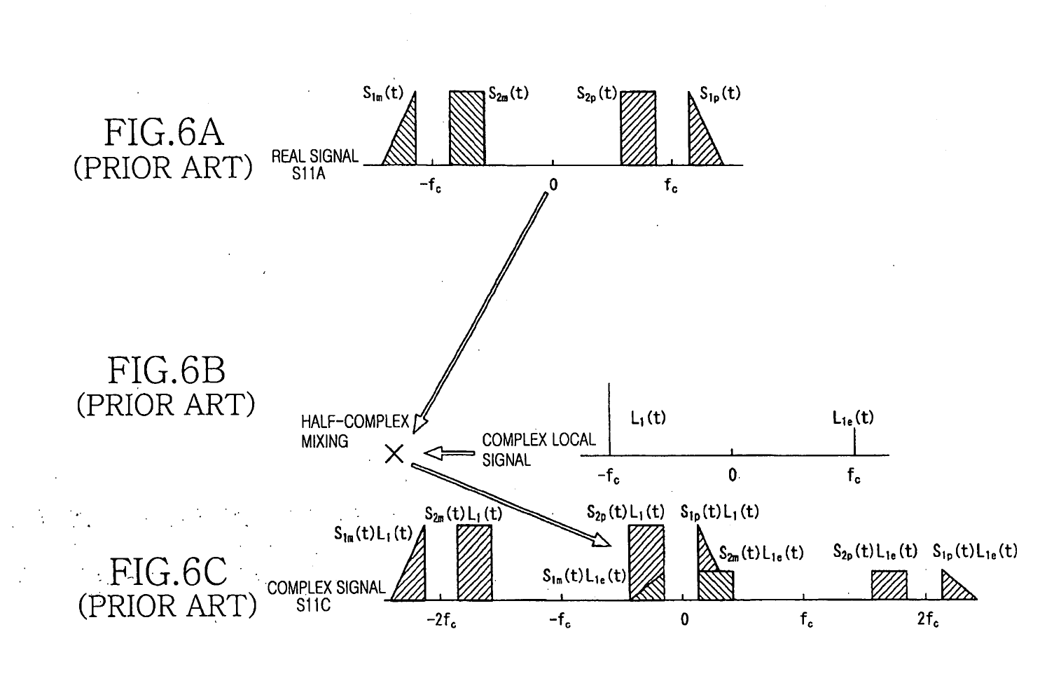

FIG. 6 illustrates a spectrum process on a complex frequency axis for rejecting an image frequency signal in the above-described half-complex mixer in the downconverter 8.

From FIG. 6(a) illustrating a spectrum on the complex frequency axis, it can be seen that the real signal S11A has signals s₁ₚ(t) and s₂ₚ(t) at a positive frequency f_{c} of the complex local signal output from the local oscillator (Localb) 813. Because the real S11A is a combination of complex signal components that are complex conjugates to each other as described above, Equation (5) is obtained when the real signal S11A is s_{rf}(t).

$$\begin{matrix}\begin{matrix}{s}_{rf} ( t ) = \frac{{s}_{1 i} ( t ) + j {s}_{1 q} ( t )}{2} + \frac{{s}_{1 i} ( t ) - j {s}_{1 q} ( t )}{2} + \\ \frac{{s}_{2 i} ( t ) + j {s}_{2 q} ( t )}{2} + \frac{{s}_{2 i} ( t ) - j {s}_{2 q} ( t )}{2} \\ = ( {s}_{1 p} ( t ) + {s}_{2 p} ( t ) ) + ( {s}_{1 m} ( t ) + {s}_{2 m} ( t ) )\end{matrix} & Equation ( 5 ) \\ {s}_{1 p} ( t ) = \frac{{s}_{1 i} ( t ) + j {s}_{1 q} ( t )}{2} , \\ {s}_{1 m} ( t ) = \frac{{s}_{1 i} ( t ) - j {s}_{1 q} ( t )}{2} , \\ {s}_{2 p} ( t ) = \frac{{s}_{2 i} ( t ) + j {s}_{2 q} ( t )}{2} , \\ {s}_{2 m} ( t ) = \frac{{s}_{2 i} ( t ) - j {s}_{2 q} ( t )}{2} & Equation ( 6 )\end{matrix}$$

As illustrated in FIG. 6(a), the real signal S11A has signals s₁ₘ(t) and s₂ₘ(t) corresponding to conjugate signals of the signals s₁ₚ(t) and s₂ₚ(t) also at a negative frequency −f_{c} of the complex local signal in the spectrum on the complex frequency axis. On the other hand, the signals s₁ₚ(t), s₂ₚ(t), s₁ₘ(t), and s₂ₘ(t) have the same amplitude as one another.

It is ideal that the above-described complex local signal has only a non-error signal at the negative frequency −f_{c} in the spectrum on the complex frequency axis. In this case, the frequency of the complex local signal is the negative frequency. However, the complex local signal actually has a non-error signal L₁(t) and an error signal L₁ₑ(t) at the positive frequency f_{c} as illustrated in FIG. 6(b) because an amplitude error Aₑ between the real and imaginary parts is present. Therefore, a complex local signal L_{rf}(t) is computed by Equation (7).
L_{rf}(t)=L₁(t)+L₁ₑ(t) Equation (7)

The amplitude of the error signal L₁ₑ(t) is smaller than that of the non-error signal L₁(t).

The half-complex mixer performs a half-complex mixing (or complex multiplication) operation on the real signal S11A of s_{rf}(t) and the complex local signal L_{rf}(t) and generates a complex signal S11C. The complex signal S11C of s_{if}(t) is computed by Equation (8).

$$\begin{matrix}{s}_{if} ( t ) = ( {s}_{1 p} ( t ) + {s}_{2 p} ( t ) ) {L}_{1} ( t ) + ( {s}_{1 p} ( t ) + {s}_{2 p} ( t ) ) {L}_{1 e} ( t ) + \\ ( {s}_{1 m} ( t ) + {s}_{2 m} ( t ) ) {L}_{1} ( t ) + ( {s}_{1 m} ( t ) + {s}_{2 m} ( t ) ) {L}_{1 e} ( t )\end{matrix} \qquad Equation ( 8 )$$

The complex signal S11C includes signals in the spectrum on the complex frequency axis as illustrated in FIG. 6(c). The signals will be described as follows.

When the signals s₁ₘ(t) and s₂ₘ(t) at the negative frequency −f_{c} of the real signal S11A are multiplied by the non-error signal L₁(t) of the negative frequency −f_{c} of the complex local signal L_{rf}(t), signals s₁ₘ(t) L₁(t) and s₂ₘ(t) L₁(t) are generated at the frequency −2f_{c} corresponding to twice the negative frequency of the complex local signal. When the signals s₁ₚ(t) and s₂ₚ(t) at the positive frequency +f_{c} of the real signal S11A are multiplied by the error signal L₁ₑ(t) at the positive frequency +f_{c} of the complex local signal L_{rf}(t), signals s₁ₚ(t) L₁ₑ(t) and s₂ₚ(t) L₁ₑ(t) are generated at the frequency +2f_{c} corresponding to twice the positive frequency of the complex local signal.

When the signals s₁ₚ(t) and s₂ₚ(t) at the positive frequency +f_{c} of the real signal S11A are multiplied by the non-error signal L₁(t) at the negative frequency −f_{c} of the complex local signal L_{rf}(t), signals s₁ₚ(t) L₁(t) and s₂ₚ(t) L₁(t) are generated at the frequency close to the DC component.

When the signals s₁ₘ(t) and s₂ₘ(t) at the negative frequency −f_{c} of the real signal S11A are multiplied by the error signal L₁ₑ(t) at the positive frequency +f_{c} of the complex local signal L_{rf}(t), signals s₁ₘ(t) L₁ₑ(t) and s₂ₘ(t) L₁ₑ(t) are generated at the frequency close to the DC component.

The image frequency interference occurs at the frequency close to the DC component. That is, the signals s₁ₚ(t) L₁(t) and s₂ₘ(t) L₁ₑ(t) are present at the same frequency, and the signals s₂ₚ(t) L₁(t) and s₁ₘ(t) L₁ₑ(t) are present at the same frequency, such that they interfere with each other. That is, the signal s₂ₚ(t) is symmetric with respect to the positive frequency +f_{c} of the complex local signal and the signal s₂ₘ(t) is symmetric with respect to the DC component interfere with the signal s₁ₚ(t). The signal s₁ₚ(t), symmetric with respect to the positive frequency +f_{c} of the complex local signal, and the signal s₁ₘ(t), symmetric with respect to the DC component, interfere with the signal s₂ₚ(t).

If a signal of the positive frequency is present in an actual signal, i.e., a real signal or a non-ideal complex signal, a signal is present at the negative frequency symmetric with respect to the DC component. Consequently, the signal s₁ₘ(t), symmetric with respect to the positive frequency +f_{c} of the complex local signal, interferes with the signal s₁ₚ(t), and the signal s₂ₚ(t), in relation of a mirror image with respect to the positive frequency +f_{c} of the complex local signal, interferes with the signal s₁ₚ(t). The signal s₂ₚ(t) is an image frequency signal of the signal s₁ₚ(t), such that the image frequency signal s₂ₚ(t) interferes with the signal s₁ₚ(t). Similarly, the signal s₁ₚ(t) is an image frequency signal of the signal s₂ₚ(t), such that the image frequency signal s₁ₚ(t) interferes with the signal s₂ₚ(t).

The detailed operation of the IF generator 11 of the downconverter 1 corresponding to the example of the first structure of the downconverter of the low-IF scheme in accordance with the present invention will be described as compared with the detailed operation of the conventional downconverter 8 of the low-IF scheme illustrated in FIG. 34. It is assumed that a local signal is output from the local oscillator (Localb) 813 and a frequency of the local oscillator (Localb) 813 is 795 MHz. As described above, it is assumed that an error of 10% is present between amplitudes of the real and imaginary parts I and Q and a phase error φₑ=0.

Referring to FIG. 34, the operation of the conventional downconverter 8 will be described in more detail. A real signal S11A is received from the input terminal TRF of the downconverter 8 as in the downconverter 1. At this time, two real RF signals are input to the input terminal TRF such that the real signal S11A includes two signals. That is, one signal is a DSB signal where a center frequency=800 MHz, a carrier interval=1.6 MHz, and carrier power=−20 dB. This signal is a target signal. The other signal is a Continuous Wave (CW) signal where a frequency=790 MHz that is 10 MHz less than the above-described target signal, and power=0 dB. This signal is a non-target signal.

Two real RF signals are input to the input terminal TRF such that the first IF signal, i.e., the real signal S11A, corresponding to a signal after the first frequency conversion process in the downconverter 8a is equal to a signal in the downconverter 8. That is, one signal is a DSB signal where a center frequency=400 MHz, a carrier interval=1.6 MHz, and carrier power=−20 dB. This signal is a target signal. The other signal is a CW signal where a frequency=390 MHz that is 10 MHz less than the above-described target signal, and power=0 dB. This signal is a non-target signal. A frequency of the local oscillator (Locala) 114 is set to 400 MHz. As in the downconverter 1, the non-target signal is an image frequency signal when conversion from the first IF signal to the second IF signal is performed.

The half-complex mixer converts the real signal S11A to a complex signal S11C based on a difference frequency (5 MHz) between the frequency (800 MHz or 790 MHz) of the real signal S11A and the frequency (795 MHz) of the local oscillator (Localb) 813.

At this time, the real signal S11A has the same amplitude as that of the target signal at the frequency (hereinafter, referred to as the negative frequency) in which the negative sign is attached to the frequency of the target signal. The signal with the same amplitude as that of the non-target signal is present at the negative frequency. A signal at the positive frequency of the target signal is set as a signal a, and a signal at the negative frequency of the target signal is set as a signal b. A signal at the positive frequency of the non-target signal is set as a signal c, and a signal at the negative frequency of the non-target signal is set as a signal d.

The half-complex mixer shifts the signal a to 5 MHz (=800 MHz−795 MHz) corresponding to a difference frequency between the positive frequency (800 MHz) of the real signal S11A and the positive frequency (795 MHz) of the local oscillator (Localb) 813. The signal b is shifted to −5 MHz (=790 MHz−795 MHz) corresponding to a difference frequency between the positive frequency (790 MHz) of the real signal S11A and the positive frequency (795 MHz) of the local oscillator (Localb) 813.

The signal c is shifted to 5 MHz (=−790 MHz−(−795 MHz)) corresponding to a difference frequency between the negative frequency (−790 MHz) of the real signal S11A and the negative frequency (−795 MHz) of the local oscillator (Localb) 813. The signal d is shifted to −5 MHz (=−800 MHz−(−795 MHz)) corresponding to a difference frequency between the negative frequency (−800 MHz) of the real signal S11A and the negative frequency (−795 MHz) of the local oscillator (Localb) 813.

In the complex signal S11C generated by the half-complex mixer, different signals are present at the following frequencies. At the frequency of 5 MHz, the signal d is present in a band occupied by the signal a. At the frequency of −5 MHz, the signal c is present in a band occupied by the signal b. When different signals are present in the same frequency band, one signal interferes with the other signal.

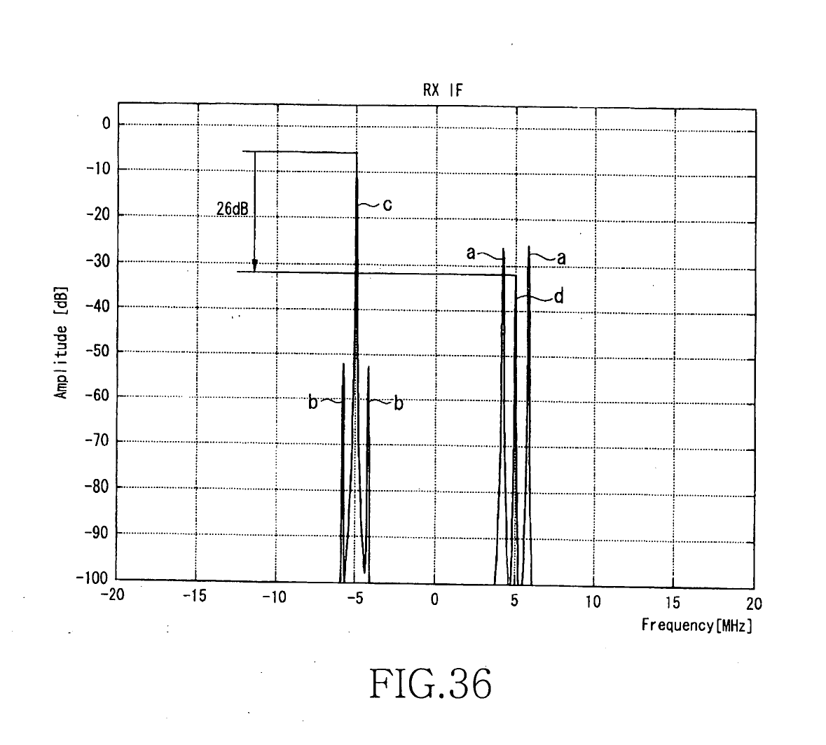

In the half-complex mixer, the complex local signal has the error signal L₁ₑ(t) at the positive frequency +f_{c}. Because the amplitude of the error signal L₁ₑ(t) is smaller than that of the non-error signal L₁(t) at the negative frequency −f_{c}, the amplitudes of signals a ˜d to be multiplied by the error signal and the non-error signal have the following variation. That is, the amplitudes of the signal b and d to be multiplied by the error signal L₁ₑ(t) at the positive frequency +f_{c} are lower than those of the signals a and c to be multiplied by the non-error signal L₁(t) at the negative frequency −f_{c}. As a result, the spectrum of the complex signal S11C is illustrated in FIG. 36. As illustrated in FIG. 36, the signal d is suppressed by 26 dB as compared with the signal c. The image rejection ratio is improved by 26 dB using the half-complex mixer. It can be seen that the signal b is suppressed by 26 dB as compared with the signal a.

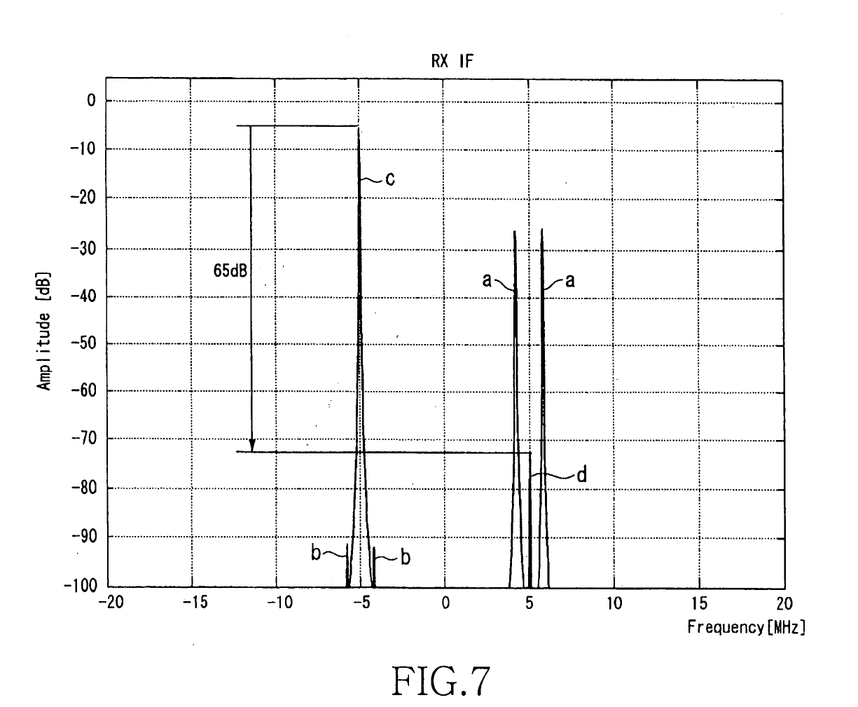

Signal d is not shown to be sufficiently suppressed as compared with the signal a. However, the downconverter 1 of the low-IF scheme in the present invention suppresses a negative frequency signal by 39 dB in the complex-coefficient transversal filter 115. The signals b and d are suppressed by 39 dB before being input to the full-complex mixer 117, and suppressed by 26 dB in the full-complex mixer 117. As illustrated in FIG. 7, the signal d is suppressed by −65 dB as compared with the signal c. The image rejection ratio is improved by −65 dB using the complex-coefficient transversal filter 115 and the full-complex mixer 117 corresponding to a type of image rejection mixer. As a result, the signal b is suppressed by −65 dB as compared with the signal a. It can be seen that the second term of Equation (3) is suppressed and therefore the image rejection ratio is improved because the complex-coefficient transversal filter 115 suppresses the negative frequency signal.

When the dual-conversion downconverter 1a sets a frequency of the local oscillator (Localb) 116 and performs conversion from the first IF signal to the second IF signal, it can acquire the sane image rejection ratio as that of the single-conversion downconverter 1.

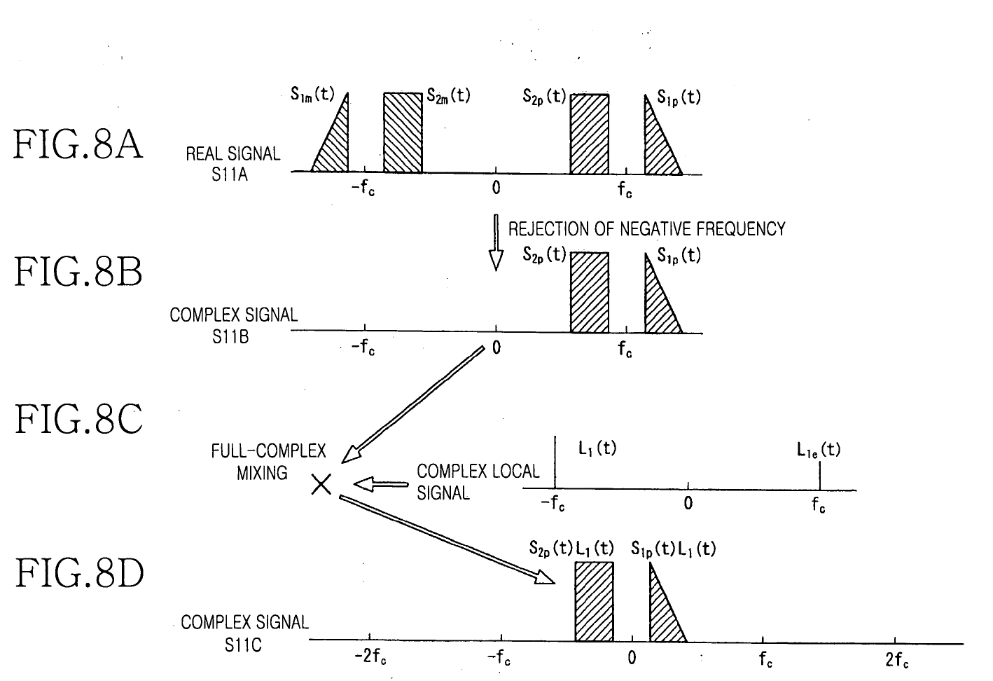

FIG. 8 illustrates a spectrum process on a complex frequency axis for rejecting an image frequency signal in the complex-coefficient transversal filter 115 and the full-complex mixer 117 of the downconverter 8 corresponding to the first structure of the downconverter based on the low-IF scheme in accordance with the present invention.

As illustrated in FIG. 8(a), a real signal S11A has signals s₁ₚ(t) and s₂ₚ(t) at a positive frequency +f_{c} of a complex local signal in a spectrum on the complex frequency axis, and has signals s₁ₘ(t) and s₂ₘ(t) corresponding to conjugate signals of the signals s₁ₚ(t) and s₂ₚ(t) also at a negative frequency −f_{c} of the complex local signal in the spectrum on the complex frequency axis as in the conventional downconverter 8 of the low-IF scheme. On the other hand, the signals s₁ₚ(t), s₂ₚ(t), s₁ₘ(t), and s₂ₘ(t) have the same amplitude as one another.

The real signal S11A is input to the complex-coefficient transversal filter 115 and a complex signal S11B is output from the complex-coefficient transversal filter 115. As described above, the complex-coefficient transversal filter 115 suppresses the negative frequency signal. As illustrated in FIG. 8(b), the complex signal S11B has only the signals s₁ₚ(t) and s₂ₚ(t) at the positive frequency +f_{c} of the complex local signal in the spectrum on the complex frequency axis. When the complex signal S11B is set as s_{rf}′(t), Equation (9) is obtained.
s_{rf}′(t)=s₁ₚ(t)+s₂ₚ(t) Equation (9)

Like the complex local signal output from the local oscillator (Localb) 813, the complex local signal output from the local oscillator (Localb) 116 is generated from the signal L_{rf} as shown in Equation (7) and is illustrated in FIG. 8(c). The complex signal S11B of s_{rf}′(t) and the complex local signal L_{rf} undergo the full-complex mixing (or complex multiplication) process in the full-complex mixer 117, such that a complex signal S11C is generated. The complex signal S11C is set as s_{if}(t), Equation (10) is obtained.
s_{if}(t)=(s₁ₚ(t)+s₂ₚ(t))L₁(t)+(s₁ₚ(t)+s₂ₚ(t))L₁ₑ(t) Equation (10)

The complex signal S11C includes signals in the spectrum on the complex frequency axis as illustrated in FIG. 8(d). That is, when the signals s₁ₚ(t) and s₂ₚ(t) at the positive frequency +f_{c} of the complex signal S11B are multiplied by the non-error signal L₁(t) at the negative frequency −f_{c} of the complex local signal L_{rf}(t), signals s₁ₚ(t) L₁(t) and s₂ₚ(t) L₁(t) are generated at the frequency close to the DC component.

Because a different signal is absent at the same frequency in the complex signal S11C of the downconverter 1, it is different from the conventional downconverter 8, such that image frequency interference does not occur. The complex-coefficient transversal filter 115 rejects the negative frequency signal and therefore the image frequency interference does not occur.

Because an attenuation amount of the negative frequency signal in the complex-coefficient transversal filter 115 is a finite value, the negative frequency signal cannot be completely rejected. However, a total image rejection ratio is improved by a value obtained from the full-complex mixer 117 and a value obtained from the complex-coefficient transversal filter 115.

When the image frequency is set as in the following, the above-described downconverter 1 can improve the image rejection ratio.

For example, the frequency of the IF signal is set to 25 MHz such that the image frequency can be the frequency separated by more than a frequency (18 MHz) from the frequency of the target signal. The frequency (18 MHz) corresponds to a half value of a pass bandwidth of the complex-coefficient transversal filter 115 with the frequency characteristics as illustrated in FIG. 5. The image frequency is set to the frequency out of the pass band of the complex-coefficient transversal filter 115. At this time, the frequency of the target signal is 800 MHz and the frequency of the local oscillator (Localb) 116 is 775 MHz.

At this time, two real RF signals are input to the input terminal TRF such that the real signal S11A includes two signals. That is, one signal is a DSB signal where a center frequency=800 MHz, a carrier interval=1.6 MHz, and carrier power=−20 dB. This signal is a target signal. The other signal is a CW signal where a frequency=750 MHz that is 50 MHz less than the above-described target signal, and power=0 dB. This signal is a non-target signal. The non-target signal is an image frequency signal of the target signal.

Two real RF signals are input to an input terminal TRF such that the first IF signal, i.e., the real signal S11A, corresponding to a signal after the first frequency conversion process in the downconverter 1a is equal to a signal in the downconverter 1. That is, one signal is a DSB signal where a center frequency=400 MHz, a carrier interval=1.6 MHz, and carrier power=−20 dB. This signal is a target signal. The other signal is a CW signal where a frequency=350 MHz that is 50 MHz less than the above-described target signal, and power=0 dB. This signal is a non-target signal. A frequency of the local oscillator (Locala) 114 is set to 400 MHz. As in the downconverter 1, the non-target signal is an image frequency signal. In the downconverter 1a, the second IF signal corresponds to an IF signal as described below.

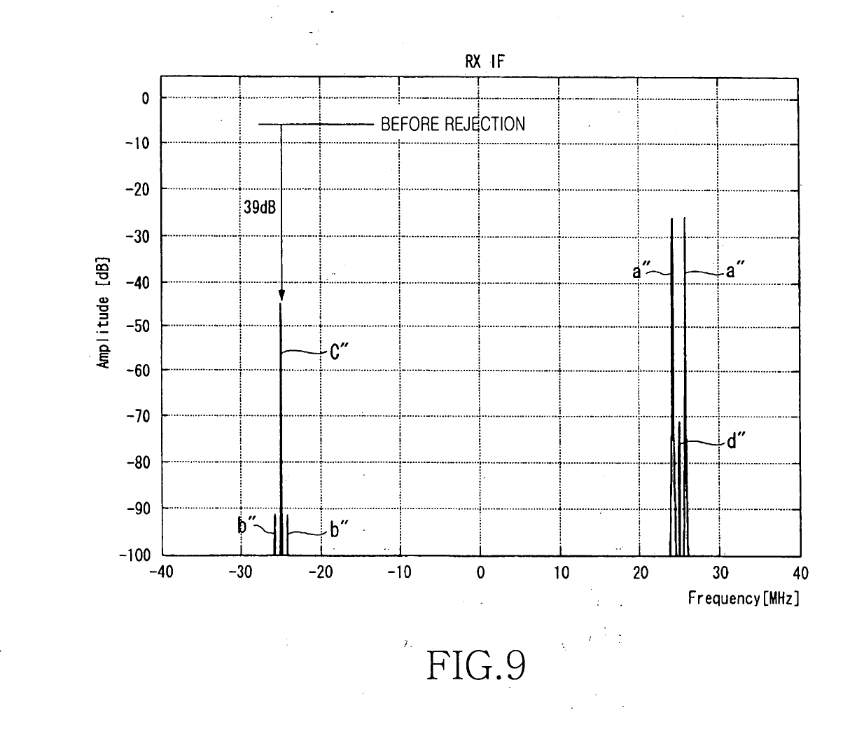

Here, when the frequency of the complex signal S11C corresponding to the IF signal is set to 25 MHz, a spectrum of the complex signal S11C corresponding to an output signal of the full-complex mixer 117 is illustrated in FIG. 9. As described above, FIG. 9 illustrates a spectrum of the complex signal S11C in the IF generator 11 of the downconverter 1 when the frequency of the IF signal is changed from 5 MHz to 25 MHz. FIG. 9 is compared with FIG. 7, illustrating a spectrum of the complex signal S11C when the frequency of the IF signal is 5 MHz.

In FIG. 9, signals a″˜d″ are signals when the frequency of the IF signal is changed from 5 MHz to 25 MHz in the IF generator 11. The signals a″˜d″ are associated with the signals a˜d in FIG. 7. A process for generating the signals a″˜d″ is the same as that for generating the signals a˜d except the frequency of the IF signal.

Here, the signal c″ is a signal obtained by frequency-converting the image frequency (750 MHz) signal in the local oscillator (Localb) 116 of the IF generator 11 (or a signal whose frequency is shifted by −775 MHz). In the downconverter 1a, the signal c″ is obtained by increasing a signal of 350 MHz by 400 MHz in the frequency converter of the IF generator 11a and frequency-converting the image frequency (750 MHz) signal in the local oscillator (Localb) 116 (or a signal whose frequency is shifted by −775 MHz).

In an input terminal Irp of the complex-coefficient transversal filter 115, the above-described signal c″ is a signal out of a pass band (800 MHz±18 MHz) of the complex-coefficient transversal filter 115. The signal c″ passes through the complex-coefficient transversal filter 115. As illustrated in FIG. 9, the signal c″ is suppressed by 39 dB as compared with the signal c illustrated in FIG. 7 (or an IF signal whose frequency is 5 MHz).

When the negative frequency signal of the complex signal S11B corresponding to the output signal of the complex-coefficient transversal filter 115 is frequency-converted in the plus direction due to an amplitude difference between the real and imaginary parts of the complex local signal of the frequency A1 from the local oscillator (Localb) 116 as in the case where the frequency of the IF signal is 5 MHz, image frequency interference to the target signal a″ occurs. Frequency characteristics of the complex-coefficient transversal filter 115 at −25 MHz are the same as frequency characteristics at −5 MHz as illustrated in FIG. 5. When the real signal S11A is converted to the complex signal S11C using the complex-coefficient transversal filter 115 and the full-complex mixer 117 although the frequency of the IF signal is changed from 5 MHz to 25 MHz, the same image rejection ratio (−65 dB) is obtained.

Accordingly, the following effects can be obtained. The image rejection ratio of the signal c″ can be improved by an image rejection ratio obtained by converting the real signal S11A to the complex signal S11C using the complex-coefficient transversal filter 115 and the full-complex mixer 117 and an image rejection ratio of 39 dB based on the frequency characteristics of the complex-coefficient transversal filter 115.

In accordance with each basic structure and each embodiment, the baseband generator not only can improve the image rejection ratio by converting an input signal to a complex signal, but also can improve the image rejection ratio by attenuating an image frequency component of the input signal.

In the present invention, the IF generator 11 can obtain a high image rejection ratio using the complex-coefficient transversal filter 115 and the full-complex mixer 117. However, the complex signal S11C in the input terminal of the baseband generator 12 includes a signal (i.e., the signal c) of a high level at an image frequency (−5 MHz) associated with a signal (i.e., the signal a) at the target frequency (5 MHz) as illustrated in FIG. 7. When the real and imaginary parts S12AI and S12AQ of the complex signal S12A corresponding to the output signal of the complex-coefficient filter 134 are completely orthogonal, the signals a and c do not interfere with each other. When an amplitude difference is present between the real part S12BI and the imaginary part S12BQ of the complex signal S12B in a process of the complex-coefficient filter 134 or a process of the AGC amplifiers 123 and 124 and the ADCs 125 and 136 in the baseband generator 12, image frequency interference to the signal a occurs due to the signal c.

The image frequency interference of the baseband generator 12 is suppressed by correcting an amplitude difference between the real part S12BI and the imaginary part S12BQ of the complex signal S12B. As a concrete correction means, the above-described imbalance corrector 127 suppresses image frequency interference due to an amplitude error that may occur between the real part S12BI and the imaginary part S12BQ of the complex signal S12B. Accordingly, performance degradation in the IF signal can be improved.

When the frequency of the local oscillator (Localb) 116 is set as described above, the dual-conversion downconverter 1a can obtain the same image rejection ratio as that of the single-conversion downconverter 1.

E. Complex-Coefficient SAW Filters 150 and 157 of Downconverter of Low-IF Scheme

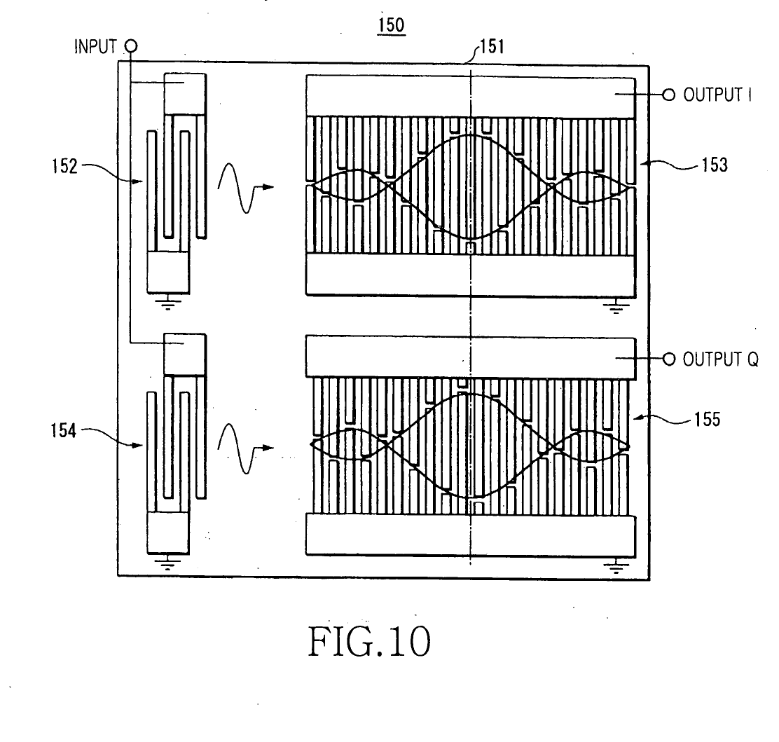

A complex-coefficient SAW filter 150 corresponding to an example of a concrete structure of the complex-coefficient transversal filter 115 of FIG. 1 will be described with reference to FIG. 10. Alternatively, the complex-coefficient transversal filter 115 may be implemented with a switch capacitor circuit and a Charge Coupled Device (CCD). The SAW filter is suitable at a high frequency.

An example of a downconverter using the above-described complex-coefficient SAW filter 150 will be described with reference to the first to third embodiments of the present invention.

Referring to FIG. 10, the complex-coefficient SAW filter 150 is implemented with a transversal SAW filter. For example, the complex-coefficient SAW filter 150 has a structure in which comb shaped electrodes (hereinafter, referred to as Inter-Digital Transducers (IDTs)) 152˜155 are placed on a surface of a piezoelectric substrate 151 that is made of a piezoelectric material such as a crystal or ceramic material. The IDTs 152˜155 have the comb shape and are configured by two electrode fingers alternately opposite to each other.

On the piezoelectric substrate 151, the IDTs 152 and 154 are placed in a straight line in the perpendicular direction of the paper surface of FIG. 10. The IDT 154 is arranged in a position when the IDT 152 is shifted in parallel in the perpendicular direction. Electrode fingers in the sane position relation of the IDTs 152 and 154 are commonly connected to the input terminal of the complex-coefficient SAW filter 150. The electrode fingers of the other side are grounded to the piezoelectric substrate 151. As described above, the IDTs 152 and 154 are used for an input.

On the piezoelectric substrate 151, the IDTs 153 and 155 are placed in the horizontal direction of the paper surface at a predetermined interval. The IDTs 153 and 155 are set opposite to the IDTs 152 and 154. Two propagation paths of SAWs are formed by the IDTs 152 and 154. The IDTs 153 and 155 is placed on the piezoelectric substrate 151 such that an intersection width between electrode fingers is different according to an arrangement as illustrated in FIG. 10. At this time, the IDT 153 is placed on the piezoelectric substrate 151 such that a curve (or envelope curve) formed by intervals between opposite electrode fingers of the IDT 153 is even symmetric with respect to the center of the curve. The IDT 155 is placed on the piezoelectric substrate 151 such that a curve (or envelope curve) formed by intervals between opposite electrode fingers of the IDT 155 is odd symmetric with respect to the center of the curve.

Electrode fingers in the same position relation of the IDTs 153 and 155 are connected to output terminals I and Q. The electrode fingers of the other side are grounded to the piezoelectric substrate 151. As described above, the IDTs 153 and 155 are used for an output.

Next, a method for operating and designing the complex-coefficient SAW filter 150 will be described. When an impulse electric signal is applied to the IDTs 152 and 154, the piezoelectric substrate 151 is mechanically distorted according to the piezoelectric effect due to a potential difference occurring between an electrode finger connected to the input terminal and a grounded electrode finger in an interval between the electrode fingers of the IDTs 152 and 154. The SAWs are excited and propagated in the horizontal direction of the surface on the piezoelectric substrate 151. According to the SAW propagation in an interval between the electrode fingers of the IDTs 153 and 155, the mechanical distortion occurs in the piezoelectric substrate 151. According to the piezoelectric effect due to the distortion, a potential difference between the electrode fingers of the IDT 153 or the electrode finger of the IDT 155 connected to the output terminal Q and the grounded electrode finger is output as a signal from the output terminal I or Q.

In the IDTs 152 and 154 serving as the IDTs of the input side, the SAW associated with an electrode finger corresponding to a node is easily excited, and the SAW of an arbitrary wavelength can be excited when an interval (or pitch) between the electrode fingers is changed. In the IDTs 153 and 155 serving as the IDTs of the output side, a potential difference between the electrode fingers is easily generated for the SAW associated with an electrode finger corresponding to a node, and a signal of an arbitrary wavelength can be output when an interval between the electrode fingers is changed. As is apparent from the above description, the SAW filter can output a signal of an arbitrary wavelength by changing an interval between the electrode fingers of an IDT in at least one of the input and output sides.

The complex-coefficient SAW filter 150 is a transversal SAW filter. An impulse response of the complex-coefficient SAW filter 150 is determined by a weighting function (or intersection width) Wᵢ in each electrode finger (hereinafter, referred to as a tap), a distance xᵢ from each tap, and a phase velocity v of the SAW. A frequency transfer function H(ω) of the impulse response is expressed by Equation (11).

$$H ( ω ) = {\sum }_{i = 0}^{n} {W}_{i} exp ( - \frac{jω {x}_{i}}{v} ) \qquad Equation ( 11 )$$

Equation (11) represents a linear combination of the weighting function Wᵢ and is based on the basic principle of the transversal filter. As described above, the SAWs are propagated to the IDTs 153 and 155 opposite to the IDTs 152 and 154 on the piezoelectric substrate 151. When the propagated SAWs are converted to electric signals in the IDTs 153 and 155, desired frequency characteristics can be obtained. The transversal filter can independently define amplitude and phase characteristics by designing the weighting function Wᵢ and the distance xᵢ. When the weighting function Wᵢ and the distance xᵢ of the transversal SAW filter are designed, desired characteristics of the complex-coefficient SAW filter 150 can be obtained.

The complex-coefficient SAW filter 150 is implemented with two real-coefficient transversal SAW filters provided on the piezoelectric substrate 151. Specifically, one side of the two real-coefficient transversal SAW filters is based on the IDT 152 for the input and the IDT 153 for the output, and the other side of two real-coefficient transversal SAW filters is based on the IDT 154 for the input and the IDT 155 for the output. On the other hand, the electrode finger of the IDT 153 is placed on the piezoelectric substrate 151 such that the curve formed by intervals between the electrode fingers is even symmetric with respect to the electrode centerline. The electrode finger of the IDT 155 is placed on the piezoelectric substrate 151 such that the curve formed by intervals between the electrode fingers is odd symmetric with respect to the electrode centerline. In the complex-coefficient SAW filter 150, the curve formed by gaps between the electrode fingers of the IDT 153 is set which is mapped to an impulse response of a real part. This means that a weighting process mapped to the impulse response of the real part is made for the electrode finger of the IDT 153. A weighting process mapped to the impulse response of the imaginary part is made for the electrode finger of the IDT 155.

When the real signal S11A is simultaneously input to the IDTs 152 and 154 serving as the input IDTs in the complex-coefficient SAW filter 150, the impulse response of the real part is output from the output terminal I connected to the IDT 153 and the impulse response of the imaginary part is output from the output terminal Q connected to the IDT 155. A phase difference of 90 degrees is present between output signals of the output terminals I and Q.

When the complex-coefficient transversal filter 115 is implemented with the complex-coefficient SAW filter 150, the following merits are provided. Because electrode dimensions of the SAW filter can be precisely created when the present fine processing technology is used, desired small characteristic variation can be obtained and the overall performance of a device can be improved.

The weighting process is performed for the IDTs 153 and 155 serving as the output IDTs in this basic structure as described above. Alternatively, the weighting process may be performed for the IDTs 152 and 154 serving as the input IDTs.

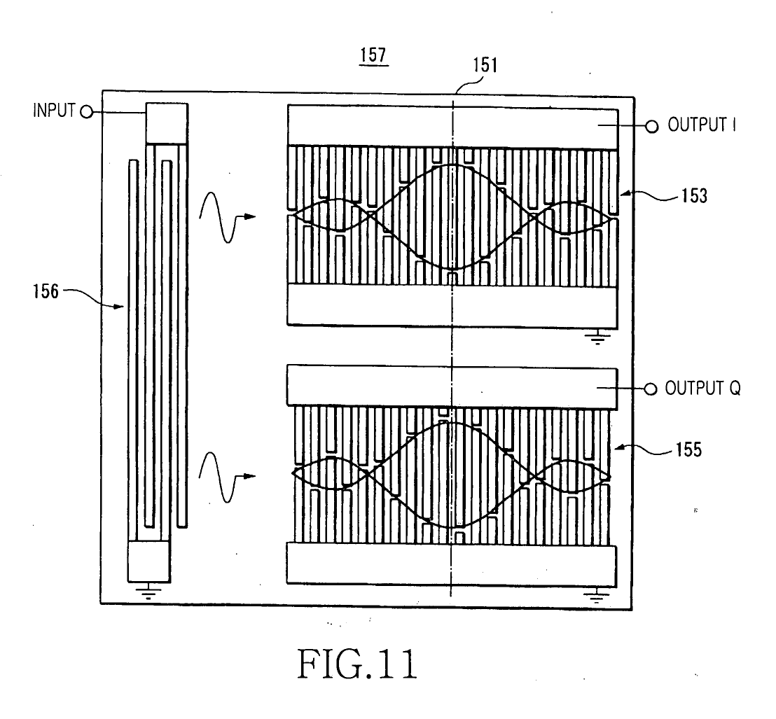

As illustrated in FIG. 11, a complex-coefficient SAW filter 157 can be used in a structure in which the input IDTs 152 and 154 of the complex-coefficient SAW filter 150 are replaced with an IDT 156 opposite to the output IDTs 153 and 155. The IDT 156 is placed across two propagation paths of the SAWs formed between the output IDTs 153 and 155 opposite thereto.

F. Example of Second Basic Structure of Downconverter Based on Low-IF Scheme

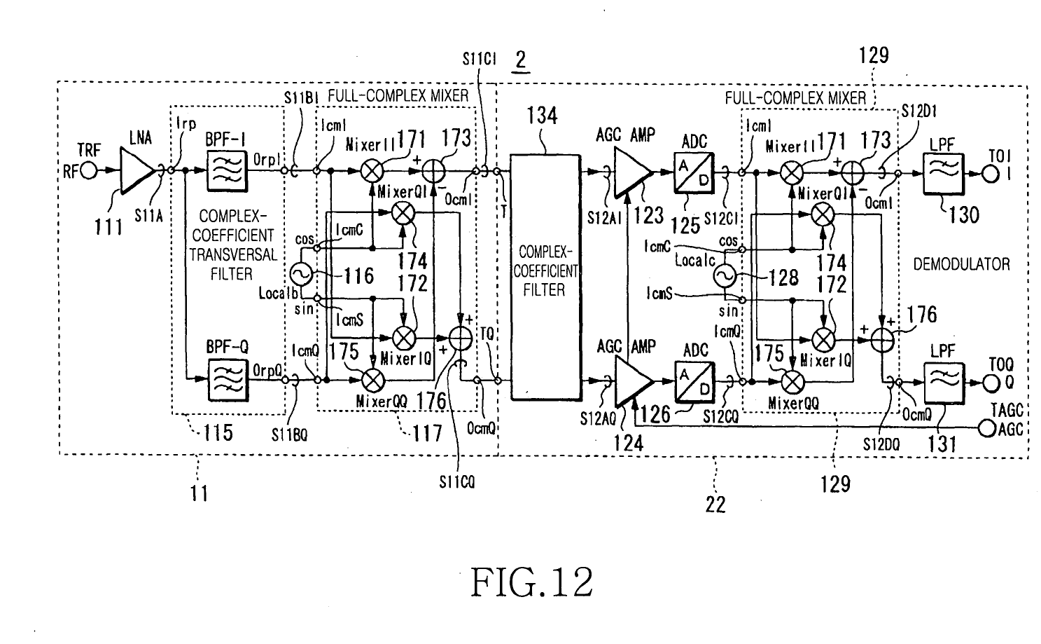

Next, an example of a second basic structure of the downconverter based on the low-IF scheme in accordance with the present invention will be described with reference to FIG. 12. A structure of the above-described downconverter 2 is similar to that of FIG. 1. However, the structure and operation of a baseband generator 22 are different from those of the baseband generator 12 of the downconverter 1 corresponding to the example of the first basic structure. Then, the downconverter 2 corresponding to the example of the second basic structure will be described with reference to the accompanying drawings.

The baseband generator 22 is different from the baseband generator 12 corresponding to the example of the first basic structure in that the BPFs 121 and 122 are replaced with a complex-coefficient filter 134 and the imbalance corrector 127 is deleted.

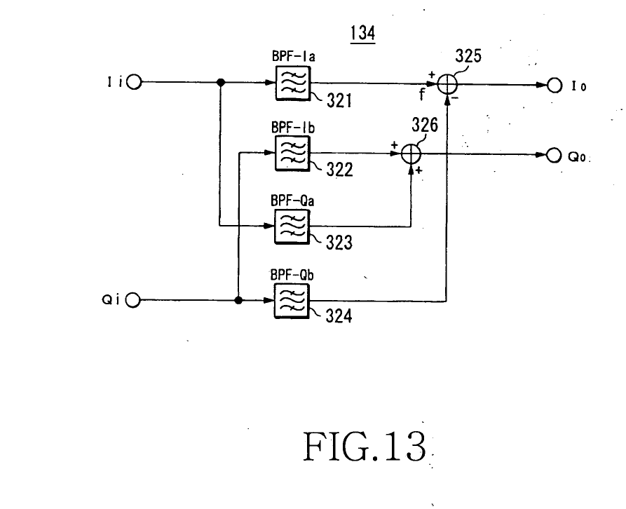

The complex-coefficient filter 134 is implemented with a complex-coefficient transversal filter as illustrated in FIG. 13. In the complex-coefficient transversal filter, a coefficient is a complex coefficient. The complex-coefficient transversal filter is configured by a BPF-Ia 321, a BPF-Ib 322, a BPF-Qa 323, a BPF-Qb 324, a subtractor 325, and an adder 326.

The BPF-Ia 321 performs a filter process for passing only a target frequency component of a signal input from an input terminal Ii, and outputs a signal after the process to a positive input terminal of the subtractor 325. The BPF-Ib 322 performs the filter process for a signal input from an input terminal Qi, and outputs a signal after the process to one input terminal of the adder 326. The BPF-Ia 321 and the BPF-Ib 322 process a real part of the coefficient.

The BPF-Qa 323 performs the filter process for a signal input from the input terminal Ii, and outputs a signal after the process to the other input terminal of the adder 326. The BPF-Qb 324 performs the filter process for a signal input from the input terminal Qi, and outputs a signal after the process to a negative input terminal of the subtractor 325. The BPF-Qa 323 and the BPF-Qb 324 process an imaginary part of the coefficient.

The subtractor 325 subtracts an output signal of the BPF-Qb 324 from an output signal of the BPF-Ia 321 and outputs a subtraction result as the real part of an output signal to an output terminal Io. The adder 326 adds an output signal of the BPF-Ib 322 and an output signal of the BPF-Qa 323 and outputs an addition result as the imaginary part of an output signal to an output terminal Qo.

Next, an example of a method for designing the above-described complex-coefficient transversal filter will be described.

Like the complex-coefficient transversal filter 115 in the example of the first basic structure, the complex-coefficient transversal filter is designed by the above-described frequency shift method. The complex-coefficient transversal filter, in which the center frequency ω=5 MHz, is designed. On the other hand, because the complex-coefficient transversal filter can have complex bandpass characteristics, it can be used as a band limit filter.

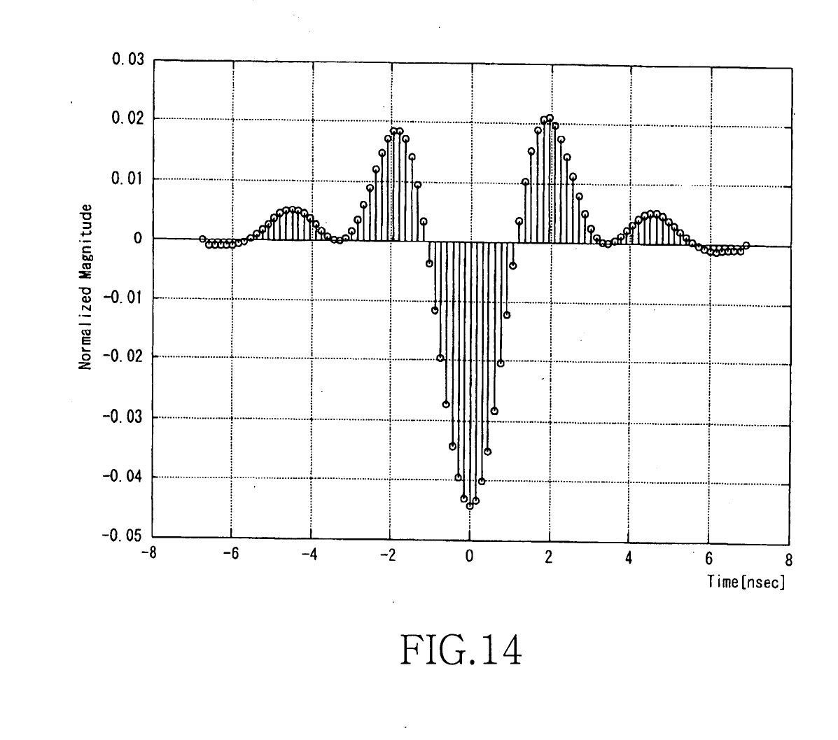

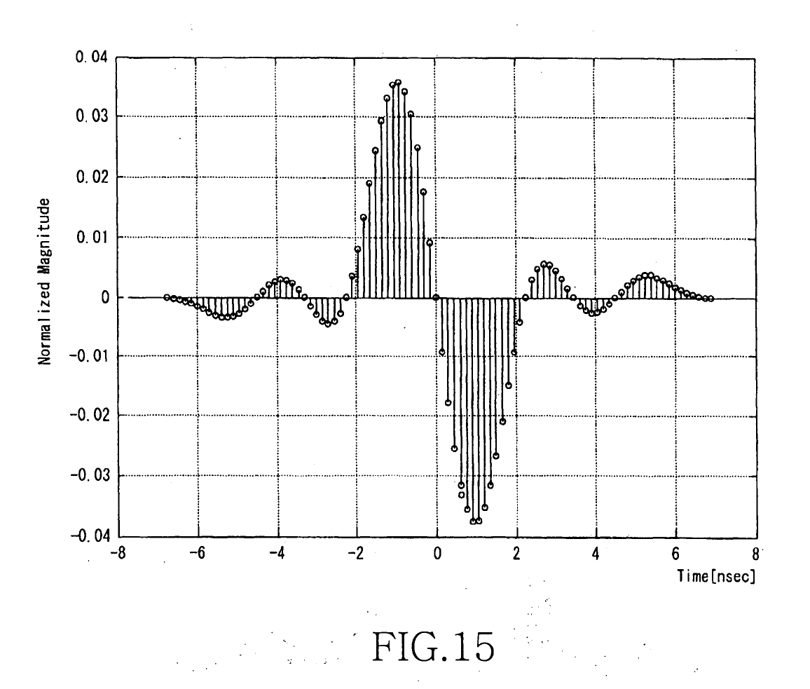

FIG. 14 illustrates an impulse response of a real part of the complex-coefficient transversal filter that is even symmetric with respect to the center of the impulse response. FIG. 15 illustrates an impulse response of an imaginary part of the complex-coefficient transversal filter that is odd symmetric with respect to the center of the impulse response. The above-described complex-coefficient transversal filter has a sampling frequency of 150 MHz.

Next, the operation of the baseband generator 22 will be described with reference to FIG. 12. Because the operation of the baseband generator 22 is similar to that of the baseband generator 12 corresponding to the example of the first basic structure, only differences will be described.

It is assumed that an input terminal TRF of the downconverter 2 corresponding to an example of this basic structure receives the same signal as that input to the input terminal TRF of the downconverter 1 corresponding to the example of the first basic structure.

Here, a complex signal S11C in terminals TI and TQ is set as a signal s_{if}(t). When an amplitude error is present between a real part S11CI and an imaginary part S11CQ of the complex signal S11C corresponding to the signal s_{if}(t), the amplitude of the real part S11CI is B, and the amplitude error between the signal s_{ifi}(t) corresponding to the real part S11CI and the signal s_{ifq} corresponding to the imaginary part S11CQ is Bₑ. Because the signal s_{if}(t) is a combination of the signals S_{ifi}(t) and s_{ifq}, s_{if}(t) is defined as shown in Equation (12).

$$\begin{matrix}{s}_{if} ( t ) = \frac{( B {s}_{ifi} ( t ) + j {Bs}_{ifq} ( t ) ) + ( {B}_{e} {s}_{ifi} ( t ) - j {B}_{e} {s}_{ifq} ( t ) )}{2} \\ = \frac{B ( {s}_{ifi} ( t ) + j {s}_{ifq} ( t ) ) + {B}_{e} ( {s}_{ifi} ( t ) - j {s}_{ifq} ( t ) )}{2}\end{matrix} \qquad Equation ( 12 )$$

In a negative frequency of a target signal frequency, i.e., an image frequency corresponding to a frequency that has the same absolute value as that of the target signal frequency but only has a different sign, and in a target signal frequency corresponding to the image frequency, a signal proportional to a value of the error Bₑ appears as shown in Equation (12). That is, image frequency interference re-occurs

In an example of this basic structure, the above-described complex-coefficient filter 134 is used to process the complex signals S11C. That is, the complex-coefficient filter 134 has characteristics in which a positive frequency is set as a pass band and performs a process such that an image frequency signal at the negative frequency is suppressed. Like the IF generator 11, the baseband generator 22 prevents the re-occurrence of the image frequency interference.

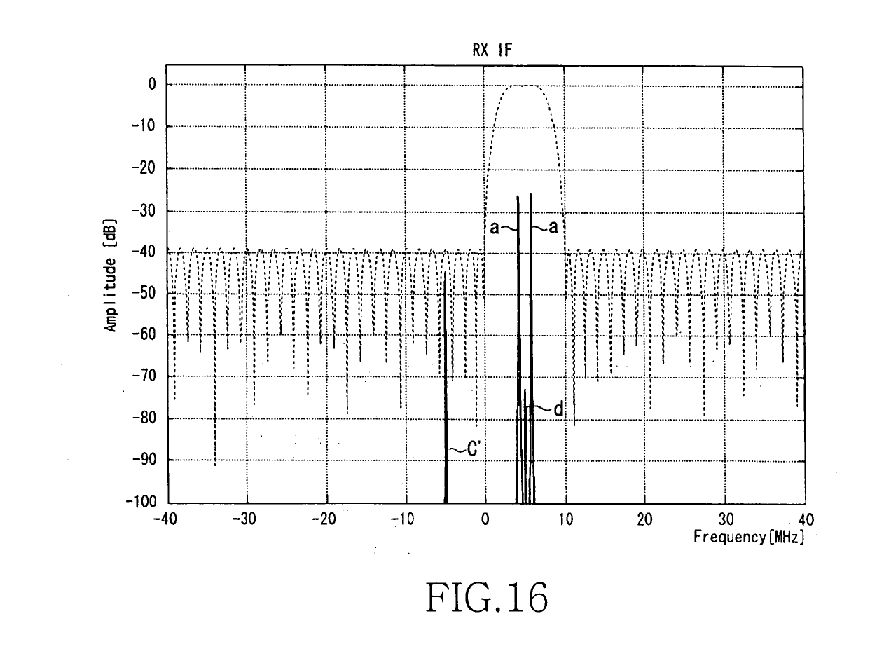

Because a complex signal S12A is obtained by processing the complex signal S11C corresponding to an input signal of the baseband generator 22, signals a˜d illustrated in FIG. 7 are based on a spectrum obtained by a signal process of the complex-coefficient filter 134. In FIG. 16, frequency characteristics of a complex-coefficient transversal filter used as the complex-coefficient filter 134 are denoted by the dashed line, and the spectrum of the complex signal S12A is denoted by the continuous line. As indicated by the dashed line, the complex-coefficient filter 134 passes the signals a and b of FIG. 7 without attenuation because they are present in a pass band. Also in FIG. 16, the signals a and b are expressed in original levels.

Because the signals b and c of FIG. 7 are present in a stop band, they are attenuated as in the signal c′ of FIG. 16. When the signal b of FIG. 7 is attenuated by the same level as in the signal c′, it has a value of less than a lowest amplitude (−100 dB) capable of being expressed in FIG. 16 and does not appear in FIG. 16.

Because the baseband generator 22 suppresses an image frequency signal corresponding to the negative frequency in the complex-coefficient filter 134, the imbalance corrector 127 of the baseband generator 12 corresponding to the example of the first structure is unnecessary and is able to be deleted.

Because the complex-coefficient filter 134 suppresses the negative frequency of the complex signal S11C corresponding to an IF signal in an example of this basic structure, the baseband generator 22 can prevent the re-occurrence of the image frequency interference and can further improve the image rejection ratio. Because the image frequency signal is attenuated, a requirement for a dynamic range of a rear stage rather than the complex-coefficient filter 134 can be mitigated.

The full-complex mixer 117 arranged in a front stage of the complex-coefficient filter 134 has characteristics for passing a positive frequency signal by suppressing a negative frequency signal in an example of this basic structure. The full-complex mixer 117 has characteristics in which a positive frequency is set as a pass band and performs a process for suppressing the image frequency signal corresponding to the negative frequency. Alternatively, the complex-coefficient filter 134 may have characteristics in which the negative frequency is set as the pass band and may perform a process for suppressing the positive frequency signal when the positive frequency signal is suppressed and the negative frequency signal is mainly input to the complex-coefficient filter 134.

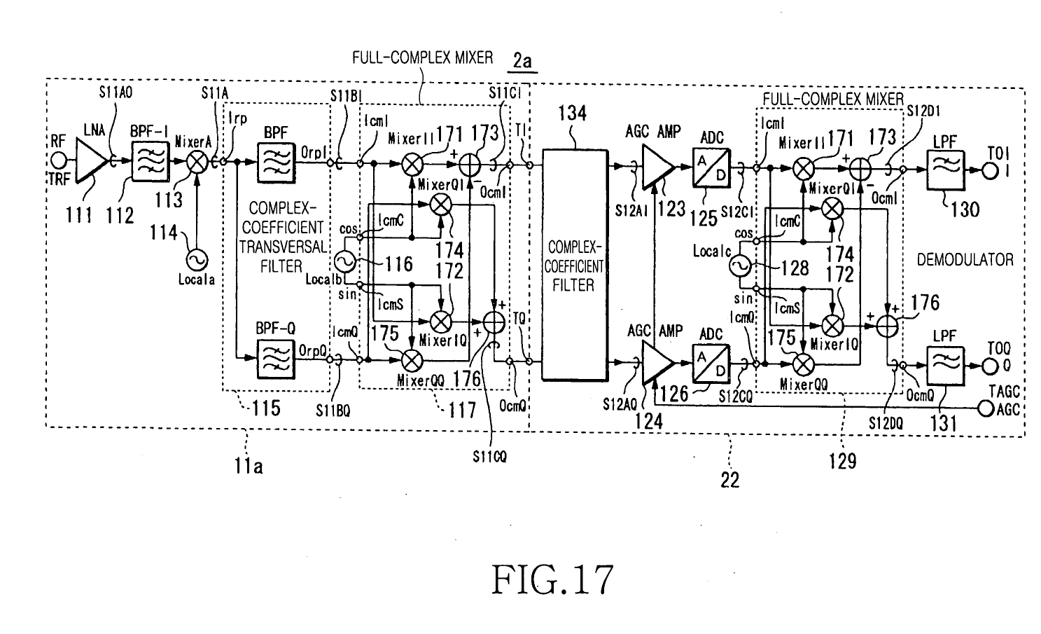

In an example of the second basic structure of the present invention as illustrated in FIG. 17 like the example of the first structure of the present invention, the dual-conversion downconverter 2a includes an IF generator 11a. In the IF generator 11a, a frequency converter is inserted between the LNA 111 and the complex-coefficient transversal filter 115 of the IF generator 11 of the single-conversion downconverter 2. The downconverter 2a can have the same characteristics when the first IF signal and the second IF signal are replaced with an RF signal and an IF signal of the downconverter 2.

The complex-coefficient filter 134 not only may use a complex-coefficient transversal filter illustrated in FIG. 13, but also may use a complex-coefficient filter including a polyphase filter with complex band rejection characteristics based on Resistor-Capacitor (RC), an operational amplifier, etc. In this case, the polyphase filter has flat frequency characteristics in the pass band when the pass band is present at a positive frequency. The polyphase filter is different from the complex-coefficient transversal filter in that the polyphase filter has the complex band rejection characteristics and cannot be used as a band limit filter.

G. Complex-Coefficient SAW Filter 340 in Downconverter of Low-IF Scheme

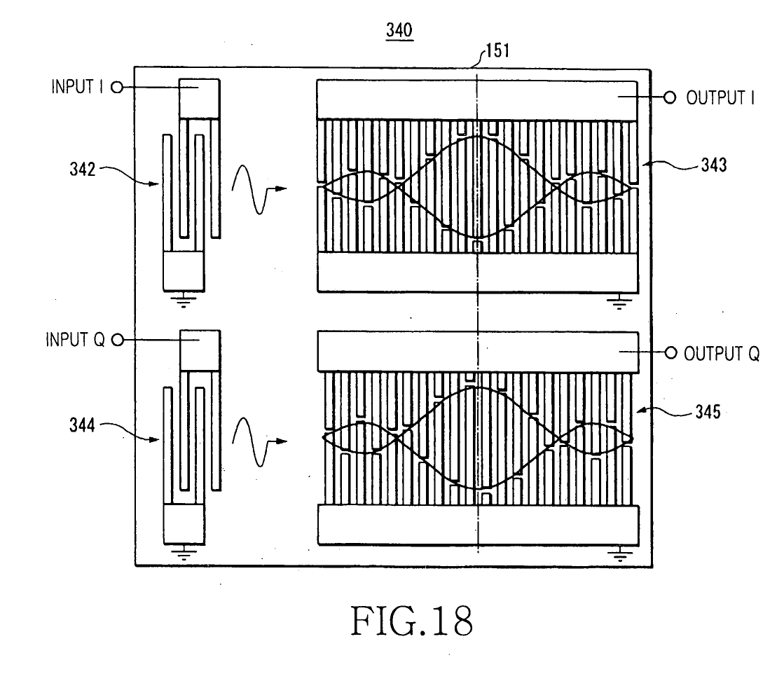

Next, a complex-coefficient SAW filter 340 (corresponding to an example of a concrete structure of a complex-coefficient transversal filter used as the complex-coefficient filter 134 of the downconverter 2 illustrated in FIG. 12) will be described with reference to FIG. 18. A concrete example of the downconverter using the above-described complex-coefficient SAW filter 340 will be described in more detail with reference to first and second embodiments of the present invention as described below.

The complex-coefficient SAW filter 340 has the same structure as the complex-coefficient SAW filter 150 in the example of the second basic structure. In the complex-coefficient SAW filter 340, an IDT 343 (of a first comb shaped electrode), an IDT 345 (of a second comb shaped electrode), and an IDT 346 (of a third comb shaped electrode) are placed on a piezoelectric substrate 151. On the other hand, the IDTs 343, 345 and 346 have the same structure as the IDTs 152˜155.

The complex-coefficient SAW filter 340 is implemented with two real-coefficient transversal SAW filters provided in the piezoelectric substrate 151. Specifically, one side of the two real-coefficient transversal SAW filters is based on the IDT 342 for the input and the IDT 343 for the output, and the other side of two real-coefficient transversal SAW filters is based on the IDT 344 for the input and the IDT 345 for the output. On the other hand, the electrode finger of the IDT 343 is placed on the piezoelectric substrate 151 such that the curve formed by intervals between the electrode fingers is even symmetric with respect to the center of the curve. The electrode finger of the IDT 345 is placed on the piezoelectric substrate 151 such that the curve formed by intervals between the electrode fingers is odd symmetric with respect to the center of the curve. The curve formed by gaps between the electrode fingers of the IDT 343 is set which is mapped to an impulse response of a real part. In the complex-coefficient SAW filter 340, a weighting process mapped to the impulse response of the real part is made for the electrode finger of the IDT 343. A weighting process mapped to the impulse response of the imaginary part is made for the electrode finger of the IDT 345.

When the real part S11CI and the imaginary part S11CQ of the complex signal S11C are simultaneously input to the IDTs 342 and 344 serving as the input IDTs in the complex-coefficient SAW filter 340, the impulse response of the real part is output from the output terminal I connected to the IDT 343 and the impulse response of the imaginary part is output from the output terminal Q connected to the IDT 345. A phase difference of 90 degrees is present between output signals of the output terminals I and Q.

When the complex-coefficient filter 134 is implemented with the complex-coefficient SAW filter 340 as in the above-described complex-coefficient SAW filter 150, the following benefits are provided. Because electrode dimensions of the SAW filter can be precisely created when the present fine processing technology is used, desired small characteristic variation can be obtained and the overall performance of a device can be improved.

The weighting process is performed for the IDTs 343 and 345 serving as the output IDTs in this basic structure as described above. Alternatively, the weighting process may be performed for the IDTs 342 and 344 as in the complex-coefficient SAW filter 150.

H. Example of Third Basic Structure of Downconverter Based on Low-IF Scheme

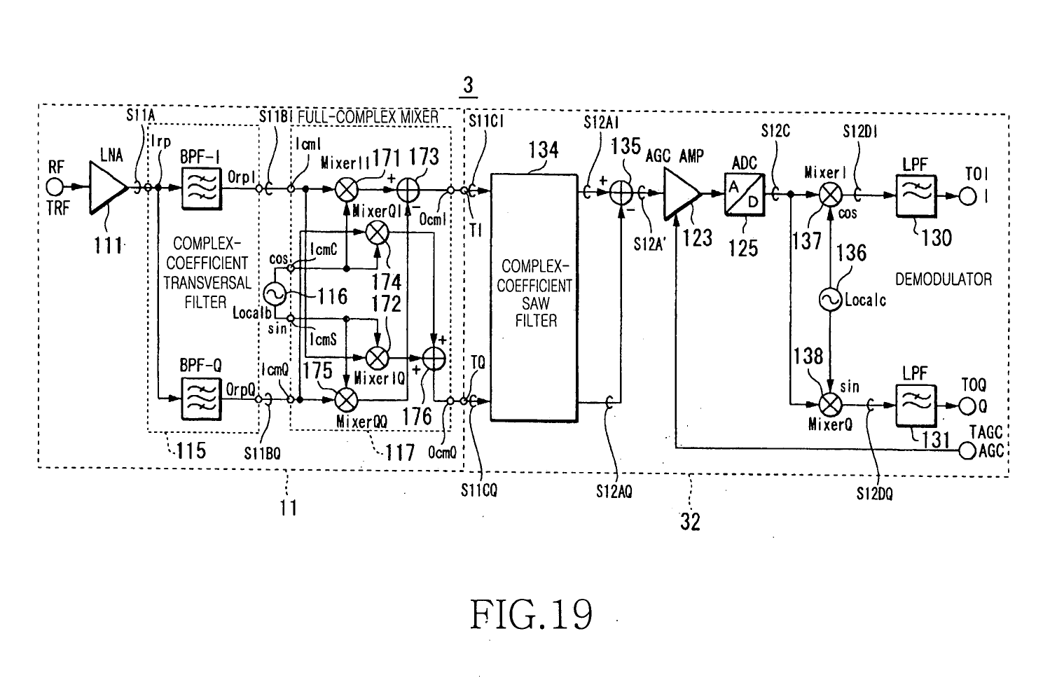

Next, an example of a third basic structure of the downconverter based on the low-IF scheme in accordance with the present invention will be described with reference to FIG. 19. A structure of the above-described downconverter 3 is similar to that of FIG. 12. However, the structure and operation of a baseband generator 32 are different from those of the baseband generator 22 of the downconverter 2 corresponding to the example of the second basic structure. Next, the downconverter 3 corresponding to the example of the third basic structure will be described.

The baseband generator 32 is different from the baseband generator 22 corresponding to the example of the second basic structure in that a subtractor 135 is inserted between the complex-coefficient filter 134 and the AGC amplifier 123, the AGC amplifier 124 and the ADC 126 are deleted, and the full-complex mixer 129 is replaced with a half-complex mixer including a local oscillator (Localc) 136, a mixer-I 137, and a mixer-Q 138.

Like the local oscillator (Localc) 128, the local oscillator (Localb) 136 has the same frequency as the IF, and sets the frequency to A2. Hereinafter, a complex local signal output from the local oscillator (Localc) 136 is referred to as the complex local signal of the frequency A2.

Next, the operation of the baseband generator 32 will be described with reference to FIG. 19. Because the operation of the baseband generator 32 is similar to that of the baseband generator 22 corresponding to the example of the second basic structure, only differences will be described.

The complex-coefficient filter 134 suppresses a negative frequency signal of an input signal, outputs a real part S12AI of a complex signal S12A to a positive input terminal of the subtractor 135, and outputs an imaginary part S12AQ of the complex signal S12A to a negative input terminal of the subtractor 135. The subtractor 135 subtracts the imaginary part S12AQ from the real part S12AI and outputs a real signal S12A′ to a signal input terminal of the AGC amplifier 123.

The mixer-I 137 multiplies a real signal S12C input from the ADC 125 and a real part of the complex local signal of the frequency A2 input from the local oscillator (Localb) 136 and outputs, to an input terminal of the LPF 130, a real part S12DI of a complex signal S12D corresponding to a signal of a frequency difference between both signals. The mixer-Q 138 multiplies the real signal S12C input from the ADC 125 and an imaginary part of the complex local signal of the frequency A2 input from the local oscillator (Localb) 136 and outputs, to an input terminal of the LPF 131, an imaginary part S12DQ of the complex signal S12D corresponding to the signal of the frequency difference between both signals.

The subtractor 135 inverts the polarity of the imaginary part S12AQ corresponding to an output of the complex-coefficient filter 134 and changes an output process of the subtractor 135 from a difference between the real part S12AI and the imaginary part S12AQ to a sum of the real part S12AI and the imaginary part S12AQ. Characteristics of processing a signal in the complex-coefficient filter 134 and the subtractor 135 result in complex conjugates. A positive frequency signal is suppressed and a negative frequency is present in a pass band. In an example of this basic structure, the process has bandpass characteristics in which the center frequency is set to −5 MHz.

In the example of this basic structure similar to the example of the second structure, the baseband generator 32 suppresses an image frequency signal and the re-occurrence of image frequency interference by suppressing the negative frequency signal. Only the real part S12AI or the imaginary part S12AQ of the complex signal S12A corresponding to an output signal of the complex-coefficient filter 134 is extracted and output to a signal input terminal of the AGC amplifier 123. As illustrated in FIG. 19, a signal process system configured by an AGC amplifier and an ADC is one system configured by the AGC amplifier 123 and the ADC 125. This basic structure does not need to have one system of the AGC amplifier 123 and the ADC 125 and the other system of the AGC amplifier 124 and the ADC 126 as in the second basic structure. Therefore, circuit size, cost, and power consumption can be reduced.

The full-complex mixer 117 arranged in a front stage of the complex-coefficient filter 134 has characteristics for passing a positive frequency signal by suppressing a negative frequency signal in an example like the second basic structure. The complex-coefficient filter 134 has characteristics in which a positive frequency is set as a pass band and performs a process for suppressing the image frequency signal corresponding to the negative frequency. Alternatively, the complex-coefficient filter 134 may have characteristics in which the negative frequency is set as the pass band and may perform a process for suppressing the positive frequency signal when the positive frequency signal is suppressed and the negative frequency signal is input to the complex-coefficient filter 134.

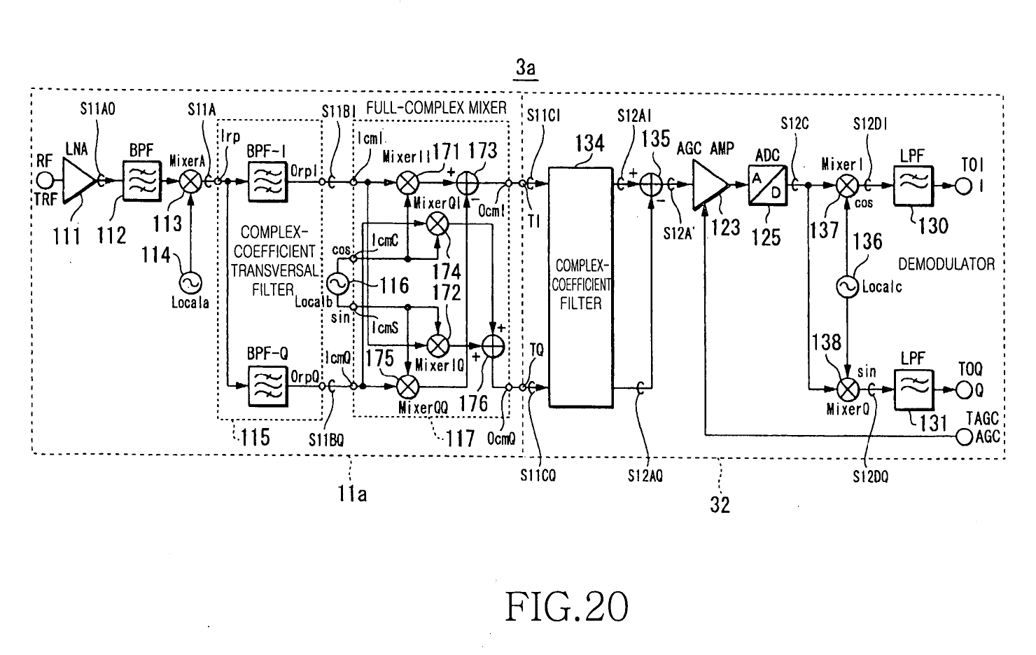

In an example of the third basic structure of the present invention as illustrated in FIG. 20 like the example of the first and second basic structures of the present invention, the dual-conversion downconverter 3a includes an IF generator 11a. In the IF generator 11a, a frequency converter is inserted between the LNA 111 and the complex-coefficient transversal filter 115 of the IF generator 11 of the single-conversion downconverter 3. The downconverter 3a can have the same characteristics when the first IF signal and the second IF signal are replaced with an RF signal and an IF signal of the downconverter 3.

I. Principle of Upconverter of Low-IF Scheme

Next, there will be described the principle of suppressing an image frequency signal in an upconverter of a low-IF scheme of the present invention corresponding to an example of a basic structure.

J. Example of Basic Structure of Upconverter Based on Low-IF Scheme

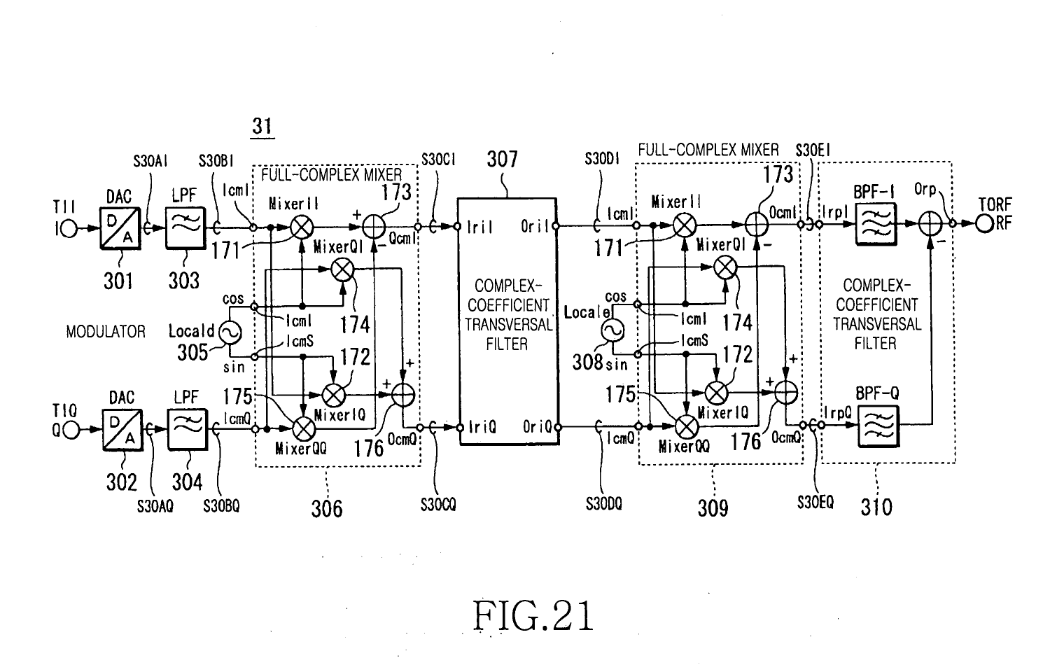

FIG. 21 illustrates an upconverter serving as an example of a basic structure of the upconverter of the low-IF scheme in the present invention. For example, the above-described upconverter 31 of the low-IF scheme converts digital signals received from digital input terminals TI and TQ with real and imaginary parts to analog baseband signals, frequency-converts the analog baseband signals to IF signals, and generates a complex IF signal. Moreover, the upconverter 31 frequency-converts the generated complex IF signal to an RF signal frequency corresponding to a high frequency, extracts only a real part of the complex RF signal, and outputs the real RF signal to an output terminal TRF connected to an antenna or so on.

The upconverter 31 is configured by Digital-to-Analog Converters (DACs) 301 and 302, LPFs 303 and 304, a local oscillator (Locald) 305, a full-complex mixer 306, a complex-coefficient transversal filter 307 (or a second complex-coefficient transversal filter), a local oscillator (Locale) 308, a full-complex mixer 309 (or a complex mixer), and a complex-coefficient transversal filter 310.

The local oscillator (Locald) 305 has the same frequency as the IF and sets the frequency to B1. The local oscillator (Locald) 305 outputs a complex local signal with the frequency B1. The complex local signal output from the local oscillator (Locald) 305 is referred to as the complex local signal of the frequency B1.

The full-complex mixer 306 has the same structure as the above-described full-complex mixer 117, and frequency-converts a complex signal S30B corresponding to a baseband signal to the frequency B1 of the local oscillator (Locald) 305 as a complex signals S30C corresponding to an IF signal. The full-complex mixer 306 receives a real part of the complex local signal of the frequency B1 from the local oscillator (Locald) 305 through an input terminal IcmC and receives an imaginary part of the complex local signal of the frequency B1 from the local oscillator (Locald) 305 through an input terminal IcmS. The full-complex mixer 306 frequency-converts the complex signal S30B input from input terminals IcmI and IcmQ to a frequency of an output signal of the local oscillator (Locald) 305, and outputs the complex signal S30C to output terminals OcmI and OcmQ.

The complex-coefficient transversal filter 307 has an input terminal IirI for the real part, an input terminal IirQ for the imaginary part, an output terminal OirI for the real part, and an output terminal OirQ for the imaginary part. The complex-coefficient transversal filter 307 suppresses one of negative and positive frequencies and outputs a complex signal S30D.

The local oscillator (Locale) 308 has a difference frequency between a frequency of the RF signal and the same frequency as the IF, and sets the frequency to B2. The local oscillator (Locale) 308 outputs a complex local signal with the frequency B2. The complex local signal output from the local oscillator (Locale) 308 is referred to as the complex local signal of the frequency B2.

The full-complex mixer 309 has the same structure as the above-described full-complex mixer 117. The full-complex mixer 309 receives a real part of the complex local signal of the frequency B2 from the local oscillator (Locale) 308 through an input terminal IcmC and receives an imaginary part of the complex local signal of the frequency B2 from the local oscillator (Locale) 308 through an input terminal IcmS. The full-complex mixer 309 converts a complex signal S30D corresponding to an IF signal input from the complex-coefficient transversal filter 307 through the input terminals IcmI and IcmQ to a frequency corresponding to a sum of the frequency B2 of an output signal of the local oscillator (Locale) 308 and the frequency of the complex signal S30D. The full-complex mixer 309 outputs a complex signal S30E to output terminals OcmI and OcmQ.

The complex-coefficient transversal filter 310 is configured by a BPF-I, a BPF-Q, and a subtractor. The input terminal IrpI for the real part of the complex-coefficient transversal filter 310 is connected to an input terminal of the BPF-I, and the input terminal IrpQ for the imaginary part of the complex-coefficient transversal filter 310 is connected to an input terminal of the BPF-Q. An output terminal of the BPF-I is connected to a positive input terminal of a subtractor, and an output terminal of the BPF-Q is connected to a negative input terminal of the subtractor. An output terminal of the subtractor is connected to an output terminal Orp of the complex-coefficient transversal filter 310. The complex-coefficient transversal filter 310 receives a complex signal S11E from the input terminal IrpI for the real part and the input terminal IrpQ for the imaginary part, and outputs an RF signal to the output terminal Orp.

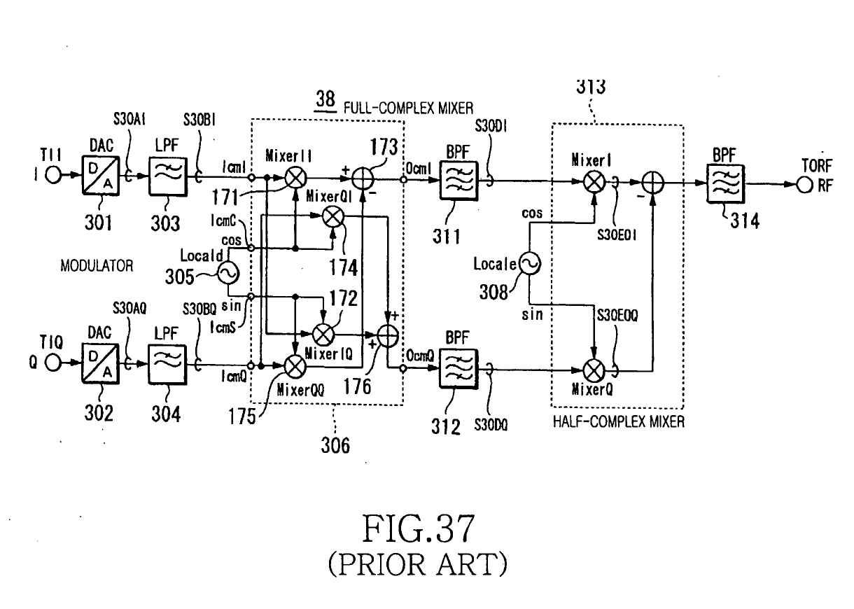

When the upconverter 31 (corresponding to the basic structure of the upconverter of the low-IF scheme of the present invention illustrated in FIG. 21) is compared with a conventional upconverter 38 illustrated in FIG. 37, the following differences are observed. That is, BPFs 311 and 312 of the upconverter 38 are replaced with the complex-coefficient transversal filter 307. A combination of a half-complex mixer 313 and a BPF 314 (for frequency-converting a complex signal S30D corresponding to output signals of the BPFs 311 and 312 to a real signal according to a complex local signal output from the local oscillator (Locale) 308) is replaced with a combination of the full-complex mixer 309 (for frequency-converting the complex signal S30D corresponding to an output signal of the complex-coefficient transversal filter 307 to a complex signal S30E according to a complex local signal output from the local oscillator (Locale) 308 and the complex-coefficient transversal filter 310 for band-limiting the complex signal S30E and outputting a real signal).

The local oscillators (Locald and Locale) 305- and 308 of the upconverters 31 and 38 output the following complex local signal, and are different from the local oscillators (Localb and Localc) 116, 813, 128, 823, and 136 of the above-described downconverters. The complex local signal is output with a spectrum at a positive frequency f_{c} on the complex frequency axis. Accordingly, the frequency of the complex local signal is the positive frequency f_{c}.

Next, the operation of the above-described upconverter 31 will be briefly described. The DACs 301 and 302 convert a DSB signal of a carrier interval=1.6 MHz corresponding to a complex baseband signal input from input terminals TII and TIQ from a digital signal to an analog signal. The LPFs 303 and 304 remove a high frequency component from a complex signal S30A input from the DACs 301 and 302 and performs a waveform shaping operation, and outputs a complex signal S30B to the full-complex mixer 306.

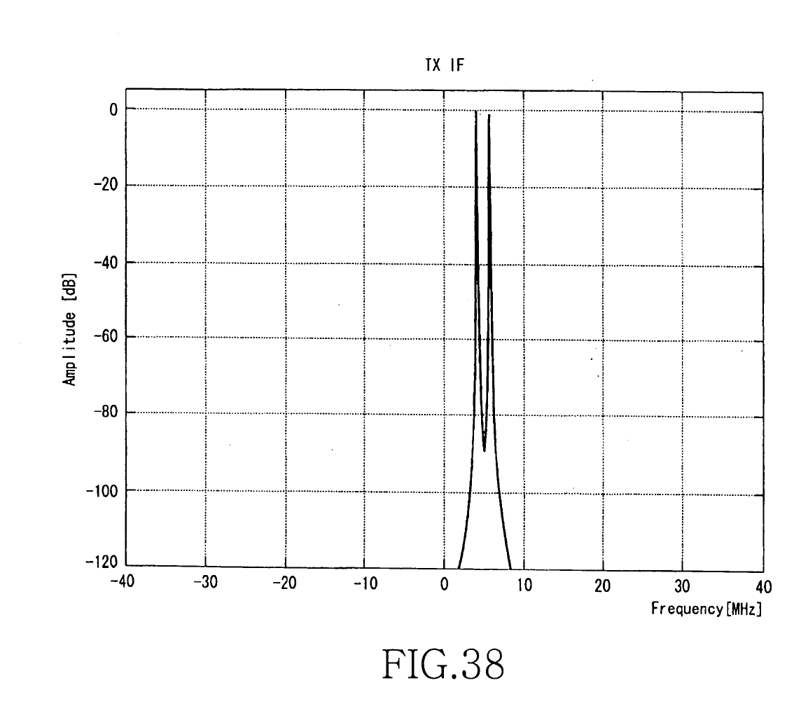

The full-complex mixer 306 converts the signal S30B to the signal frequency (B1=5 MHz) of the local oscillator (Locald) 305 according to a complex local signal of the frequency B1 input from the local oscillator (Locald) 305. As illustrated in FIG. 38, the complex signal S30C of the IF signal corresponding to the DSB signal based on the center frequency of 5 MHz is output to the input terminals for the real and imaginary parts of the complex-coefficient transversal filter 307. The complex-coefficient transversal filter 307 suppresses the negative frequency of the complex signals S30C and outputs a complex signal S30D to the full-complex mixer 309.

The full-complex mixer 309 frequency-converts the complex signal S30D to the frequency of the RF signal according to the complex local signal of the frequency B2 input from the local oscillator (Locale) 308, and outputs a complex signal S30E corresponding to an RF signal to the input terminals for the real and imaginary parts of the complex-coefficient transversal filter 310. The complex-coefficient transversal filter 310 suppresses the negative frequency of the complex signal S30E, subtracts a signal obtained by passing the imaginary part S30EQ of the complex signal S30E through the BPF-Q from a signal obtained by passing the real part S30EI of the complex signal S30E through the BPF-I, and outputs a real RF signal to an output terminal TORF of the upconverter 31.

K. Detailed Operation of Full-Complex Mixer 309 in Upconverter 31 of Low-IF Scheme

The operation of the full-complex mixer 309 in the upconverter 31 will be described in more detail. In this case, the same image rejection ratio can be obtained between the full-complex mixer 309 and the half-complex mixer 313 (or a mixer based on a complex input, a complex local signal, and a real output) of the upconverter 38 illustrated in FIG. 37. Next, the half-complex mixer 313 of FIG. 37 will be described. It is assumed that a complex IF signal corresponding to a DSB signal of a carrier frequency=5 MHz and a carrier interval=1.6 MHz is input to the input terminals for the real and imaginary parts of the half-complex mixer 313.

It is ideal that a spectrum of the complex local signal is present at a positive frequency of f_{c}. Because an error occurs between amplitudes of real and imaginary parts of the complex local signal, a low-level spectrum is present at a negative frequency of −f_{c} as described below.

When the complex signal S30D corresponding to the complex IF signal is regarded as an ideal complex signal corresponding to a signal s_{rfi}(t)+js_{rfq}(t), the amplitude of the above-described complex local signal is A, the complex local signal is A(Lₒᵢ(t)+jL_{oq}(t)), the amplitude error between the real and imaginary parts of the above-described complex local signal is Aₑ, and a complex RF signal S30E0 is a signal s_{rf}(t), Equation (13) is obtained.

$$\begin{matrix}{s}_{rf} ( t ) = ( {s}_{ifi} ( t ) + j {s}_{ifq} ( t ) ) ( ( A + {A}_{e} ) {L}_{oi} ( t ) + j ( A - {A}_{e} ) {L}_{oq} ( t ) ) \\ = ( {s}_{ifi} ( t ) + j {s}_{ifq} ( t ) ) ( A ( {L}_{oi} ( t ) + j {L}_{oq} ( t ) ) + \\ {A}_{e} ( {L}_{oi} ( t ) - j {L}_{oq} ( t ) ) )\end{matrix} \qquad Equation ( 13 )$$

As shown in the second term of Equation (13), a frequency conversion process (reverse to a target frequency conversion process) is performed due to an error signal based on the amplitude error Aₑ between the real and imaginary parts of the complex local signal. When only a real part of s_{rf}(t) corresponding to the complex signal S30E0 is extracted, s_{rf}′(t) is defined as shown in Equation (14).

$$\begin{matrix}{s}_{rf}^{′} ( t ) = Re ( {s}_{ifi} ( t ) + j {s}_{ifq} ( t ) ) ( A ( {L}_{oi} ( t ) + j {L}_{oq} ( t ) ) + \\ {A}_{e} ( {L}_{oi} ( t ) - j {L}_{oq} ( t ) ) ) \\ = A ( {s}_{ifi} ( t ) {L}_{oi} ( t ) - {s}_{ifq} ( t ) {L}_{oq} ( t ) ) + \\ {A}_{e} ( {s}_{ifi} ( t ) {L}_{oi} ( t ) + {s}_{ifq} ( t ) {L}_{oq} ( t ) )\end{matrix} \qquad Equation ( 14 )$$

As shown in Equation (14) for s_{rf}′(t), the first term indicates a signal for which a frequency conversion process is performed in a plus direction according to a non-error signal of the local signal, and the second term indicates a complex conjugate signal of a signal for which a frequency conversion process is performed in a minus direction according to an error signal of the local signal.

When the reduction of an image rejection ratio due to a phase error is considered, the image rejection ratio IMRₘᵢₓ is computed as shown in Equation (4). When an error of 10% is present between amplitudes of the real and imaginary parts I and Q output from the local oscillator (Locale) 308 and a phase error φₑ=0 (indicating the case where no phase error is present) as an example in which an image rejection ratio is reduced, Aₑ=0.1 and cos φₑ=1. In this case, the image rejection ratio IMRₘᵢₓ in an output terminal of the above-described half-complex mixer 313 is 26 dB according to the computation of Equation (4).

L. Complex-Coefficient Transversal Filter 310 in Upconverter 31 of Low-IF Scheme

Next, there will be described the overview and design method of the complex-coefficient transversal filter 310 within the upconverter 31. The complex-coefficient transversal filter 310 converts an RF signal from a complex signal to a real signal while suppressing a negative frequency. The complex-coefficient transversal filter 310 includes a transversal filter for performing a convolution integral with an even symmetric impulse to process a real part S30EI of a complex signal S30E, a transversal filter for performing a convolution integral with an odd symmetric impulse to process an imaginary part S30EQ of the complex signal S30E, and a subtractor. Like the above-described complex-coefficient transversal filter 115, characteristics of the two transversal filters are optional. The two transversal filters output signals with a phase difference of 90 degrees, and the subtractor combines the output signals. A process for converting the RF signal from the complex signal to the real signal is conventionally realized in a phase shifter.

Like the above-described complex-coefficient transversal filter 115, the complex-coefficient transversal filter 310 may be designed using a frequency shift method. A real-coefficient LPF of a predetermined pass bandwidth Bw/2 and a stop-band attenuation amount ATT is designed and a coefficient of the real-coefficient LPF is multiplied by e^{jax}, such that a filter of a center frequency ω, a pass bandwidth Bw, and a stop-band attenuation amount ATT can be obtained. Here, the complex-coefficient transversal filter 310 is designed in which a center frequency ω=800 MHz and a stop-band attenuation amount ATT=39 dB.

FIG. 3 illustrates an impulse response of a real part of the complex-coefficient transversal filter that is even symmetric with respect to the center of the impulse response. FIG. 4 illustrates an impulse response of an imaginary part of the complex-coefficient transversal filter that is odd symmetric with respect to the center of the impulse response. The above-described complex-coefficient transversal filter has a sampling frequency of 2.4 GHz. The impulse responses of the real and imaginary parts of the above-described complex-coefficient transversal filter 310 are the same as those of the above-described complex-coefficient transversal filter 115.

Next, an operation for outputting the complex signal S30E from the full-complex mixer 309 to the complex-coefficient transversal filter 310 will be described. In FIG. 21, it is assumed that the frequency of the local oscillator (Locald) 305 is 5 MHz, and the frequency of the local oscillator (Locale) 308 is 795 MHz. Moreover, it is assumed that an amplitude error between the real and imaginary parts I and Q of the local signal output from the local oscillator (Locale) 308 is 10%.

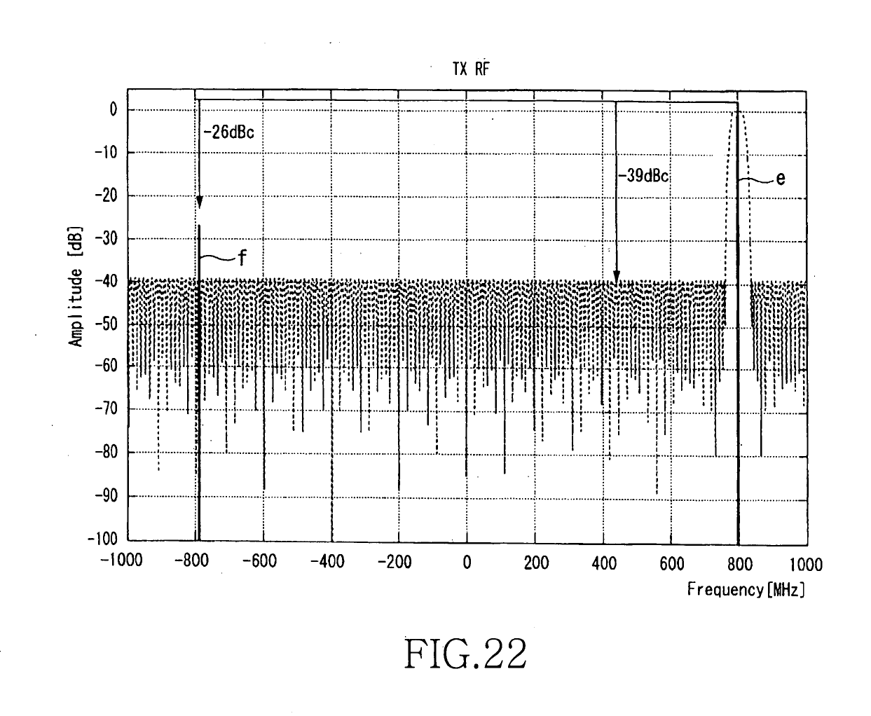

When the amplitude error between the real and imaginary parts I and Q of the local signal output from the local oscillator (Locale) 308 is 10% as described above, the full-complex mixer 309 performs a frequency conversion process from the complex signal S30D (of the IF signal) to the complex signal S30E (of the RF signal), i.e., a frequency conversion process (of −795 MHz) reverse to a frequency conversion process of +795 MHz from the IF signal frequency (5 MHz) to the RF (800 MHz). As illustrated in FIG. 22, the frequency conversion process for −790 MHz (corresponding to the image frequency) generates a signal (i.e., the image frequency signal) that is −26 dB lower than a signal (i.e., the target signal) based on the frequency conversion process of +795 MHz. In the complex signal S30E, the full-complex mixer 309 can obtain an image rejection ratio of −26 dB.

Next, the operation of the complex-coefficient transversal filter 310 will be described in more detail. FIG. 22 illustrates frequency characteristics of the complex-coefficient transversal filter 310. From FIG. 22, it can be seen that the dashed line denotes frequency characteristics of the complex-coefficient transversal filter 310, a target signal e (or the complex signal S30E) is in a pass band of the complex-coefficient transversal filter 310, and an image frequency signal f at a negative frequency is out of the pass band, and −39 dB is suppressed. The complex-coefficient transversal filter 310 can obtain the image rejection ratio of −39 dB for a real RF signal.

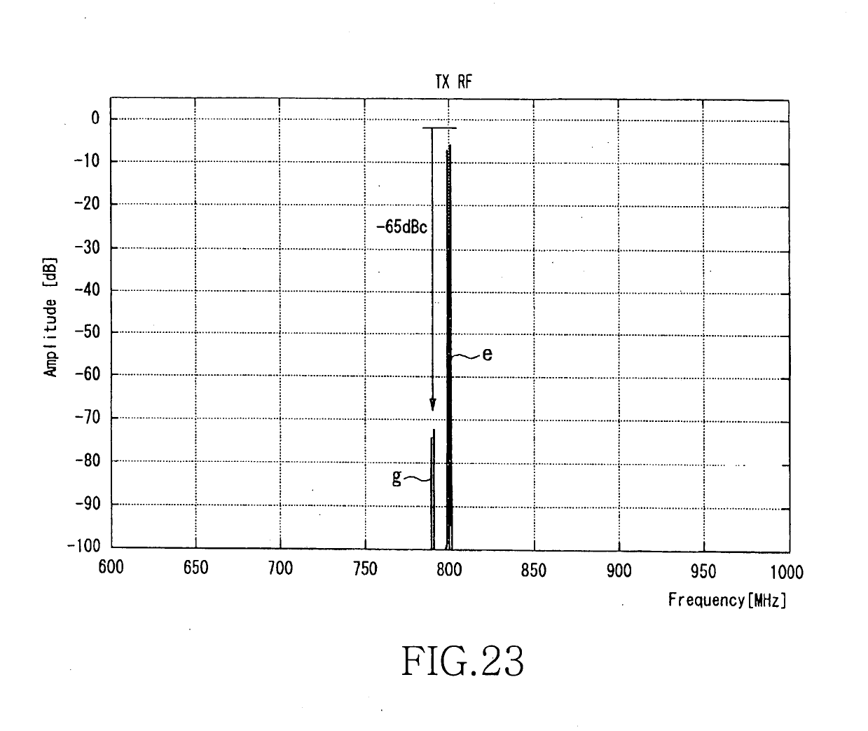

In the upconverter 31 of FIG. 21, the full-complex mixer 309 can obtain an image rejection ratio of −26 dB for the complex signal S30D, and the complex-coefficient transversal filter 310 can obtain an image rejection ratio of −39 dB. The signal f is further suppressed by −39 dB. A real RF signal has a spectrum constructed by a signal e (or the target signal) and a signal g (or an image frequency signal) illustrated in FIG. 23. As illustrated in FIG. 23, the signal g is suppressed by −65 dB for the signal e. In other words, the image rejection ratio of −65 dB can be obtained for the target signal.

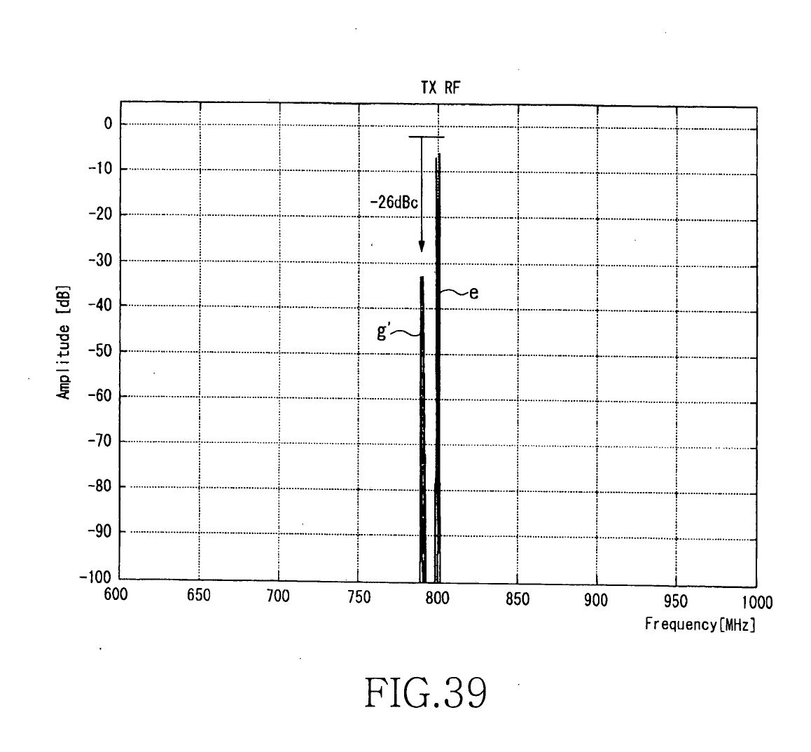

When the frequency of the local oscillator (Locald) 305 is 5 MHz and the frequency of the local oscillator (Locale) 308 is 795 MHz, a spectrum of the signal S30E2 from the output terminal of the half-complex mixer 313 is illustrated in FIG. 39. As illustrated in FIG. 39, a signal g′ at Frequency=790 MHz is only suppressed by −26 dB as compared with the signal e (or the target signal) at Frequency=800 MHz. The full-complex mixer 309 and the complex-coefficient transversal filter 310 improve the image rejection ratio of −65 dB as compared with the half-complex mixer 313.

The following effects are provided. That is, an unnecessary band signal is suppressed according to the effect of suppressing the negative frequency in the full-complex mixer 309 and the effect of suppressing the negative frequency due to frequency characteristics of the complex-coefficient transversal filter 310. Because an additional circuit structure is not required for the improvement of the image rejection ratio and the rejection of an unnecessary band signal, a transmitter can be miniaturized.

On the other hand, the full-complex mixer 306 and the complex-coefficient transversal filter 307 convert the complex signal S30B corresponding to the complex baseband signal to the complex signal S30D corresponding to the complex IF signal while ensuring the image rejection ratio in the same principle as that of the full-complex mixer 309 and the complex-coefficient transversal filter 310.

M. Complex-Coefficient SAW Filter 360 in Upconverter of Low-IF Scheme

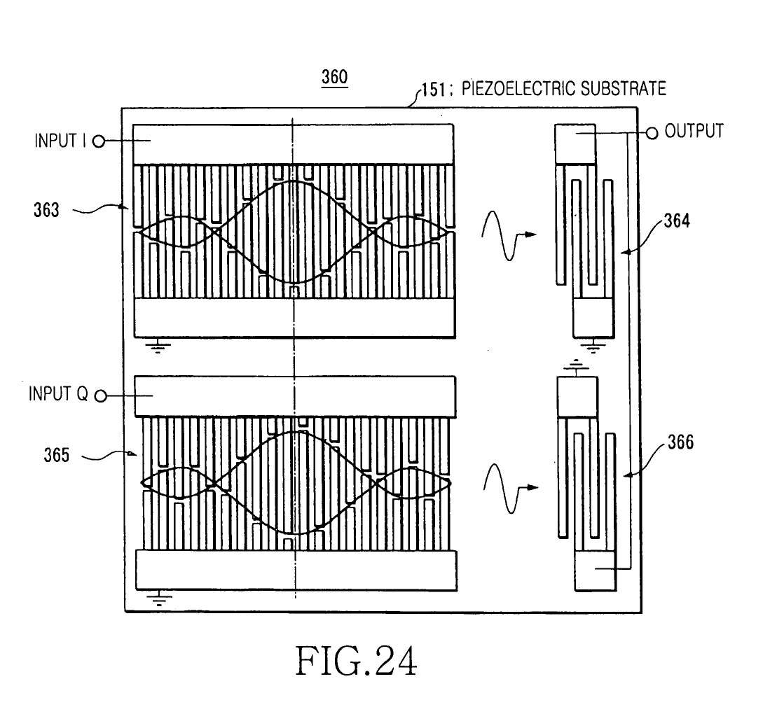

A complex-coefficient SAW filter 360 corresponding to an exemplary structure of the complex-coefficient transversal filter 310 of FIG. 21 will be described with reference to FIG. 24. Alternatively, the complex-coefficient transversal filter 310 may be implemented with a switch capacitor circuit and a CCD like the above-described complex-coefficient transversal filter 115. The SAW filter is suitable at a high frequency.

An example of a downconverter using the above-described complex-coefficient SAW filter 360 or 350 will be described with reference to first and second embodiments of the present invention as described below.

Like the complex-coefficient SAW filters 150, 157, 340, and 350, the complex-coefficient SAW filter 360 is implemented with a transversal SAW filter. IDTs 363˜366 are placed on a surface of a piezoelectric substrate 151. The IDTs 363˜366 have the comb shape and are configured by two electrode fingers alternately opposite to each other.

The IDTs 152, 153, 154, and 155 of the complex-coefficient SAW filter 150 are replaced with the IDTs 363˜366 of the complex-coefficient SAW filter 360. Electrode fingers in the same position relation of the IDTs 363 and 365 are commonly grounded to the piezoelectric substrate 151, and the other electrode fingers of the IDTs 363 and 365 are coupled to input terminals I and Q. A weighting process mapped to the impulse response of the real part is made for the electrode finger of the IDT 363. A weighting process mapped to the impulse response of the imaginary part is made for the electrode finger of the IDT 365.

The electrode fingers of the IDTs 364 and 366 opposite to the IDTs 363 and 365 are commonly grounded to the piezoelectric substrate 151. The other electrode fingers of the IDTs 364 and 366 are commonly connected to an output terminal.

Because the electrode fingers are connected as described above, SAWs excited from the IDTs 363 and 365 opposite to the IDTs 364 and 366 on the piezoelectric substrate 151 are received and the polarity of a signal output to the output terminal is inverted. Accordingly, the IDTs 364 and 366 subtract a signal input by the IDT 365 from a signal input by the IDT 363. When the complex-coefficient SAW filter 360 is configured as described above, a process for subtracting the signal of the input terminal Q from the signal of the input terminal I can be performed within the complex-coefficient SAW filter 360.

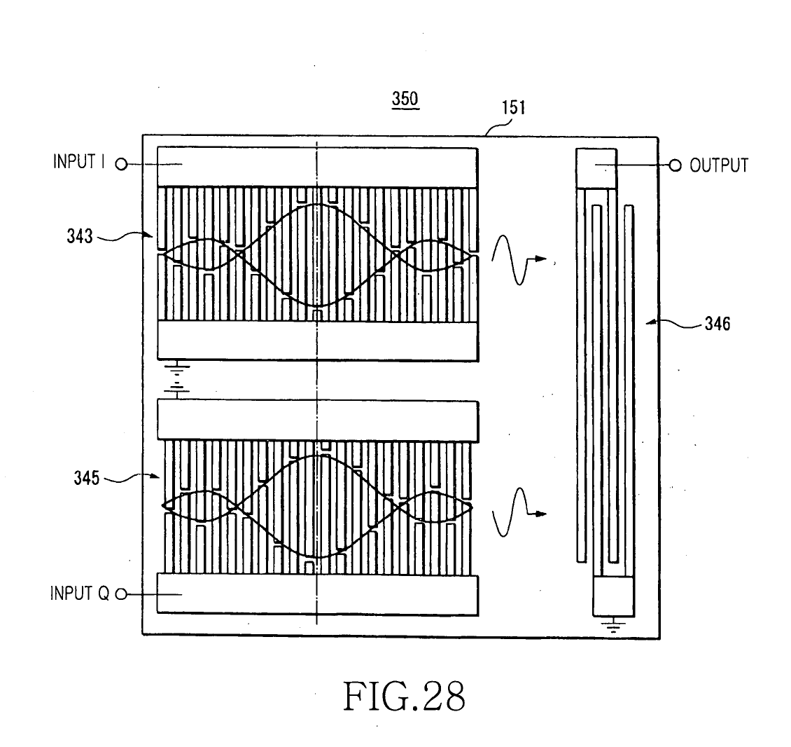

As illustrated in FIG. 28, the complex-coefficient SAW filter 360 may be replaced with the complex-coefficient SAW filter 350 of a structure in which an output IDT 346 is placed across two propagation paths of the SAWs formed between the input IDTs 343 and 345 opposite thereto.

N. Principle of Downconverter Based on Zero-IF Scheme

Next, the operation principle of the zero-IF scheme of the present invention will be described with reference to an example of the downconverter of the zero-IF scheme in the present invention.

O. Example of Basic Structure of Downconverter Based on Zero-IF Scheme

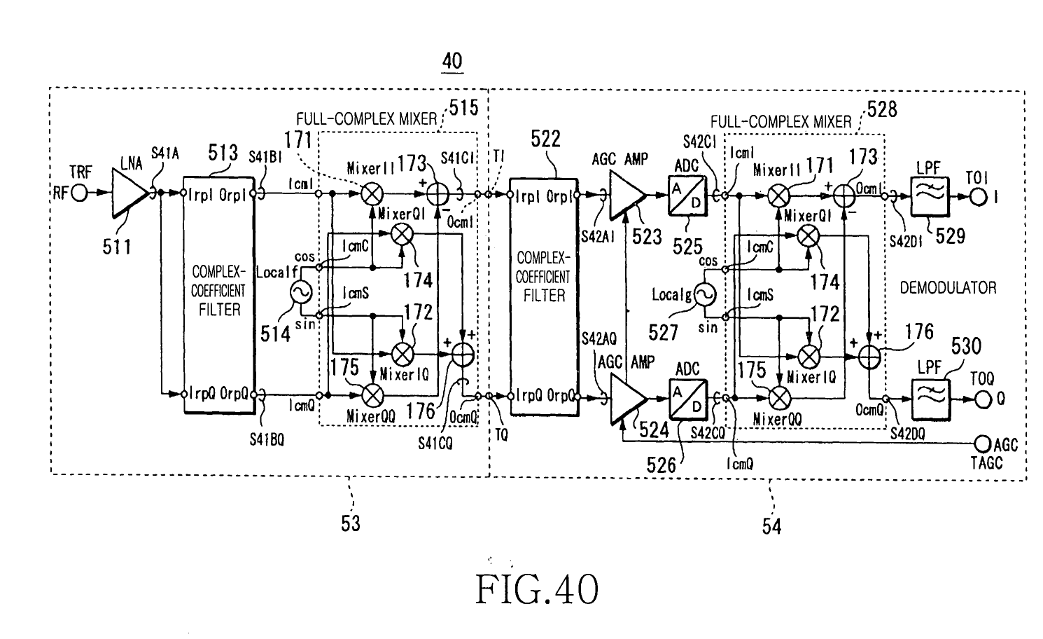

First, the example of the downconverter of the zero-IF scheme in the present invention will be described with reference to FIG. 40. For example, the downconverter 40 is a radio receiver. The downconverter 40 converts an RF signal input from an input terminal TRF connected to an antenna to a complex RF signal, outputs the complex RF signal from a local oscillator (Localf) 514, generates a complex baseband signal according to a complex local signal at the same frequency as an RF signal frequency, and outputs the complex baseband signal to a demodulator. As compared with a downconverter of a quasi-zero-IF scheme as described below, the downconverter 40 of the zero-IF scheme includes an IF generator 53 connected to terminals TI and TQ and a baseband generator 54.

The IF generator 53 is configured by an LNA 511, a complex-coefficient filter 513, the local oscillator (Localf) 514, and a full-complex mixer (or complex mixer) 515. As described below, the complex-coefficient filter 513 and the full-complex mixer 515 prevent EVM-related degradation.

The complex-coefficient filter 513 receives a real signal S41A from input terminals IrpI and IrpQ, and outputs a real part S41BI and an imaginary part S41BQ of a complex signal S41B with a phase difference of 90 degrees from output terminals OrpI and OrpQ.

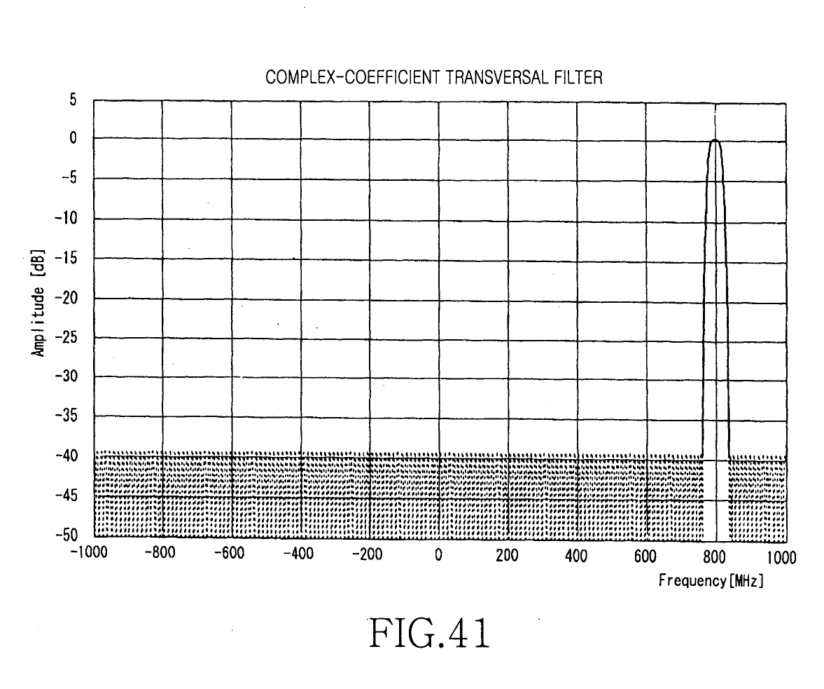

FIG. 41 illustrates an example of frequency characteristics of a complex-coefficient transversal filter used as the complex-coefficient filter 513 of the downconverter 40 in the present invention. An associated complex-coefficient transversal filter can be designed in the same method as that of the complex-coefficient transversal filter applied to the downconverter of the above-described low-IF scheme. In the downconverter 40, a filter is configured to reject an RF signal by 39 dB in a frequency band outside a frequency band of a predetermined range with the center of an RF signal frequency of 800 MHz as illustrated in FIG. 41.

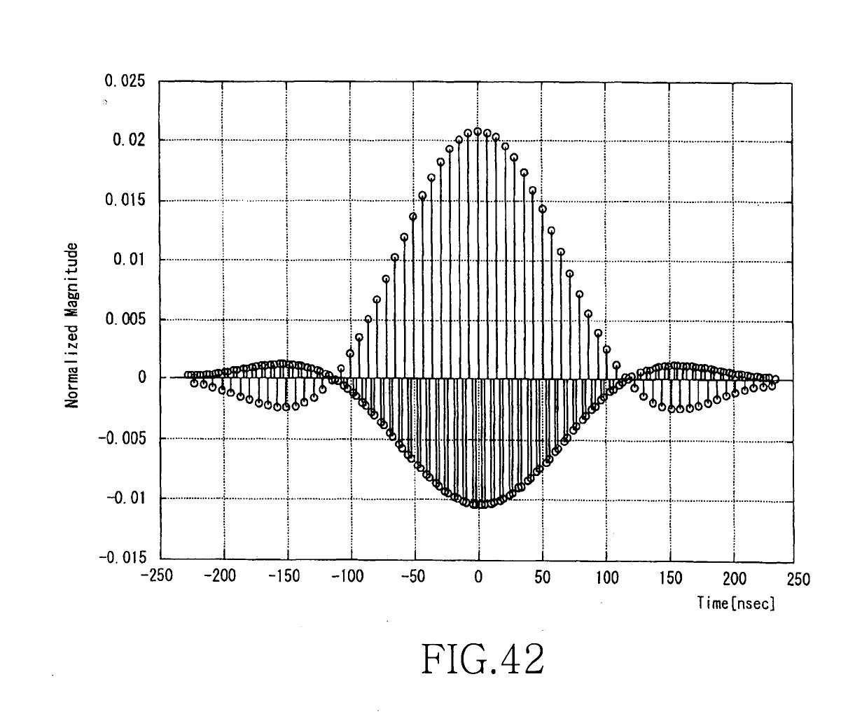

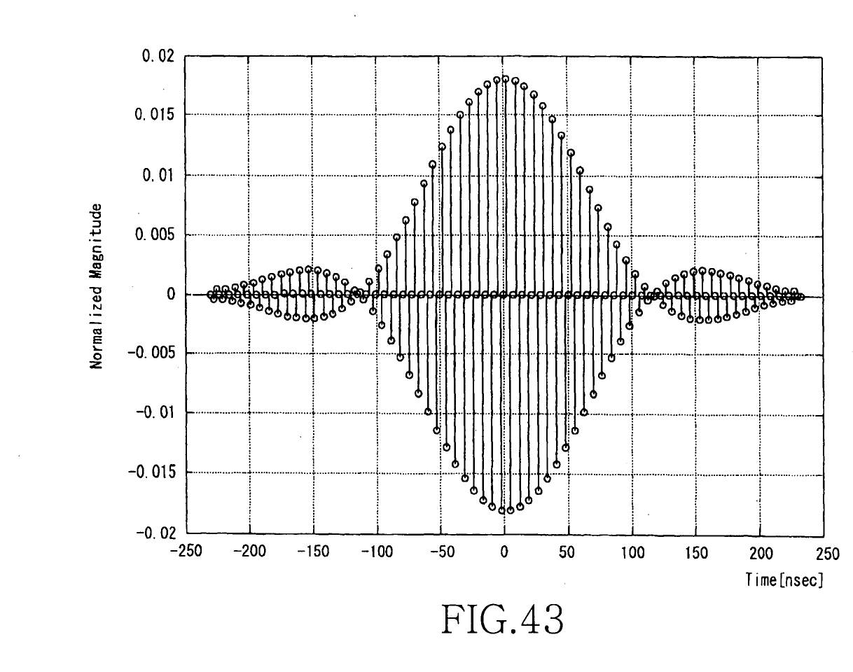

FIG. 42 illustrates an impulse response of a real part of the complex-coefficient transversal filter. The impulse response of the real part is even symmetric with respect to the center. FIG. 43 illustrates an impulse response of an imaginary part of the complex-coefficient transversal filter. The impulse response of the imaginary part is odd symmetric with respect to the center. A convolution integral process for the impulse responses and the input signals can output components of a complex signal with a phase difference of 90 degrees while suppressing a negative frequency signal. In FIGS. 42 and 43, the vertical axis represents the normalized magnitude.

The local oscillator (Localf) 514 has a frequency of a difference between the RF signal frequency and the IF, and sets the frequency to C1. Hereinafter, the complex local signal output from the local oscillator (Localf) 514 is referred to as the complex local signal of the frequency C1.

The full-complex mixer 515 frequency-converts the complex signal S41B to a frequency of a complex signal S41C, receives a real part of the complex local signal of the frequency C1 from the local oscillator (Localf) 514 through an input terminal IcmC, and receives an imaginary part of the complex local signal of the frequency C1 through an input terminal IcmS. The full-complex mixer frequency-converts the complex signal S41B input from input terminals IcmI and IcmQ to a signal of frequency zero, and outputs the complex signal S41C from output terminals OcmI and OcmQ.

The baseband generator 54 is configured as a complex-coefficient filter 522, AGC amplifiers 523 and 524, ADCs 525 and 526, a local oscillator (Localg) 527, a full-complex mixer 528, and LPFs 529 and 530.

The complex-coefficient filter 522 limits a frequency band out of a predetermined range based on the frequency of an IF signal for the input complex signal S41C, and outputs a complex signal S42A. The AGC amplifiers 523 and 524 control a gain according to voltage input from an input terminal TAGC.

To perform a digital signal process in a demodulator connected to a rear stage of the baseband generator 54, the ADCs 525 and 526 perform an A/D conversion process for a complex signal output from the AGC amplifiers 523 and 524, and output the complex signal S42C to the full-complex mixer 528.

A local oscillator (Localg) 527 has the same frequency as the IF, and sets the frequency as C2. Hereinafter, a complex local signal output from the local oscillator (Localg) 527 is referred to as the complex local signal of the frequency C2.

The full-complex mixer 528 has the same structure as the above-described full-complex mixer 117. The full-complex mixer 528 receives a real part of the complex local signal of the frequency C2 from the local oscillator (Localg) 527 through an input terminal IcmC and receives an imaginary part of the complex local signal of the frequency C2 from the local oscillator (Localg) 527 through an input terminal IcmS. The full-complex mixer 528 frequency-converts the complex signal S42C input from the ADCs 525 and 526 through input terminals IcmI and IcmQ to a baseband signal including a DC component, and outputs a complex signal S42D from output terminals OcmI and OcmQ.

When the frequency of the signal S41A corresponding to the RF signal is the same as an output frequency of the local oscillator (Localf) 514, the local oscillator (Localg) 527 and the full-complex mixer 528 are unnecessary. When the frequency of the signal S41A is different from the output frequency of the local oscillator (Localf) 514 as described below, the local oscillator (Localg) 527 and the full-complex mixer 528 are required.

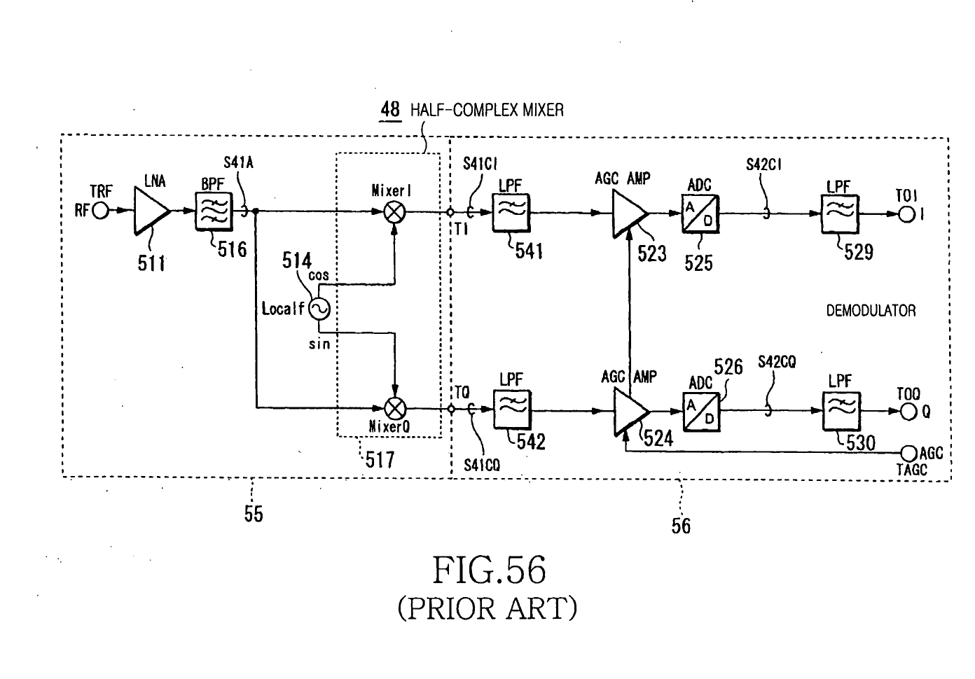

When the frequency of the signal S41A is the same as the output frequency of the local oscillator (Localf) 514, the following differences are present between the downconverter 40 (corresponding to a first basic structure of the downconverter of the zero-IF scheme of the present invention illustrated in FIG. 40) and the conventional downconverter 48 (of the zero-IF scheme illustrated in FIG. 56). That is, the downconverter 48 includes an IF generator 55 and a baseband generator 56. A BPF 516 of the IF generator 55 is replaced with the complex-coefficient filter 513 of the IF generator 53. A half-complex mixer 517 of the IF generator 55 for frequency-converting a real signal to a complex signal according to a complex local signal output from the local oscillator (Localf) 514 is replaced with the full-complex mixer 515 of the IF generator 53. The baseband generator 54 is different from the baseband generator 56 in that LPFs 541 and 542 of the baseband generator 56 are replaced with the complex-coefficient filter 522 of the baseband generator 54.

Next, the operation of the above-described downconverter 40 will be briefly described. The LNA 511 amplifies a real RF signal input from an input terminal TRF and outputs the real signal S41A. The complex-coefficient filter 513 receives the signal and outputs complex signal S41B to the full-complex mixer 515. The full-complex mixer 515 performs frequency conversion to a complex local signal at the same frequency as frequency zero or an IF according to a complex local signal of the frequency C1 2 Hz input from the local oscillator (Localf) 514, and outputs a complex signal S41C to the complex-coefficient filter 522.

The complex-coefficient filter 522 band-limits the complex signal S41C and outputs a complex signal S42A to the AGC amplifiers 523 and 524. The AGC amplifiers 523 and 524 adjust amplitudes of a real part S42AI and an imaginary part S42AQ of the complex signal S42A to amplitudes suitable for input to the ADCs 525 and 526, and output signals with the adjusted amplitudes to the ADCs 525 and 526. The ADCs 525 and 526 perform A/D conversion processes for the input signals and output a complex signal S42C to the full-complex mixer 528.

The full-complex mixer 528 frequency-converts the complex signal S42C to a baseband signal of frequency zero according to the complex local signal of the frequency C2 output from the local oscillator (Localg) 527, and outputs a complex signal S42D to the LPFs 529 and 530. The LPFs 529 and 530 band-limit the complex signal S42D and output real and imaginary parts I and Q of a baseband signal to a demodulator.

On the other hand, when the frequency of the signal S41A corresponding to the RF signal is the same as the output frequency of the local oscillator (Localf) 514, the ADCs 525 and 526 directly output the complex signal S42A to the LPFs 529 and 530.

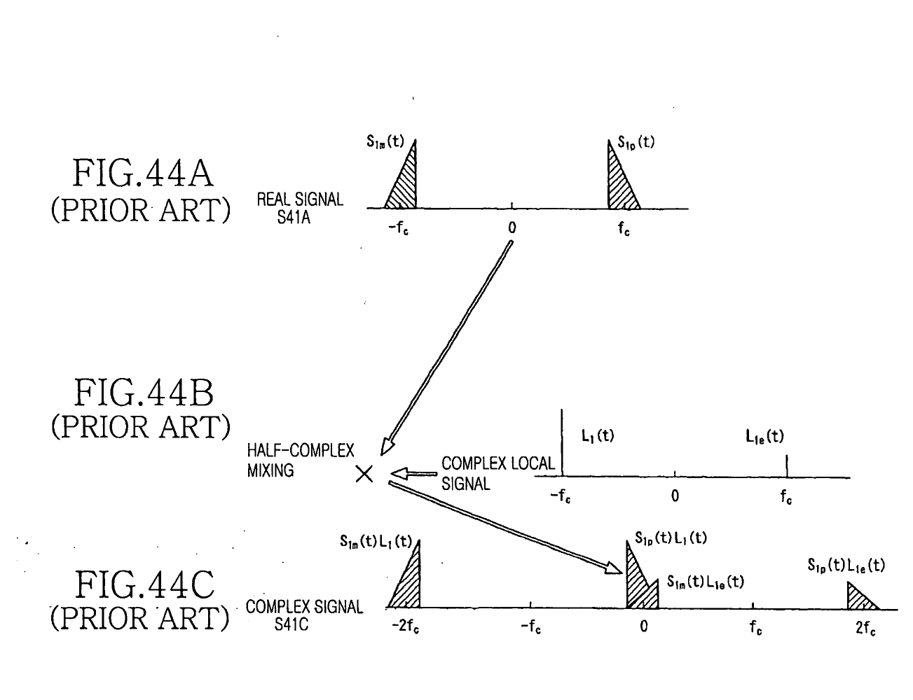

For the reason described below, a process for suppressing an image frequency signal in the full-complex mixer 515 of the downconverter 40 will be described with reference to FIG. 44 (that illustrates a process for suppressing an image frequency signal on the complex frequency axis in a half-complex mixer 517 within the conventional downconverter 48). That is, the full-complex mixer 515 and the half-complex mixer 517 illustrated in FIG. 56 perform an identical process (or an identical time domain process for frequency shift).
Next, the half-complex mixer 517 illustrated in FIG. 56 will be described. As illustrated in FIG. 44(a), it is assumed that the real signal S41A has a signal s₁ₚ(t) whose signal band includes a positive frequency f_{c} of the complex local signal output from the local oscillator (Localf) 514 in the spectrum on the complex frequency axis. Because the real signal S41A is a combination of complex signal components of mutual complex conjugates as described above, the real signal S41A is set as s_{rf}(t) and is defined in Equation (15).

$$\begin{matrix}\begin{matrix}{s}_{rf} ( t ) = \frac{{s}_{1 i} ( t ) + {js}_{1 q} ( t )}{2} + \frac{{s}_{1 i} ( t ) - {js}_{1 q} ( t )}{2} \\ = {s}_{1 p} ( t ) + {s}_{1 m} ( t )\end{matrix} & Equation ( 15 ) \\ {s}_{1 p} ( t ) = \frac{{s}_{1 i} ( t ) + {js}_{1 q} ( t )}{2} , {s}_{1 m} ( t ) = \frac{{s}_{1 i} ( t ) - {js}_{1 q} ( t )}{2} & Equation ( 16 )\end{matrix}$$

As illustrated in FIG. 44(a), the real signal S41A has signals s₁ₚ(t) and s₁ₘ(t) corresponding to a conjugate signal of the signal s₁ₚ(t) at a negative frequency −f_{c} of the complex local signal in the spectrum on the complex frequency axis. On the other hand, the signals s₁ₚ(t) and s₁ₘ(t) have the same amplitude as each other.

It is ideal that the above-described complex local signal has only a non-error signal at the negative frequency −f_{c} in the spectrum on the complex frequency axis. In this case, the frequency of the complex local signal is the negative frequency. However, the complex local signal actually has a non-error signal L₁(t) and an error signal L₁ₑ(t) at the positive frequency f_{c} as illustrated in FIG. 44(b) because an amplitude error Aₑ between the real and imaginary parts is present. Therefore, a complex local signal L_{rf} is computed by Equation (7). The half-complex mixer 517 performs a half-complex mixing process (or a complex multiplication process) for the real signal S41A corresponding to s_{rf}(t) and the complex local signal L_{rf}(t), thereby generating the complex signal S41C. When the complex signal S41C is set as s_{bb}(t), Equation (17) is obtained.
s_{bb}(t)=(s₁ₚ(t)+s₁ₘ(t))L₁(t)+(s₁ₚ(t)+s₁ₘ(t))L₁ₑ(t) Equation (17)

The complex signal S41C includes signals in the spectrum on the complex frequency axis as illustrated in FIG. 44(c). In the following, these signals will be described.

When the signal s₁ₘ(t) whose signal band includes the negative frequency −f_{c} of the real signal S41A is multiplied by the non-error signal L₁(t) at the negative frequency −f_{c} of the complex local signal L_{rf}(t), a signal s₁ₘ(t) L₁(t) is generated at the frequency −2f_{c}, corresponding to twice the negative frequency of the complex local signal. When the signal s₁ₚ(t) whose signal band includes the positive frequency +f_{c} of the real signal S41A is multiplied by the error signal L₁ₑ(t) at the positive frequency +f_{c} of the complex local signal L_{rf}(t), a signal s₁ₚ(t) L₁ₑ(t) is generated at the frequency +2f_{c}, corresponding to twice the positive frequency of the complex local signal.

When the signal s₁ₚ(t) whose signal band includes the positive frequency +f_{c} of the real signal S41A is multiplied by the non-error signal L₁(t) at the negative frequency −f_{c} of the complex local signal L_{rf}(t), a signal s₁ₚ(t) L₁(t) is generated at a DC component (i.e., frequency zero). When the signal s₁ₘ(t) whose signal band includes the negative frequency −f_{c} of the real signal S41A is multiplied by the error signal L₁ₑ(t) at the positive frequency +f_{c} of the complex local signal L_{rf}(t), a signal s₁ₘ(t) L₁ₑ(t) is generated at frequency zero.

As is apparent from the above description, the following phenomenon occurs at frequency zero. That is, because the signals s₁ₚ(t) L₁(t) and s₁ₘ(t) L₁ₑ(t) are present at the same frequency (or frequency zero), they interfere with each other. The signal s₁ₘ(t) whose signal band includes the negative frequency −f_{c} of the signal symmetric with respect to frequency zero interferes with the signal s₁ₚ(t).

At this time, a signal symmetric with respect to frequency zero interferes with an arbitrary signal. This interference is referred to as the image (or mirror image) frequency interference.

Because a concept of the negative frequency is actually absent on the frequency axis in the downconverter of the zero-IF scheme, an image frequency associated with frequency zero is absent. When observation is extended to the complex frequency axis, the concept of the negative frequency can be applied and the concept of the image frequency interference associated with frequency zero can be applied.

With the observation extended to the complex frequency axis, EVM-related degradation in the downconverter of the zero-IF scheme will be described on the basis of the principle in which image frequency interference occurs in the downconverter of the low-IF scheme.

When an actual signal, i.e., a real signal, or a non-ideal complex signal has a signal at a positive frequency in the case of a downconverter with incomplete orthogonality as in an analog downconverter, a signal is present whose signal band includes the negative frequency symmetric with respect to a DC component associated with the positive frequency. As a result, a signal s₁ₘ(t) whose signal band includes the negative frequency −f_{c} corresponding to a signal symmetric with respect to frequency zero of the complex local signal interferes with the signal s₁ₚ(t). The signal s₁ₘ(t) generates an image frequency signal of the signal s₁ₚ(t). The image frequency signal occurs due to the signal s₁ₘ(t).

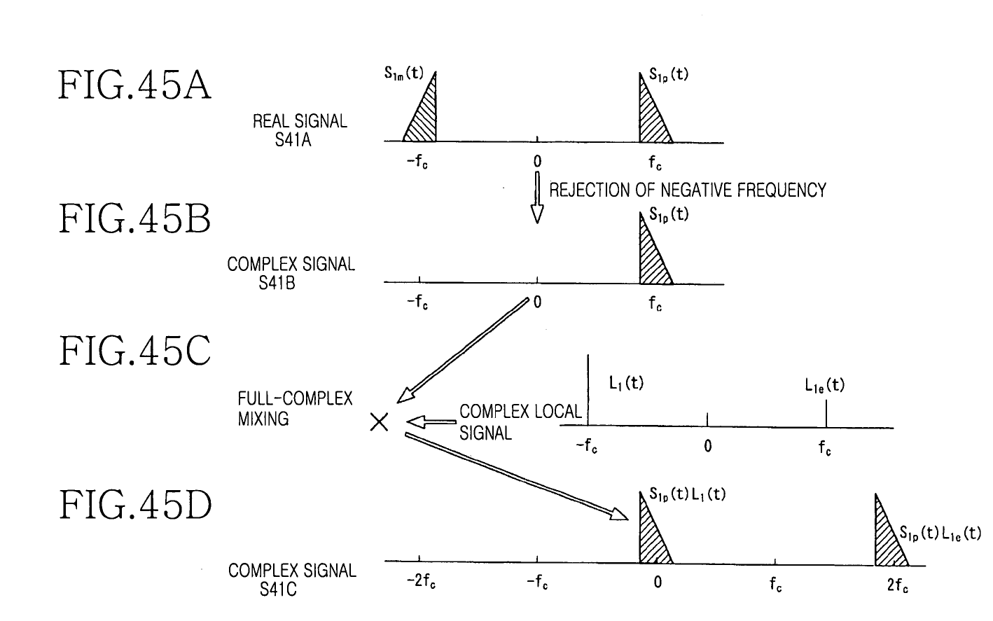

A process for suppressing an image frequency signal in a spectrum on the complex frequency axis in the complex-coefficient filter 513 and the full-complex mixer 515 of the downconverter 40 will be described with reference to FIG. 45. As illustrated in FIG. 45(a), the real signal S41A has a signal s₁ₚ(t) (whose signal band includes a positive frequency +f_{c} of the complex local signal) and a signal s₁ₘ(t) (whose signal band includes a negative frequency −f_{c} of the complex local signal) when the signal s₁ₘ(t) is a conjugate signal of the signal s₁ₚ(t) in the spectrum on the complex frequency axis, as in the conventional downconverter 48 of the zero-IF scheme. On the other hand, the signals s₁ₚ(t) and s₁ₘ(t) have the same amplitude as each other.

The real signal S41A is input to the complex-coefficient filter 513 and the complex signal S41B is output from the complex-coefficient filter 513. Here, the complex-coefficient filter 513 suppresses the negative frequency signal. As illustrated in FIG. 45(b), the complex signal S41B only has the signal s₁ₚ(t) whose signal band includes the positive frequency +f_{c} of the complex local signal in a spectrum on the complex frequency axis. Here, the complex signal S41B is set as s_{rf}′(t), Equation (18) is obtained.
s_{rf}′(t)=s₁ₚ(t) Equation (18)

The complex local signal output from the local oscillator (Localf) 514 is denoted by L_{rf}(t) associated with Equation (18) as illustrated in FIG. 45(c). The full-complex mixer 515 performs a full-complex mixing process (or a complex multiplication process) for the complex signal S41B of s_{rf}′(t) and the complex signal L_{rf}, thereby generating a complex signal S41C. When the complex signal S41C is set as s_{bb}(t), Equation (19) is obtained.
s_{bb}(t)=s₁ₚ(t)L₁(t)+s₁ₚ(t)L₁ₑ(t) Equation (19)

The complex signal S41C has signals in the spectrum on the complex frequency axis as illustrated in FIG. 45(d). When the signal s₁ₚ(t) whose signal band includes the positive frequency +f_{c} of the complex signal S41B is multiplied by the non-error signal L₁(t) whose signal band includes the negative frequency −f_{c} of the complex local signal L_{rf}, a signal s₁ₚ(t) L₁(t) is generated at a frequency close to a DC component.

Because a different signal is absent at the same frequency in the complex signal S41C of the downconverter 40 and image frequency interference does not occur, the downconverter 40 is different from the conventional downconverter 48. The complex-coefficient filter 513 rejects the negative frequency signal and therefore the image frequency signal does not occur.

EVM-related degradation occurs in the downconverter 40 when a mixer operates to convert only a positive frequency signal of the signal S41A corresponding to a real RF signal to a baseband. Due to incompleteness between the mixer and the local signal, the mixer performs a frequency conversion process based on a target component for converting the negative frequency signal of the real RF signal (or the complex conjugate signal of the positive frequency signal) to the baseband and performs a reverse frequency conversion process.

When a frequency conversion process at the complex frequency is considered as in the downconverter 8 of the low-IF scheme, a frequency conversion process, reverse to the target component, is performed in an identical manner associated with image frequency interference in the downconverter 1. From the above description, it can be seen that an interference signal based on a difference between a target signal frequency and a local signal frequency is generated according to a difference associated with a complex conjugate signal of an image frequency signal separated from a target signal or a complex conjugate signal of the target signal in the downconverters 1 and 40.

When a frequency input to the ADCs 125 and 126 of the downconverter 1 of the low-IF scheme illustrated in FIG. 1 is converted from the low IF to the baseband and the BPFs 121 and 122 are replaced with the complex-coefficient filter 522, the downconverter 40 of the zero-IF scheme illustrated in FIG. 40 is results. The full-complex mixer 129 is omitted such that the downconverter 40 serves as the downconverter of the zero-IF scheme. It can be seen that EVM of the downconverter 40 of the zero-IF scheme can be improved without improvement of the incompleteness between the local signal and the mixer or compensation based on a digital signal process, when the complex-coefficient filter suppresses a negative component of a real signal before frequency conversion.

Because an attenuation amount for the negative frequency signal in the complex-coefficient filter 513 is actually a finite value, the negative frequency signal cannot be completely suppressed. The overall performance of suppressing the EVM-related degradation is improved by a value obtained by the complex-coefficient filter 513 according to a value obtained by the full-complex mixer 515.

P. Principle of Downconverter of Quasi-Zero-IF Scheme

Next, the principle for suppressing EVM-related degradation in a downconverter of a zero-IF scheme will be described with an example of a basic structure of the zero-IF scheme in the present invention. The downconverter of the quasi-zero-IF scheme can employ a digital tuner, digital receiver, software radio device, etc.

As described above, the RF needs to match a local frequency to implement the downconverter of the zero-IF scheme. For this, a Phase Locked Loop (PLL) circuit is required which can perform tuning in a fine frequency step. When a fast reply as well as the tuning in the fine frequency step is required, an expensive fractional-N PLL circuit is necessary. Accordingly, an associated fractional-N PLL circuit is applied to a conventional radio receiver.

However, the use of the expensive fractional-N PLL circuit is not cost-effective because the tuning in the fine frequency step is possible in an internal digital processor such as the digital tuner, digital receiver, software radio device, or so on. The use of a circuit such as an associated fractional-N PLL circuit is not efficient in terms of size. The digital tuner, digital receiver, software radio device, etc. require a simple and compact structure.

That is, the downconverter of the quasi-zero-IF scheme uses an integer-N PLL circuit capable of satisfying cost and size-related requirements rather than the fractional-N PLL circuit in an analog circuit used in the zero-IF scheme. When the integer-N PLL circuit is used, an IF signal (or quasi-baseband signal) in which an offset is present with respect to frequency zero is output, but the downconverter of the quasi-zero-IF scheme can remove the offset from the IF signal in the digital processor and can obtain a baseband signal in which target frequency zero becomes the center frequency.

A difference between the downconverters of the low-IF scheme and the quasi-zero-IF scheme is as follows. The quasi-zero-IF scheme aims to perform conversion to frequency zero through frequency conversion based on a coarse frequency step in an analog circuit and frequency conversion based on a fine frequency step in a digital circuit. In the downconverter of the quasi-zero-IF scheme, an IF has a frequency value in a channel signal band of an RF signal. However, an IF has a frequency value out of a channel signal band in the downconverter of the low-IF scheme, such that the channel signal band does not overlap with an image frequency band.

Q. Example of Basic Structure of Downconverter Based on Quasi-Zero-IF Scheme

Here, an example of a basic structure of the downconverter of the quasi-zero-IF scheme will be described. The frequency of the signal S41A corresponding to an RF signal and an output frequency of the local oscillator (Localf) 514 in the downconverter 40 of the zero-IF scheme are different from those in the example of the basic structure of the downconverter based on the quasi-zero-IF scheme. For example, the downconverter 40 is a radio receiver. The downconverter 40 (FIG. 40) converts an RF signal input from an input terminal TRF connected to an antenna to a complex RF signal, outputs the complex RF signal from the local oscillator (Localf) 514, generates a complex baseband signal according to a complex local signal at the same frequency as an RF signal frequency, and outputs the complex baseband signal to a demodulator. As described above, the downconverter 40 includes an IF generator 53 connected to terminals TI and TQ and a baseband generator 54.

For example, the IF generator 53 converts an RF signal input from the input terminal TRF connected to the antenna to a complex RF signal. The IF generator 53 frequency-converts an associated complex RF signal to a value of a frequency separated by a predetermined frequency from frequency zero (or DC), output by the local oscillator according to a complex local signal of a frequency separated by a value of a frequency in an RF signal band. An associated frequency conversion process converts a complex signal frequency to a complex IF signal separated by a frequency value (hereinafter, referred to as an offset frequency) corresponding to a difference between an RF signal frequency and IF from a DC component. The baseband generator 54 converts the IF signal output from the IF generator 53 to a real part signal I and an imaginary part signal Q of the baseband signal, extracts the baseband signal, and outputs the extracted baseband signal to a demodulator. When a structure and operation of the above-described downconverter are similar to those of the downconverter of the zero-IF scheme, only differences will be described.

In the downconverter 40, the IF generator 53 performs a process for frequency-converting an RF signal to an IF signal in a state in which the resolution is not fine, and outputs the IF signal to the baseband generator 54. The baseband generator 54 performs a frequency conversion process with a fine resolution for the IF signal input from the IF generator 53, extracts the baseband signal, and outputs the extracted baseband signal to the demodulator.

As a value of a frequency separated by a predetermined frequency from DC, a frequency value in a signal band of the RF signal, i.e., an IF, is a predetermined frequency separated by an offset frequency from the center frequency of the RF signal in the signal band of the RF signal.

As described above, the downconverter 40 uses the full-complex mixer 515 of the first step for an analog process and the full-complex mixer 528 of the second step for a digital process after A/D conversion. For example, the downconverter 40 is used in a receiver using a digital receiver or software radio device.

A structure for suppressing a negative frequency band in the complex-coefficient filter used in the downconverter of the zero-IF scheme and the quasi-zero-IF scheme has been described. Alternatively, the complex-coefficient filter may have a structure for suppressing a positive frequency band and performing a process on the basis of a signal of an extracted negative frequency component.

R. Principle of Upconverter of Zero-IF Scheme

Next, the principle of suppressing EVM in an upconverter of a zero-IF scheme in the present invention will be described with reference to an example of a basic structure of the upconverter based on the zero-IF scheme in the present invention.

S. Example of Basic Structure of Upconverter Based on Zero-IF Scheme

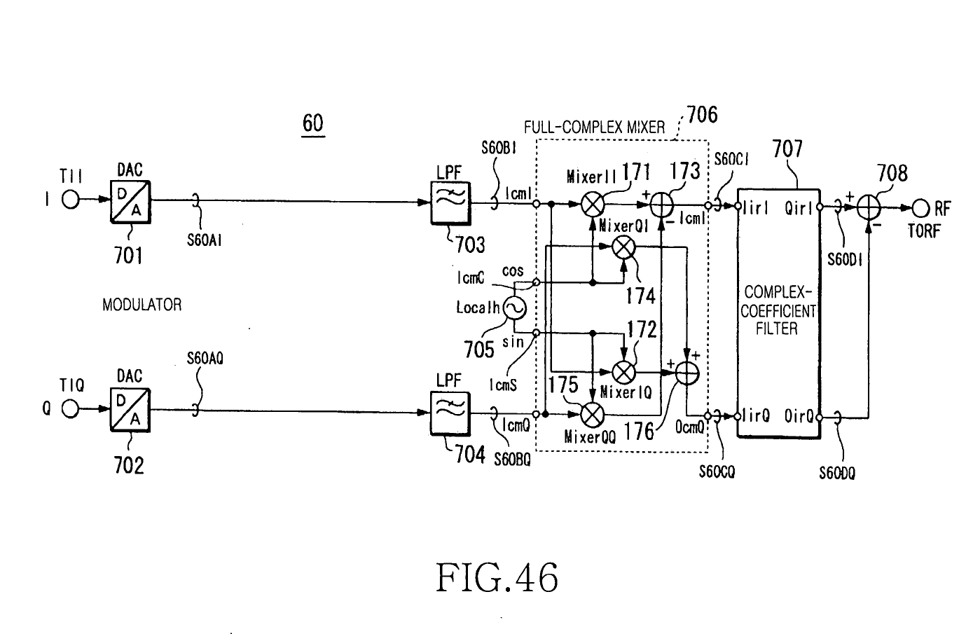

FIG. 46 illustrates the example of the basic structure of the upconverter of the zero-IF scheme in the present invention. For example, the upconverter 60 is a radio transmitter. The upconverter 60 converts digital signals received from input terminals TII and TIQ with real and imaginary parts to analog baseband signals, performs a frequency conversion process based on an RF signal frequency for the analog baseband signals, generates a complex RF signal, extracts only a real part of the complex RF signal, and outputs the extracted signal to an output terminal TORF connected to an antenna or so on.

The upconverter 60 includes DACs 701 and 702, LPFs 703 and 704, a local oscillator (Localh) 705, a full-complex mixer 706 (or a complex mixer), a complex-coefficient filter 707 (or a second complex-coefficient transversal filter), and a subtractor 708.

The DACs 701 and 702 convert digital signals input from the input terminals TII and TIQ to analog baseband signals. The LPFs 703 and 704 remove a high frequency component of a complex signal S60A output from the DACs 701 and 702, perform a waveform shaping process, and output a complex signal S60B. On the other hand, the LPFs 703 and 704 may use BPFs.

The local oscillator (Localh) 705 has a frequency of an RF signal and sets the frequency to D1. The complex local signal output from the local oscillator (Localh) 705 is referred to as the complex local signal of the frequency D1.

The full-complex mixer 706 has the same structure as the above-described full-complex mixer 117, and frequency-converts the complex signal S60B corresponding to a baseband signal to the frequency D1 of the local oscillator (Localh) 705 as a complex signals S60C corresponding to the RF signal. The full-complex mixer 706 receives a real part of the complex local signal of the frequency D1 from the local oscillator (Localh) 705 through an input terminal IcmC and receives an imaginary part of the complex local signal of the frequency D1 from the local oscillator (Localh) 705 through an input terminal IcmS. The full-complex mixer 706 frequency-converts the complex signal S60B input from input terminals IcmI and IcmQ to a frequency of an output signal of the local oscillator (Localh) 705, and outputs the complex signal S60C to output terminals OcmI and OcmQ.

The complex-coefficient filter 707 has an input terminal IirI for the real part, an input terminal IirQ for the imaginary part, an output terminal OirI for the real part and an output terminal OirQ for the imaginary part. The complex-coefficient filter 707 suppresses one of negative and positive frequencies and outputs a complex signal S60D to the subtractor 708. The subtractor 708 subtracts an imaginary part S60DQ from a real part S60DI of the complex signal S60D, and outputs a real RF signal from the output terminal TORF of the upconverter 60.

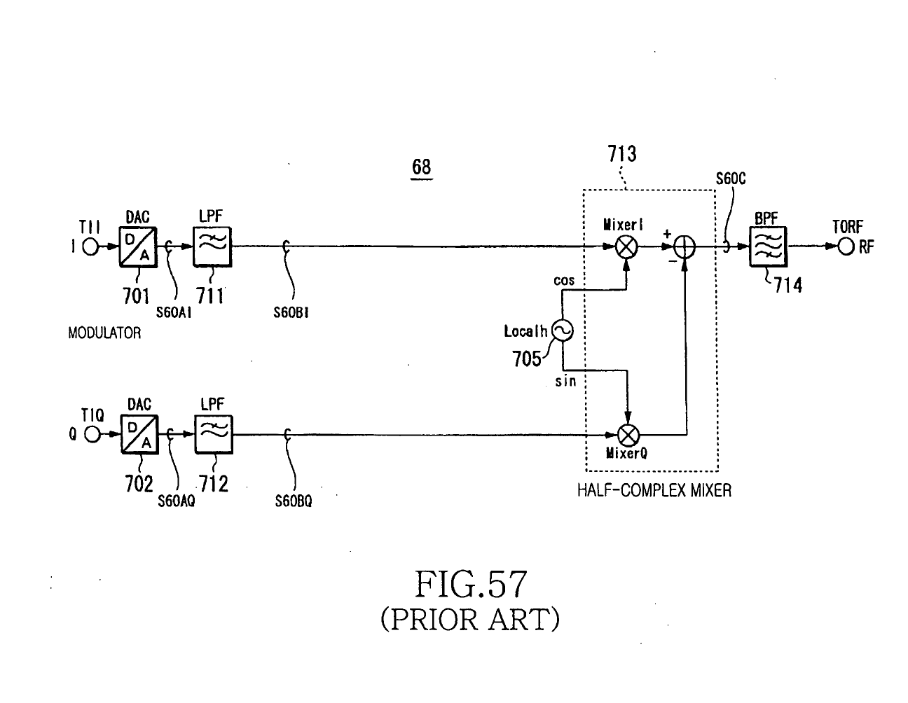

When the upconverter 60 corresponding to the basic structure of the upconverter of the zero-IF scheme of the present invention illustrated in FIG. 46 is compared with the conventional upconverter 68 illustrated in FIG. 57, the following differences are observed. That is, LPFs 711 and 712 of the upconverter 68 are replaced with the LPFs 703 and 704 that can be substituted with BPFs. A combination of a half-complex mixer 713 and a BPF 714 for frequency-converting a complex signal S60B corresponding to output signals of the LPFs 711 and 712 to a real signal according to a complex local signal output from the local oscillator (Localh) 705 is replaced with a combination of the full-complex mixer 706 for frequency-converting a complex signal S60B corresponding to output signals of the LPFs 703 and 704 to complex signal S60C according to a complex local signal output from the local oscillator (Localh) 705, the complex-coefficient filter 707 for performing a band-limiting operation while suppressing the negative or positive frequency of the complex signal S60C, and the subtractor 708 for outputting a real RF signal by subtracting an imaginary part S60DQ from a real part S60DI of the complex signal S60D output by the complex-coefficient filter 707.

Next, the operation of the above-described upconverter 60 will be briefly described. The DACs 701 and 702 convert real and imaginary part signals I and Q of a complex signal corresponding to a complex baseband signal input through input terminals TII and TIQ from digital signals to analog signals. The LPFs 703 and 704 remove a high frequency component of a complex signal S60A input from the DACs 701 and 702, perform a waveform shaping process, and output a complex signal S60B to the full-complex mixer 706.

The full-complex mixer 706 frequency-converts the signal S60B to the frequency D1 of the signal of the local oscillator (Localh) 705 according to the complex local signal of the frequency D1 input from the local oscillator (Localh) 705, and outputs a real part S60CI and an imaginary part S60CQ of the complex signal S60C of the IF signal to input terminals for the real and imaginary parts of the complex-coefficient filter 707. The complex-coefficient filter 707 outputs the real part S60DI and the imaginary part S60DQ of the complex signal S60D with a phase difference of 90 degrees to the subtractor 708 while suppressing the negative frequency of the complex signal S60C. The subtractor 708 subtracts the imaginary part S60DQ from the real part S60DI and outputs the real RF signal to the output terminal TORF of the upconverter 60.

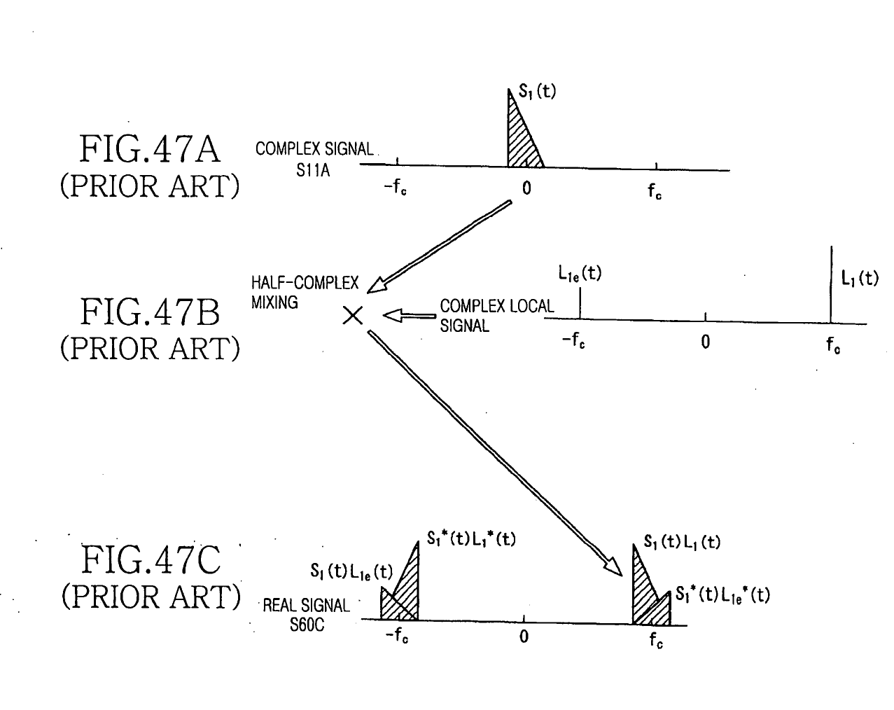

For explanation of a process for suppressing a signal causing EVM-related degradation in the above-described full-complex mixer 706, the upconverter 60 is compared with the conventional upconverter 68. FIG. 47 illustrates a process for suppressing EVM-related degradation in a spectrum on the complex frequency axis in the half-complex mixer 713 of the conventional upconverter 68.

As illustrated in FIG. 47(a), it is assumed that the complex signal S60B has a signal s₁(t) whose signal band includes frequency zero in the spectrum on the complex frequency axis. Here, when the complex signal S60B is s_{bb}(t), Equation (20) is obtained.
s_{bb}(t)=s₁ᵢ(t)+js₁ₚ(t)=s₁(t) Equation (20)

Next, the above-described complex local signal corresponding to the spectrum on the complex frequency axis ideally has only a non-error signal whose signal band includes a positive frequency +f_{c}. In this case, the frequency of the complex local signal is the positive frequency. However, the complex local signal actually has a non-error signal L₁(t) and an error signal L₁ₑ(t) whose signal band includes the negative frequency −f_{c} as illustrated in FIG. 47(b) because an amplitude error A1 between the real and imaginary parts is present. A complex local signal L_{rf}(t) is shown in Equation (7). The half-complex mixer 713 performs a half-complex mixing (or complex multiplication) operation on the complex signal S60B of s_{rf}(t) and the complex local signal L<(t) and generates a real signal S60C. When the real signal S60C is s_{rf}(t), Equation (21) is obtained.

$$\begin{matrix}{s}_{rf} ( t ) = Re [ {s}_{1} ( t ) ( {L}_{1} ( t ) + {L}_{1 e} ( t ) ) ] \\ = \frac{1}{2} ( {s}_{1} ( t ) {L}_{1} ( t ) + {s}_{1}^{*} ( t ) {L}_{i}^{*} ( t ) ) + \\ \frac{1}{2} ( {s}_{1} ( t ) {L}_{1 e} ( t ) + {s}_{1}^{*} ( t ) {L}_{ie}^{*} ( t ) )\end{matrix} \qquad Equation ( 21 )$$

In Equation (21), s₁^{•}(t), L₁^{•}(t), and L₁ₑ^{•}(t) are conjugate complex numbers of s₁(t), L₁(t), and L₁ₑ(t), respectively. Therefore, the real signal S60C has signals in the spectrum on the complex frequency axis as illustrated in FIG. 47(c). Next, the signals will be described.

When the signal s₁(t) whose signal band includes frequency zero of the complex signal S60B is multiplied by the non-error signal L₁(t) at the positive frequency +f_{c} of the complex local signal L_{rf}(t), a signal s₁(t) L₁(t) whose signal band includes the positive frequency +f_{c} of the complex local signal is generated. When the signal s₁(t) whose signal band includes frequency zero of the complex signal S60B is multiplied by the error signal L₁ₑ(t) at the negative frequency −f_{c} of the complex local signal L_{rf}(t), a signal s₁(t) L₁ₑ(t) whose signal band includes the negative frequency −f_{c} of the complex local signal is generated.

When the signal s₁^{•}(t) corresponding to the conjugate complex number of the signal s₁(t) is multiplied by the signal L₁ₑ^{•}(t) corresponding to the conjugate complex number of the error signal L₁ₑ(t) at the negative frequency −f_{c} of the complex local signal L_{rf}(t), a signal s₁^{•}(t) L₁ₑ^{•}(t) whose signal band includes the positive frequency +f_{c} of the complex local signal is generated. When the signal s₁^{•}(t) is multiplied by the signal L₁^{•}(t) corresponding to the conjugate complex number of the non-error signal L₁(t) at the positive frequency +f_{c} of the complex local signal L_{rf}(t), a signal s₁^{•}(t) L₁^{•}(t) whose signal band includes the negative frequency −f_{c} of the complex local signal is generated.

EVM-related degradation occurs at frequency zero. The signals s₁(t) L₁(t) and s₁^{•}(t) L₁ₑ^{•}(t) and the signals s₁(t) L₁ₑ(t) and s₁^{•}(t) L₁^{•}(t) are present at identical frequencies (of the positive frequency +f_{c} and the negative frequency −f_{c}), such that interference occurs between the signals. That is, EVM-related degradation associated with the signal s₁(t) occurs due to the signal s₁^{•}(t) whose signal band includes the negative frequency −f_{c} corresponding to a signal symmetric with respect to frequency zero.

When a signal of a positive frequency is present in an actual signal, i.e., a real signal, or a non-ideal complex signal, there is present a signal whose signal band includes the negative frequency symmetric with respect to a DC component associated with the positive frequency. As a result, the signal s₁^{•}(t) whose signal band includes the negative frequency −f_{c} corresponding to a signal symmetric with respect to frequency zero of the complex local signal interferes with the signal s₁(t). The signal s₁^{•}(t) causes the EVM-related degradation associated with the signal s₁(t), such that the signal s₁^{•}(t) interferes with the signal s₁(t).

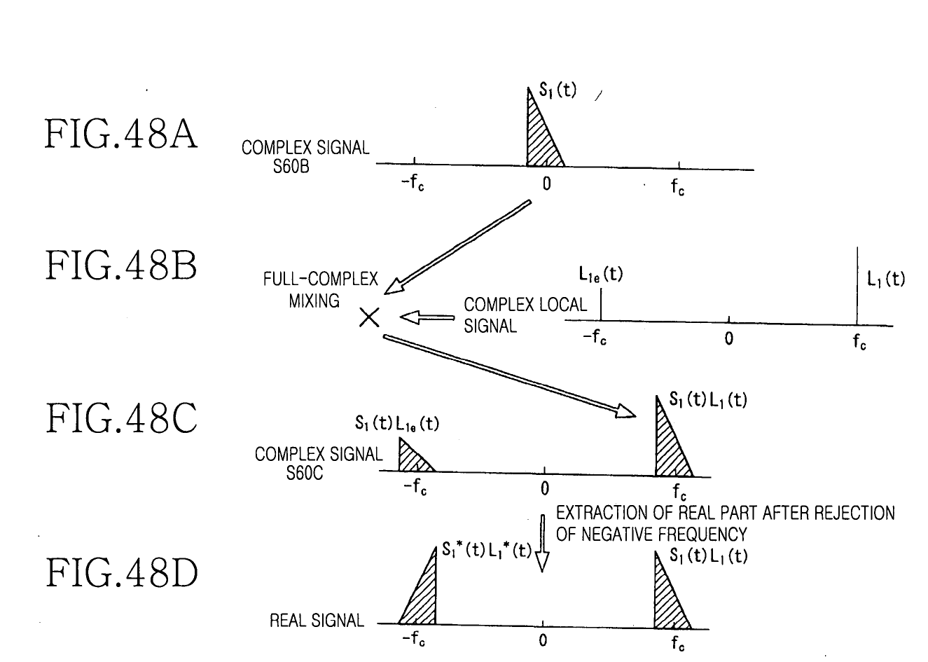

Next, a process for suppressing EVM-related degradation in a spectrum on the complex frequency axis in the complex-coefficient filter 707 and the full-complex mixer 706 of the upconverter 60 will be described with reference to FIG. 48.

As illustrated in FIG. 48(a), it is assumed that the complex signal S60B has a signal s₁(t) whose signal band includes frequency zero in the spectrum on the complex frequency axis as in the conventional upconverter 68 of the zero-IF scheme. Here, when the complex signal S60B is s_{bb}(t), Equation (20) is obtained.

Next, the above-described complex local signal corresponding to the spectrum on the complex frequency axis ideally has only a non-error signal whose signal band includes a positive frequency +f_{c}. In this case, the frequency of the complex local signal is the positive frequency. However, the complex local signal actually has a non-error signal L₁(t) and an error signal L₁ₑ(t) whose signal band includes the negative frequency −f_{c} as illustrated in FIG. 48(b) because an amplitude error Aₑ between the real and imaginary parts is present. A complex local signal L_{rf}(t) is shown in Equation (7). The full-complex mixer 706 performs a half-complex mixing (or complex multiplication) operation on the complex signal S60B of s_{rf}(t) and the complex local signal L_{rf}(t) and generates a complex signal S60C. When the complex signal S60C is set as s_{rf}(t), Equation (21) is obtained. The complex signal S60C has signals in the spectrum on the complex frequency axis as illustrated in FIG. 48(c). Next, the signals will be described.

When the signal s₁(t) whose signal band includes frequency zero of the complex signal S60B is multiplied by the non-error signal L₁(t) at the positive frequency +f_{c} of the complex local signal L_{rf}(t), a signal s₁(t) L₁(t) whose signal band includes the positive frequency +f_{c} of the complex local signal is generated.

When the signal s₁(t) whose signal band includes frequency zero of the complex signal S60B is multiplied by the error signal L₁ₑ(t) at the negative frequency −f_{c} of the complex local signal L_{rf}(t), a signal s₁(t) L₁ₑ(t) whose signal band includes the negative frequency −f_{c} of the complex local signal is generated.

Because the amplitude of the error signal L₁ₑ(t) is smaller than that of the non-error signal L₁(t) as described above, the amplitude of the signal L₁(t) L₁ₑ(t) is smaller than that of the signal L₁(t) L₁(t).

The full-complex mixer 706 is different from the half-complex mixer 713, and does not generate the signal s₁^{•}(t) L₁ₑ(t) and the signal s₁^{•}(t) L₁(t) when the complex conjugate signal s₁^{•}(t) is multiplied by the complex local signal L_{rf}(t).

The complex-coefficient filter 707 suppresses the negative frequency signal of the above-described complex signal S60C and the subtractor 708 performs a subtraction operation between the real part S60DI and the imaginary part S60DQ of the complex signal S60D output from the complex-coefficient filter 707, such that a real part is extracted. A real RF signal according to this process is defined by Equation (22).

$${s}_{rf} ( t ) = \frac{1}{2} ( {s}_{1} ( t ) {L}_{1} ( t ) + {s}_{1}^{*} ( t ) {L}_{i}^{*} ( t ) ) \qquad Equation ( 22 )$$

In this case, the complex-coefficient filter 707 suppresses the signal s₁(t) L₁ₑ(t) whose signal band includes the negative frequency −f_{c} of the complex local signal of the complex signal S60C illustrated in FIG. 48(c). The signal s₁(t) L₁(t) whose signal band includes the positive frequency +f_{c} of the complex local signal is combined with the real and imaginary parts in the subtractor 708. A real RF signal corresponding to a combined signal has the signal s₁(t) L₁(t) whose signal band includes the positive frequency +f_{c} and the signal s₁^{•}(t) L₁^{•}(t) whose signal band includes the negative frequency −f_{c} in the spectrum on the complex frequency axis. On the other hand, the signals s₁^{•}(t) and L₁^{•}(t) are the conjugate complex numbers of the signals s₁(t) and L₁(t).

Because a different signal is absent at the same frequency in the real RF signal of the upconverter 60, it is different from the conventional upconverter 68, such that EVM-related degradation does not occur. The complex-coefficient filter 707 rejects the negative frequency signal and therefore the EVM-related degradation does not occur.

Because an attenuation amount of the negative frequency signal in the complex-coefficient filter 707 is actually a finite value, the negative frequency signal cannot be completely rejected. The overall performance of suppressing the EVM-related degradation is improved by a value obtained by the complex-coefficient filter 707 in addition to a value obtained by the full-complex mixer 706.

T. Principle of Upconverter of Quasi-Zero-IF Scheme

Next, there will be described the principle of suppressing EVM-related degradation in an upconverter of a quasi-zero-IF scheme of the present invention corresponding to an example of a basic structure.

U. Example of Basic Structure of Upconverter Based on Quasi-Zero-IF Scheme

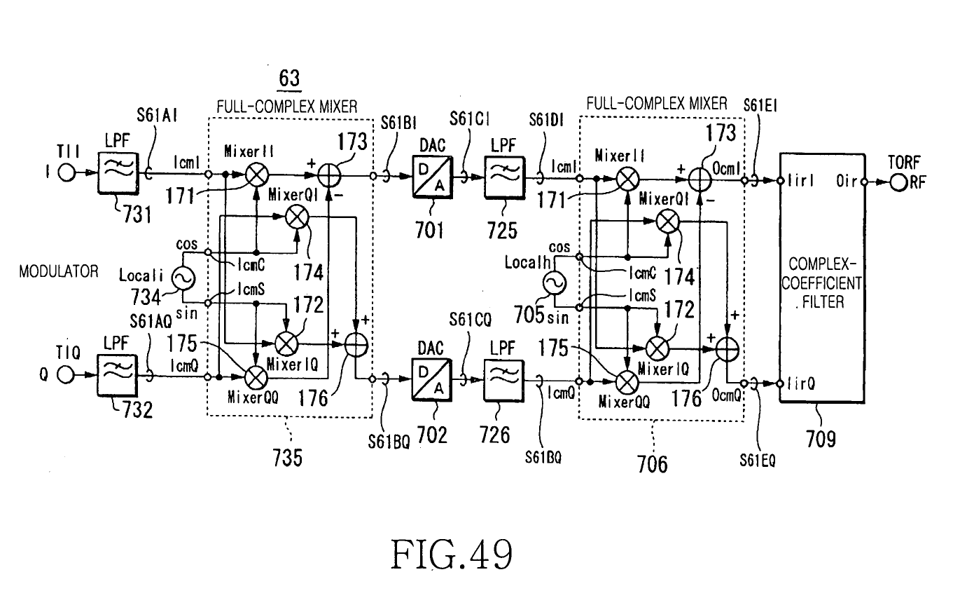

FIG. 49 illustrates an upconverter 63 corresponding to an example of a basic structure of the quasi-zero-IF scheme in the present invention. For example, the upconverter 63 is a radio transmitter. The upconverter 63 converts digital signals I and Q received from input terminals TII and TIQ with real and imaginary parts to analog baseband signals, and converts the analog baseband signals to a complex IF signal of an IF separated by an offset frequency value from DC according to a local signal for a coarse frequency conversion step output from a local oscillator (Locali) 734. The upconverter 63 frequency-converts an associated complex IF signal to a high frequency of an RF signal capable of being transmitted from an antenna, etc., the basis of a local signal for a fine frequency conversion step output from a local oscillator (Localh) 705, extracts only a real part of the complex RF signal, and transmits the extracted real part from an antenna and so on connected to an output terminal TORF.

The offset frequency in the above-described upconverter 63 is the frequency of the local signal for the coarse frequency conversion step. The frequency of the local signal for the coarse frequency conversion step indicates that a frequency value obtained by adding the frequency of the local signal for the coarse frequency conversion step to the center frequency of the RF signal is in the frequency band of the RF signal.

Here, the upconverter 63 has a structure for frequency-converting a complex baseband signal to a complex RF signal according to the local signal for the fine frequency conversion step output from the local oscillator (Localh) 705 for the fine frequency conversion step. When the resolution of the local oscillator (Localh) 705 is low, a different value between the frequency of the local signal for an associated fine frequency conversion step and the frequency of the RF signal is present. To compensate for the difference, the upconverter 63 corresponding to the upconverter of the quasi-zero-IF scheme is provided with the local oscillator (Locali) 734 corresponding to the first local oscillator, and performs the fine frequency conversion process in which the offset frequency is the center frequency according to the local signal for the coarse frequency conversion step to first generate a quasi-baseband signal. The frequency conversion to a signal with a target RF signal frequency is enabled according to the local signal for the fine frequency conversion process.

The upconverter 63 corresponding to the basic structure of the upconverter based on the quasi-zero-IF scheme illustrated in FIG. 49 is similar to that of FIG. 46. However, the structure and operation of the upconverter 63 are different from the upconverter 60 corresponding to an example of the basic structure of the upconverter based on the zero-IF scheme. Next, the upconverter 63 corresponding to the basic structure of the upconverter based on the quasi-zero-IF scheme will be described.

The upconverter 63 is different from the upconverter 60 corresponding to an example of a basic structure of the upconverter based on the zero-IF scheme in that LPFs 731 and 732, the local oscillator (Locali) 734 for outputting a signal of the frequency separated by the offset frequency from the frequency of the RF signal, and a full-complex mixer 735 are inserted between input terminals TII and TIQ and input terminals of the DACs 701 and 702. The LPFs 703 and 704 are replaced with LPFs 725 and 726 that cannot be substituted with BPFs.

The upconverter 63 is different from the upconverter 60 in that functions of the complex-coefficient filter 707 and the subtractor 708 are integrated and the complex-coefficient filter 707 and subtractor 708 are replaced with a complex-coefficient filter 709 for receiving a complex signal and outputting a real signal. The complex-coefficient filter 709 is different from the complex-coefficient filter 707 of the upconverter 61 based on the zero-IF scheme in that the filter 709 uses a function of the external subtractor 708 and performs a signal subtraction process inside the filter.

The LPFs 731 and 732 remove a high frequency component of a digital signal and performs a waveform shaping process. The full-complex mixer 735 performs frequency conversion to a signal in which the offset frequency is the center frequency.

The local oscillator (Locali) 734 has the offset frequency and sets the frequency to D2. Hereinafter, the complex local signal output from the local oscillator (Locali) 734 is referred to as the complex local signal of the frequency D2.

When the local oscillator (Locali) 734 has the offset frequency, the frequency D1 of the local oscillator (Localh) 705 corresponds to a frequency of a difference between the frequency of the RF signal and the offset frequency.

The full-complex mixer 735 has the same structure as the above-described full-complex mixer 117, and frequency-converts a complex signal S61A corresponding to a baseband signal to the offset frequency based on the complex signals S61B corresponding to the IF signal. The full-complex mixer 735 receives a real part of the complex local signal of the frequency D2 from the local oscillator (Locali) 734 through an input terminal IcmC and receives an imaginary part of the complex local signal of the frequency D2 from the local oscillator (Locali) 734 through an input terminal IcmS. The full-complex mixer 735 frequency-converts the complex signal S61A input from input terminals IcmI and IcmQ to the offset frequency corresponding to a frequency of an output signal of the local oscillator (Locali) 734, and outputs the complex signal S61B from output terminals OcmI and OcmQ.

Next, the operation of the upconverter 63 of the quasi-zero-IF scheme will be described. The LPFs 731 and 732 remove a high frequency component from digital signals input through the input terminals TII and TIQ, perform a waveform shaping process, and output the complex signal S61A corresponding to a complex baseband signal.

The full-complex mixer 735 frequency-converts the complex signal S61A by performing a frequency conversion process in which the offset frequency is the center frequency of the complex signal S61A according to the complex local signal of the frequency D2 output from the local oscillator (Locali) 734. The full-complex mixer 735 outputs a real part S61BI and an imaginary part S61BQ of the complex signal S61B corresponding to the complex IF signal to the DACs 701 and 702.

The DAC 701 converts the real part S61BI of the complex signal S61B output from the full-complex mixer 735 to a real part S61CI corresponding to an analog signal, and the DAC 702 converts the imaginary part S61BQ of the complex signal S61B to an imaginary part S61CQ corresponding to an analog signal, such that a complex signal S61C corresponding to an analog complex IF signal is generated. The LPF 725 removes a high frequency component from a real part S61CI of the complex signal S61C, performs a waveform shaping process, and outputs a real part S61DI of a complex signal S61D. The LPF 726 removes a high frequency component from an imaginary part S61CQ of the complex signal S61C, performs a waveform shaping process, and outputs an imaginary part S61DQ of the complex signal S61D.

The full-complex mixer 706 frequency-converts the complex signal S61D on the basis of a complex local signal with the frequency D1, separated by the offset frequency from the RF signal frequency, output from the local oscillator (Localh) 705, and outputs a complex signal S61E corresponding to a complex RF signal with an RF signal frequency to the complex-coefficient filter 709. The complex-coefficient filter 709 outputs a real RF signal with a phase difference of 90 degrees to an output terminal TORF while suppressing the negative frequency of a complex signal S61E.

For example, the complex-coefficient filters 707 and 709 used in the upconverters 60 and 63 of the zero-IF scheme and the quasi-zero-IF scheme can use a polyphase filter or a complex-coefficient transversal filter. When the complex-coefficient transversal filters are adopted, impulse responses illustrated in FIGS. 42 and 43 are provided. Specifically, a complex-coefficient filter with frequency characteristics illustrated in FIG. 41 can be applied.

As illustrated in FIG. 49, the upconverter 63 of the quasi-zero-IF scheme uses a digital signal process in the full-complex mixer 735 corresponding to the first-step mixer and an analog signal process after D/A conversion in the full-complex mixer 706 corresponding to the second-step mixer. The upconverter 63 is provided in a digital receiver or a transmitter using software radio technology.

The complex-coefficient filters 707 and 709 of the upconverters 60 and 63 for suppressing a negative frequency band have been described. Alternatively, the complex-coefficient filters may have a structure for suppressing a positive frequency band and performing a process on the basis of an extracted negative frequency component.

If flat group delay characteristics are required for the complex-coefficient transversal filter, an impulse response used for the complex-coefficient transversal filter must be exactly an even or odd symmetric impulse response. However, if flat group delay characteristics are not required, an asymmetric impulse response can also be accepted.

A downconverter of the present invention is configured by a complex-coefficient transversal filter for generating a real part of a complex RF signal by performing a convolution integral according to an impulse response of the real part for an input RF signal, generating an imaginary part of the complex RF signal by performing a convolution integral according to an impulse response of the imaginary part for the input RF signal, rejecting one side of a positive or negative frequency, and outputting the complex RF signal, and a complex mixer for mixing the complex RF signal and a complex local signal while rejecting one side of a positive or negative frequency. Therefore, image interference to the RF signal can be suppressed in an image rejection ratio corresponding to a sum of an image rejection ratio based on the complex-coefficient transversal filter and an image rejection ratio based on the complex mixer, such that the image rejection ratio can be improved. The downconverter of the low-IF scheme can obtain a sufficient image rejection ratio, and the downconverters of the zero-IF scheme and the quasi-zero-IF scheme can improve EVM.

Because the complex-coefficient transversal filter is used, a phase difference of 90 degrees can be easily obtained between the real and imaginary parts. Moreover, because the complex-coefficient transversal filter can have a function of a low-band filter, the downconverter can be miniaturized. When a frequency converter is inserted before the complex-coefficient transversal filter in the downconverter of the low-IF scheme, a dual-conversion downconverter can be configured to perform two frequency conversion processes for the RF signal and a desired frequency conversion resolution and a desired image rejection ratio can be ensured.

Because an image rejection ratio does not need to be obtained using a mixer, the degradation of the image rejection ratio due to the variation of a transistor can be allowed. For this reason, the size of the transistor of the mixer can be small. The number of used transistors increases, but a total of power consumption can be reduced due to the reduction of power consumption of an individual transistor. The degradation of transition frequency, fT, can be prevented, and performance can be improved.

An upconverter of the present invention is configured by a complex mixer for mixing a complex signal and a complex local signal and outputting an RF signal to a complex-coefficient transversal filter while rejecting one side of a positive or negative frequency, and the complex-coefficient transversal filter for performing a convolution integral according to an impulse response of the real part for a complex RF signal output from the complex mixer, performing a convolution integral according to an impulse response of the imaginary part for the complex RF signal, rejecting one side of a positive or negative frequency, and outputting a real RF signal. Therefore, image interference to the RF signal can be suppressed in an image rejection ratio corresponding to a sum of an image rejection ratio based on the complex-coefficient transversal filter and an image rejection ratio based on the complex mixer, such that the image rejection ratio can be improved. Because the complex-coefficient transversal filter is used, a phase difference of 90 degrees can be easily obtained between the real and imaginary parts. Moreover, because the complex-coefficient transversal filter can have a function of a low-band filter, the upconverter can be miniaturized.

V. First Embodiment of Downconverter of Low-IF Scheme

Next, a first embodiment of a downconverter of a low-IF scheme in accordance with the present invention will be described with reference to the accompanying drawings.

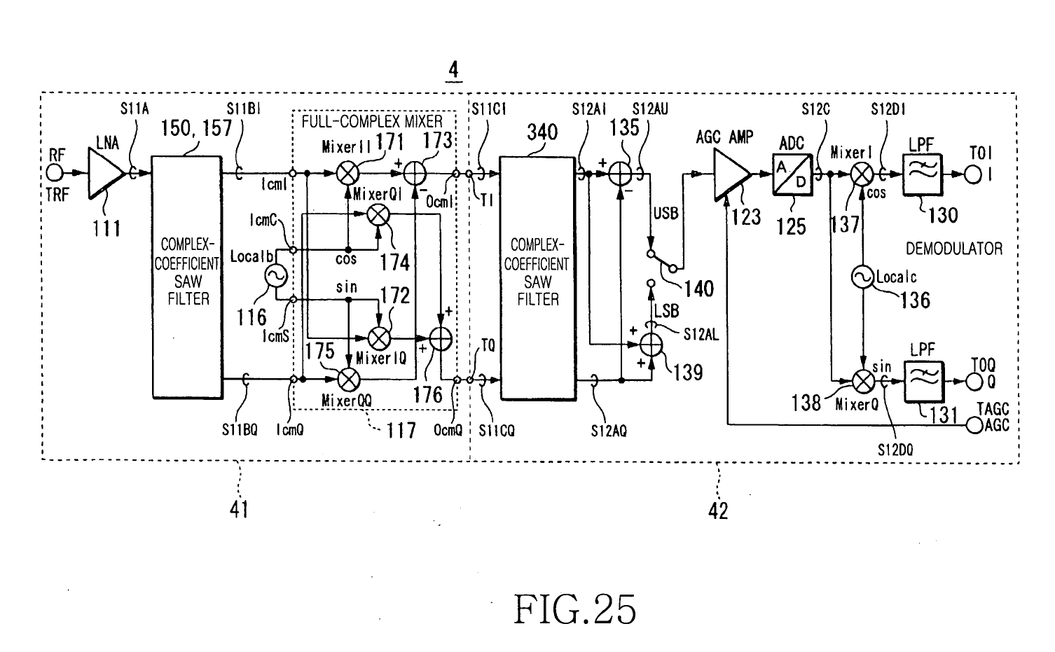

FIG. 25 is a block diagram illustrating a structure of a downconverter 4 of the low-IF scheme in accordance with an embodiment of the present invention. The downconverter 4 is similar to that of FIG. 19. However, the structures and operations of an IF generator 41 and a baseband generator 42 are different from those of the IF generator 31 and the baseband generator 32 in the downconverter 3 corresponding to the example of the third basic structure.

Next, the downconverter 4 in accordance with this embodiment will be described with reference to the accompanying drawings.

The IF generator 41 is different from the IF generator 31 corresponding to the example of the third basic structure, in that the IF generator 41 uses a complex-coefficient SAW filter 150 or 157 as one means for implementing the complex-coefficient transversal filter 115.

The baseband generator 42 is different from the baseband generator 32 corresponding to the example of the third basic structure in that the baseband generator 42 uses a complex-coefficient SAW filter 340 as one means for implementing the complex-coefficient filter 134 and additionally uses an adder 139 and a switch 140.

The operations of the IF generator 41 and the baseband generator 42 in this embodiment will be described with reference to FIG. 25.

Because the operations of the IF generator 41 and the baseband generator 42 are similar to those of the IF generator 31 and the baseband generator 32 corresponding to the example of the third basic structure, only differences will be described.

In the IF generator 41, a real signal S11A output from an LNA 111 is input to the complex-coefficient SAW filter 150 or 157, and a complex signal S11B is output from the complex-coefficient SAW filter 150 or 157. A full-complex mixer 117 receives the complex signal S11B, frequency-converts the complex signal S11B according to an output signal of a local oscillator (Localb) 116 at a frequency that is a frequency of an IF signal lower than the frequency of the complex signal S11B, and performs frequency conversion to a complex signal S11C corresponding to the frequency of the IF signal that is lower than the complex signal S11B. On the other hand, a pass bandwidth of the complex-coefficient SAW filter 150 or 157 covers a radio system bandwidth.

In the baseband generator 42, the complex-coefficient SAW filter 340 band-limits an input signal, performs a process for suppressing only a positive or negative frequency signal, outputs a real part S12AI of a complex signal S12A to a positive input terminal of a subtractor 135 and one input terminal of an adder 139, and outputs an imaginary part S12AQ of the complex signal S12A to a negative input terminal of the subtractor 135 and the other input terminal of the adder 139. The pass bandwidth of the complex-coefficient SAW filter 340 covers a channel bandwidth as in the complex-coefficient SAW filter 150 or 157.

The subtractor 135 subtracts the imaginary part S12AQ from the real part S12AI, and outputs a real signal S12AU to an input terminal USB of the switch 140. The adder 139 adds the real part S12AI and the imaginary part S12AQ, and outputs a real signal S12AL to an input terminal LSB of the switch 140.

In this case, the subtractor 135 outputs the real signal S12AU of an Upper Side Band (USB) corresponding to a positive frequency according to a process for subtracting the imaginary part S12AQ from the real part S12AI. The adder 139 outputs the real signal S12AL of a Lower Side Band (LSB) corresponding to a negative frequency according to a process for adding the real part S12AI and the imaginary part S12AQ.

According to a process for passing only a positive or negative frequency signal from the complex-coefficient SAW filter 340, the switch 140 switches a signal to be output to the AGC amplifier 123. That is, when the complex-coefficient SAW filter 340 is designed to pass only the positive frequency signal, its output terminal is connected to the input terminal USB of the switch 140, such that the real signal S12AU is supplied to the AGC amplifier 123. When the complex-coefficient SAW filter 340 is designed to pass only the negative frequency signal, its output terminal is connected to the input terminal LSB of the switch 140, such that the real signal S12AL is supplied to the AGC amplifier 123.

When the output terminal of the switch 140 is connected to the input terminal USB, the adder 139 is powered off to reduce power consumption. When the output terminal of the switch 140 is connected to the input terminal LSB, the subtractor 135 is powered off to reduce power consumption.

As compared with the downconverter 3 corresponding to the example of the third basic structure, the downconverter 4 of the first embodiment has the following merits.

When the IF generator 41 uses the complex-coefficient SAW filter 150 or 157 as one means for implementing the complex-coefficient transversal filter 115 within the IF generator 11, the filter characteristics can be designed on the basis of a comb shaped structure of the SAW filter. When conventional fine process technology is used, the performance of the overall device can be improved. When the complex-coefficient filter 134 of the baseband generator 32 is replaced with the complex-coefficient SAW filter 340 of the baseband generator 42, the filter can be manufactured in high precision and the performance of the overall device can be improved. Because the complex-coefficient SAW filters 150, 157, and 340 are passive devices, power is not consumed and the total power consumption of the device can be reduced. There can be obtained the effect of the filter for suppressing a positive or negative frequency and suppressing an out-of-band component at a frequency side of a target signal.

As compared with the downconverter 3 corresponding to the example of the third basic structure for processing only a USB signal, the downconverter 4 is additionally provided with the adder 139 and the switch 140 for a switching operation of a device for selectively supplying power to one of the switch 140, the subtractor 135, and the adder 139, thereby selectively processing the real signal S12AU of USB and the real signal S12AL of LSB.

W. Second Embodiment of Downconverter Based on Low-IF Scheme

Next, a second embodiment of the downconverter based on the low-IF scheme in accordance with the present invention will be described with reference to the accompanying drawings.

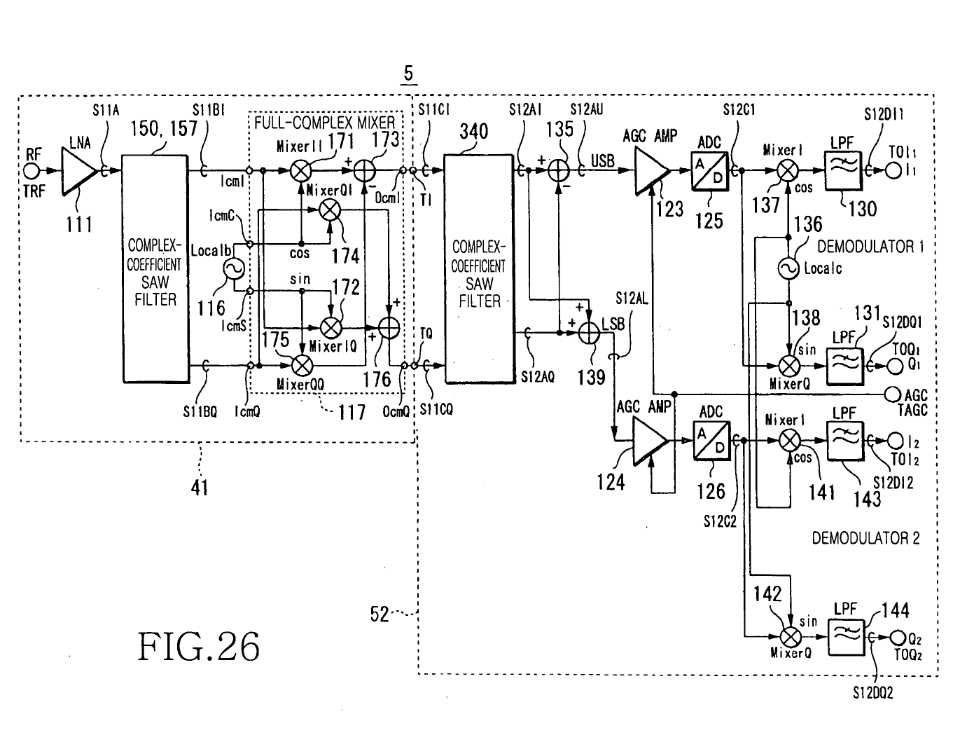

FIG. 26 is a block diagram illustrating a structure of a downconverter 5 based on the low-IF scheme in accordance with an embodiment of the present invention. The downconverter 5 is similar to that of FIG. 25. However, the structure and operation of a baseband generator 52 are different from those of the baseband generator 42 of the downconverter 4 based on the first embodiment of the present invention. Next, the downconverter 5 in accordance with this embodiment will be described with reference to the accompanying drawings.

The baseband generator 52 is different from the baseband generator 42 of the first embodiment in that the switch 140 is deleted and an AGC amplifier 124, an ADC 126, a mixer-I 141, a mixer-Q 142, and LPFs 143 and 144 are added.

Next, the operation of the baseband generator 52 of the downconverter 5 in accordance with this embodiment will be described with reference to FIG. 26. Because the operation of the baseband generator 52 is similar to that of the baseband generator 42 of the first embodiment, only differences will be described.

A real S12AU of USB from a subtractor 135 is output to a signal input terminal of an AGC amplifier 123. An ADC 125 outputs a real signal S12CI to a mixer-I 137 and a mixer-Q 138. The mixer-I 137 and the mixer-Q 138 output a real part S12DI1 and an imaginary part S12DQ1 of a complex signal S12D1 to the LPFs 130 and 131. The LPFs 130 and 131 output a complex baseband signal I1 and Q1.

A real signal S12AL of USB from an adder 139 is output to a signal input terminal of the AGC amplifier 124. The AGC amplifier 124 adjusts the amplitude of the real signal S12AL to the amplitude suitable for an input to the ADC 126, and outputs an adjustment result to the ADC 126. The ADC 126 performs an A/D conversion operation on an input signal and outputs a real signal S12C2 to the mixer-I 141 and the mixer-Q 142.

The mixer-I 141 multiplies the real signal S12C2 input from the ADC 126 and a real part of a complex local signal of a frequency A2 input from a local oscillator (Localc) 136, and outputs a real part S12DI2 of a complex signal S12D2 corresponding to a frequency signal of a frequency difference between both the signals to an input terminal of the LPF 143. The mixer-Q 142 multiplies the real signal S12C2 input from the ADC 126 and an imaginary part of the complex local signal of the frequency A2 input from the local oscillator (Localc) 136, and outputs an imaginary part S12DQ2 of the complex signal S12D2 corresponding to a frequency signal of a frequency difference between both the signals to an input terminal of the LPF 144. The LPFs 143 and 144 band-limit the real part S12DI2 and the imaginary part S12DQ2 of the complex signal S12D2, and output a complex baseband signal I2 and Q2.

As compared with the baseband generator 42 of the first embodiment for selectively processing the real signal S12AU of USB and the real signal S12AL of LSB through the switch 140, the baseband generator 52 of the second embodiment can simultaneously process the real signal S12AU and the real signal S12AL.

In this embodiment, it is assumed that an absolute value of the frequency of the real signal S12AU of USB is the same as that of the frequency of the real signal S12AL of LSB. A local oscillator for frequency conversion in the mixer-I 137 and the mixer-Q 138 and a local oscillator for frequency conversion in the mixer-I 143 and the mixer-Q 144 commonly use the local oscillator (Localc) 136.

X. Third Embodiment of Downconverter Based on Low-IF Scheme

Next, a third embodiment of the downconverter based on the low-IF scheme will be described with reference to the accompanying drawings.

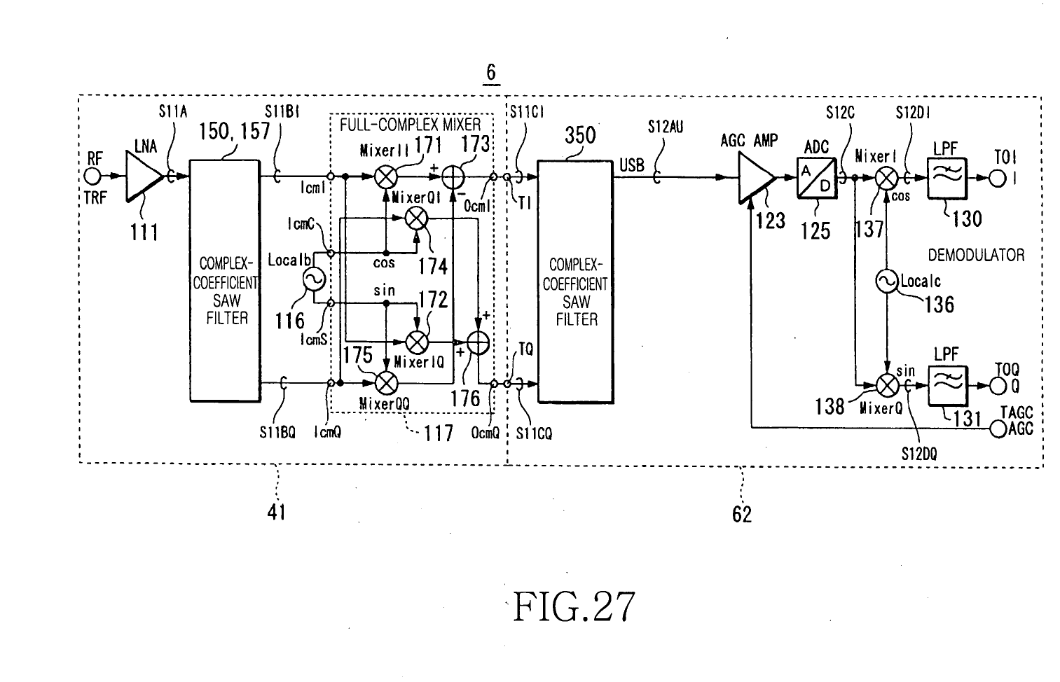

FIG. 27 is a block diagram illustrating a structure of a downconverter 6 based on the low-IF scheme in this embodiment. The downconverter 6 is similar to that of FIG. 25. However, the structure and operation of a baseband generator 62 are different from those of the baseband generator 42 of the downconverter 4 based on the first embodiment of the present invention.

Next, the downconverter 6 in accordance with this embodiment will be described with reference to the accompanying drawings. The baseband generator 62 is different from the baseband generator 42 of the first embodiment in that the complex-coefficient SAW filter 340 is replaced with a complex-coefficient SAW filter 350 and the adder 139 and the switch 140 are deleted.

An output terminal of the complex-coefficient SAW filter 350 is connected to a signal input terminal of an AGC amplifier 123. As described below, the complex-coefficient SAW filter 350 converts an input complex signal to a real signal and outputs a real signal S12AU to the AGC amplifier 123.

As illustrated in FIG. 28, the complex-coefficient SAW filter 350 is provided with an IDT 343 (of a first comb shaped electrode) and an IDT 345 (of a second comb shaped electrode) serving as input IDTs, and an IDT 346 (of a third comb shaped electrode) serving as an output IDT are placed on a piezoelectric substrate 151. In the complex-coefficient SAW filter 350 as compared with the complex-coefficient SAW filter 340 of the first and second embodiments, a weighting process mapped to an impulse response of a real part is made for an electrode finger of the IDT 343 serving as one side of the input IDTs. A weighting process mapped to an impulse response of an imaginary part is made for an electrode finger of the IDT 345 serving as the other side of the input IDTs. The complex-coefficient SAW filter 350 is different from the complex-coefficient SAW filter 340 in that the IDT 346 for one output is set opposite to the input IDTs 343 and 345 at a predetermined interval in a horizontal direction of the paper surface. The IDT 346 is placed across propagation paths of two SAWs formed between the input IDTs 343 and 345 opposite thereto.

The electrode finger of each IDT is connected to an input or output terminal, or is grounded. Electrode fingers of the IDTs 343 and 345 close to each other are grounded to the piezoelectric substrate 151, an ungrounded electrode finger of the IDT 343 is connected to the input terminal I, and an ungrounded electrode finger of the IDT 345 is connected to the input terminal Q. Electrode fingers of the IDT 346 at one side are grounded to the piezoelectric substrate 151 and electrode fingers of the IDT 346 at the other side are connected to the output terminal.

Because the electrode fingers are connected as described above, polarities of two SAWs excited from the IDTs 343 and 345 on the piezoelectric substrate 151 are opposite. Because these SAWs are converted to an electric signal in the same IDT 346, a process for subtracting a signal input from the IDT 345 from a signal input from the IDT 343 is performed in the IDT 346. Accordingly, the above-described structure is configured in the complex-coefficient SAW filter 350, such that a process for subtracting a signal of the input terminal Q from a signal of the input terminal I in the subtractor 135 in the first embodiment can be performed inside the complex-coefficient SAW filter 350.

The baseband generator 62 of this embodiment is different from the baseband generator 42 of the first embodiment in that the baseband generator 62 processes only a real USB signal S12AU. Because the complex-coefficient SAW filter 350 selects only the USB, the LSB is not processed. The baseband generator 62 of this embodiment is different from that of the first embodiment in that the adder 139 and the switch 140 are deleted and the baseband generator does not process the LSB. Because the complex-coefficient SAW filter 350 of the baseband generator 62 can perform the same function as that of the complex-coefficient SAW filter 340 and the subtractor 135, the subtractor 135 can be deleted and a device structure can be simplified.

When the IF signal frequency is high, desired characteristics may not be generated due to lead inductance of a wire rod, etc., for connecting the complex-coefficient SAW filter 340 and the subtractor 135. In this case, the complex-coefficient SAW filter 350 is preferably provided which can form a significantly short signal path on the piezoelectric substrate 151.

In this embodiment, it is assumed that the baseband generator 62 processes only the real signal S12AU of the USB. Assuming that the frequency of the local oscillator (Localc) 136 is higher than the frequency of the IF signal and only the real signal S12AL of the LSB is processed, the signal process is performed by adding the real signal S12AI and the imaginary part S12AQ of the complex signal S12A. The following change is made in the complex-coefficient SAW filter 350.

That is, the electrode finger grounded to the piezoelectric substrate 151 and the electrode finger connected to the input terminal Q are changed to each other in the electrode fingers of the IDT 345 within the complex-coefficient SAW filter 350 illustrated in FIG. 28.

According to the above-described change, the polarities of two SAWs excited from the IDTs 343 and 345 on the piezoelectric substrate 151 are the same as each other. Because these SAWs are converted to an electric signal in the same IDT 346, a signal input from the IDT 343 and a signal input from the IDT 345 are added by the IDT 346. Therefore, the complex-coefficient SAW filter 350 can be configured such that a process for adding a signal of the input terminal I and a signal of the input terminal Q in the adder 139 of the first embodiment can be performed inside the complex-coefficient SAW filter 350.

As compared with the baseband generator in which the adder 135 and the switch 140 of the first embodiment are deleted and the real signal S12AU of the USB is not processed, the baseband generator 62 of the third embodiment has the complex-coefficient SAW filter 350 that can perform the same signal process function as that of the complex-coefficient SAW filter 340 and the adder 139. Because the adder 139 is deleted, a device structure can be simplified and miniaturized.

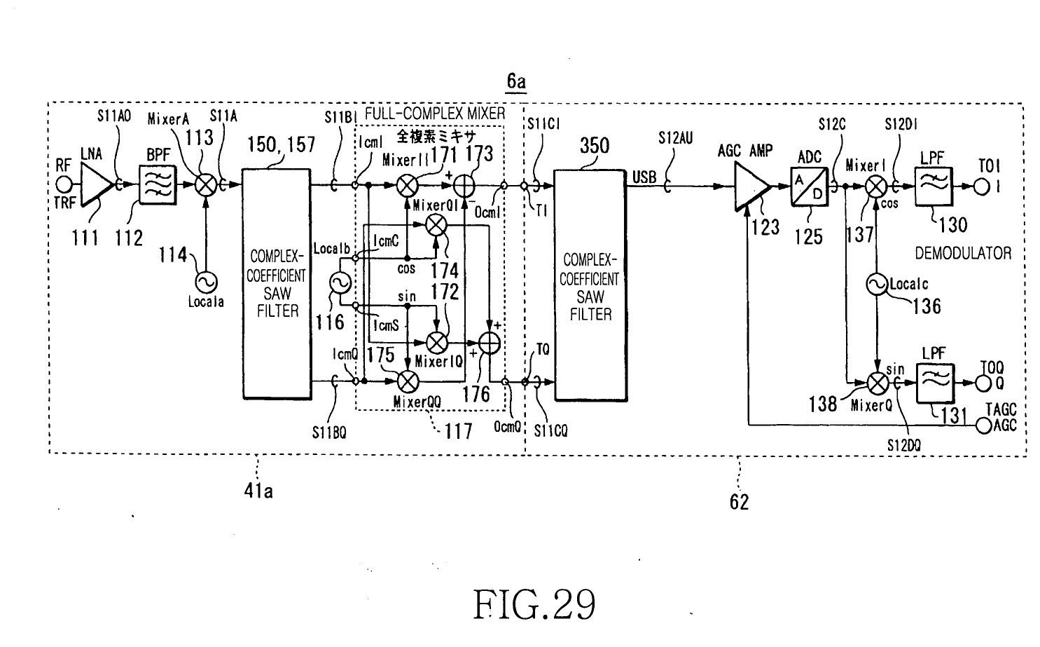

In an example of the third embodiment of the present invention as illustrated in FIG. 29 like the example of the first and third basic structures of the present invention, the dual-conversion downconverter 6a includes an IF generator 41a. In the IF generator 41a, a frequency converter is inserted between the LNA 111 and the complex-coefficient SAW filter 150 or 157 of the IF generator 41 of the single-conversion downconverter 6. The downconverter 6a can have the same characteristics when the first IF signal and the second IF signal are replaced with an RF signal and an IF signal of the downconverter 6.

Y. Fourth Embodiment of Downconverter of Low-IF Scheme

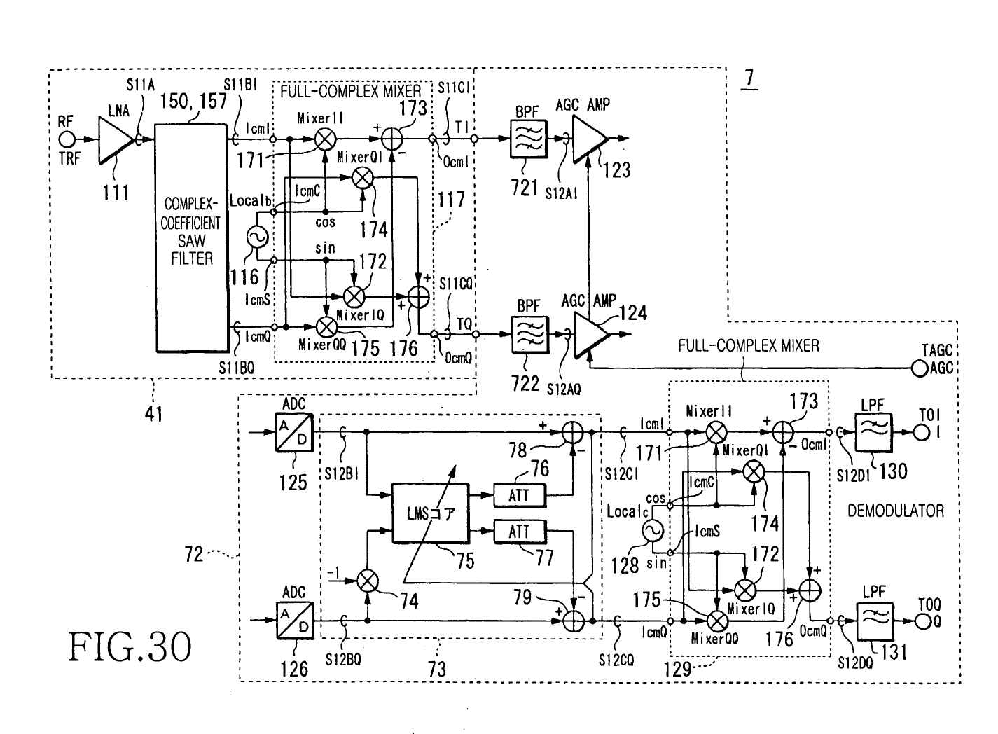

Next, a fourth embodiment of a downconverter of a low-IF scheme in accordance with the present invention will be described with reference to the accompanying drawings. FIG. 30 is a block diagram illustrating a downconverter 7 of the low-IF scheme in this embodiment. The downconverter 7 is similar to that of FIG. 1. However, the structures and operations of an IF generator 41 and a baseband generator 72 are different from those of the IF generator 11 and the baseband generator 12 of the downconverter 1 corresponding to the example of the first basic structure. Next, the downconverter 7 of this embodiment will be described.

The IF generator 41 is different from the IF generator 11 corresponding to the example of the first basic structure in that the IF generator 41 uses a complex-coefficient SAW filter 150 or 157 as one means for implementing the complex-coefficient transversal filter 115 as in the first to third embodiments of the present invention.

The baseband generator 72 is different from the baseband generator 12 corresponding to the example of the first basic structure in that the BPFs 121 and 122 are replaced with BPFs 721 and 722 and the imbalance corrector 127 is replaced with an image frequency interference canceller 73.

The image interference canceller 73 is configured by a multiplier 74 (serving as a conjugate signal generation means), a Least Mean Square (LMS) core 75 (serving as a signal level adjustment means), attenuators (ATTs) 76 and 77 (serving as signal level adjustment means), and subtractors 78 and 79. The image interference canceller 73 operates as an adaptive filter based on an LMS algorithm.

Next, the operation of the baseband generator 72 of the downconverter 7 in this embodiment will be described with reference to FIG. 30.

Because the operation of the baseband generator 72 is similar to that of the baseband generator 12 in the example of the first basic structure, only differences between them will be described.

The BPF 721 band-limits a real part S11CI of a complex signal S11C input from an input terminal TI, and outputs a real part S12AI of a complex signal S12A to an AGC amplifier 123. The BPF 722 band-limits an imaginary part S11CQ of the complex signal S11C input from an input terminal TQ and outputs an imaginary part S12AQ of the complex signal S12A to an AGC amplifier 124.

In the image frequency interference canceller 73, the multiplier 74 inverts a sign by multiplying an imaginary part S12BQ of a complex signal S12B by “−1”, and outputs the inverted signal to the LMS core 75. The LMS core 75 receives a real part S12BI of the complex signal S12B from the ADC 125, receives a signal obtained by inverting the polarity of the imaginary part S12BQ of the complex signal S12B from the multiplier 74, and generates a complex signal S12C corresponding to a complex conjugate signal of the complex S12B. The LMS core 75 is a core of the adaptive filter, sets an output signal of the subtractors 78 and 79 to an error signal, sets the generated complex conjugate signal to a reference signal, and controls a filter coefficient on the basis of the LMS algorithm.

The ATT 76 adjusts the amplitude of a signal output from an output terminal of a real part of the LMS core 75 (corresponding to a real part of an image frequency interference cancel signal) and outputs an adjustment result to the subtractor 78. The ATT 77 adjusts the amplitude of a signal output from an output terminal of an imaginary part of the LMS core 75 (corresponding to an imaginary part of an image frequency interference cancel signal) and outputs an adjustment result to the subtractor 79.

The subtractor 78 subtracts the image frequency interference cancel signal of the amplitude adjusted by the ATT 76 from the real part S12BI of the complex signal S12B output from the ADC 125, and outputs a real part S12CI of the complex signal S12C to the full-complex mixer 129 and the LMS core 75.

The subtractor 79 subtracts the image frequency interference cancel signal of the amplitude adjusted by the ATT 77 from the imaginary part S12BQ of the complex signal S12B output from the ADC 126, and outputs an imaginary part S12CQ of the complex signal S12C to the full-complex mixer 129 and the LMS core 75.

Next, the operation of the image interference canceller 73 will be described. The adaptive filter of the image interference canceller 73 sets the complex conjugate signal generated by the multiplier 74 from an original signal of the image frequency signal to the reference signal. The adaptive filter operates such that an error between the reference signal and the image frequency signal included in the input complex signal S12B is minimized. Because the image frequency signal is completely rejected when an error is absent, characteristics for excluding the image frequency interference can be improved up to an adaptive precision limit of the adaptive filter.

The adaptive filter of the image interference canceller 73 may obtain an adaptive filter coefficient by inputting a calibration signal at the time of an adaptive process. When an image frequency signal slowly varies on a time axis because characteristic variation of an analog part does not occur in a relatively short time, an adaptive process always does not need to operate but is performed only in a predetermined time. The remaining time is used to operate an equalizer as an adaptive filter based on the obtained coefficient. This operation is repeated such that a desired object is achieved.

The ATTs 76 and 77 for the real and imaginary parts, capable of adjusting an output level of the LMS core 75, are inserted to operate a filter coefficient word length of the LMS core 75 in a minimum coefficient word length. When the ATTs 76 and 77 cannot be used because a signal level of the image frequency signal is significantly lower than that of a complex conjugate signal serving as a reference signal input to the adaptive filter, a coefficient value varies in the LMS core 75, such that an image frequency interference cancel signal serving as an output can be changed to the same level as that of the image frequency signal. If a coefficient value of the LMS core 75 is set to be small, it means that a filter coefficient word length is short.

As compared with the baseband generator 12 in the example of the first basic structure, the baseband generator 72 of the fourth embodiment has the following merits. That is, the AGC amplifiers 123 and 124 depend upon a variable gain and frequency. When the amplitudes of the real part S12CI and the imaginary part S12CQ of the complex signal S12C are different from each other and an amplitude difference (or imbalance) between both signals occurs, image frequency interference re-occurs. As compared with the imbalance corrector 127 for performing a process for correcting an amplitude difference between the real part S12CI and the imaginary part S12CQ of the complex signal S12C on the basis of a fixed value, the image interference signal canceller 73 of this embodiment can avoid the re-occurrence of image frequency interference according to frequencies, regardless of gains of the AGC amplifiers 123 and 124. According to the above-described process, for example, a high image rejection ratio of more than 80˜100 dB can be obtained.

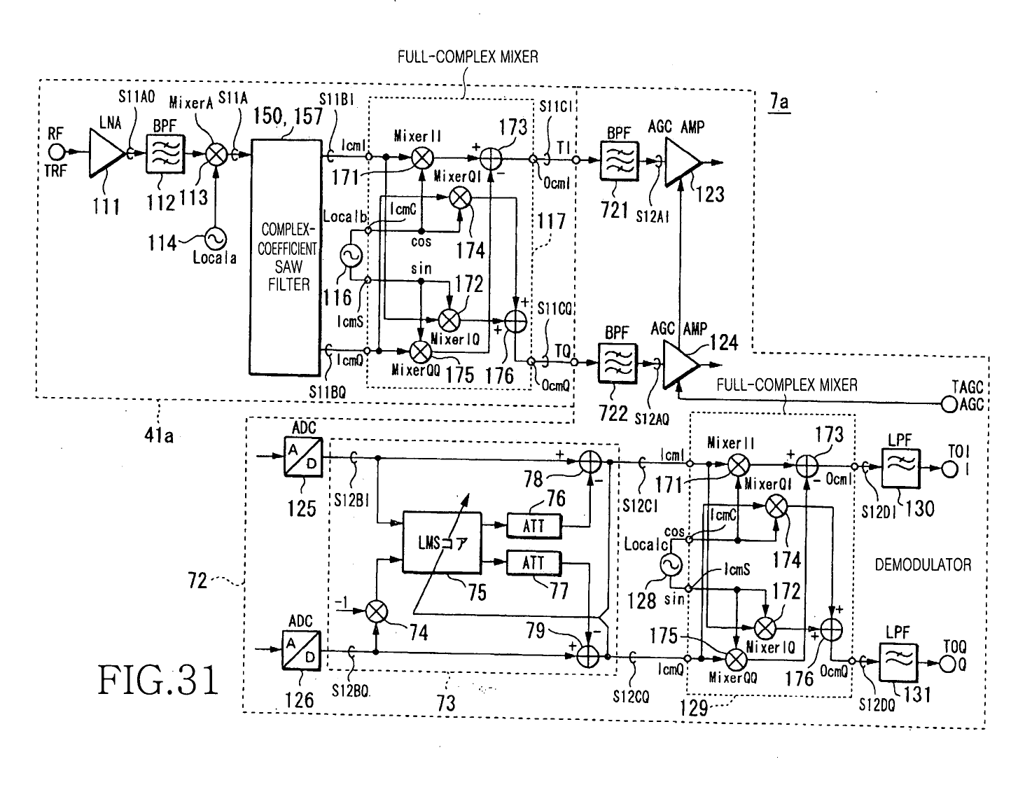

In an example of the fourth embodiment of the present invention as illustrated in FIG. 31 like the example of the first and third basic structures and the third embodiment of the present invention, the dual-conversion downconverter 7a includes an IF generator 41a. In the IF generator 41a, a frequency converter is inserted between the LNA 111 and the complex-coefficient SAW filter 150 or 157 of the IF generator 41 of the single-conversion downconverter 7. The downconverter 7a can have the same characteristics when the first IF signal and the second IF signal are replaced with an RF signal and an IF signal of the downconverter 7.

As described above, the first and second basic structures and the second and fourth embodiments of the present invention can simultaneously process positive and negative frequencies, and can select the positive and negative frequencies or select the simultaneous processing in a digital part after performing conversion to digital signals in the ADCs 125 and 126.

Merits of the downconverters 4˜7 of the first to fourth embodiments will be described. The downconverters 4˜6 in the above-described first to third embodiments are suitable for the purpose of requiring low power consumption. Because the SAW filter 340 or 350 performs a channel band-limiting operation, the dynamic range and the number of bits required for the ADCs 125 and 126 are small, an operation in which the frequency of the IF signal increases to a minimum of 40 MHz is reduced, and power consumption is reduced. Because the frequency of the IF signal can be decreased when the complex-coefficient SAW filter 340 or 350 of the baseband generators 42, 52, and 62 is replaced with a polyphase filter, filter characteristics are degraded due to the reduction of a sampling frequency of the ADCs 125 and 126 and the reduction of an input bandwidth as compared with those of the complex-coefficient SAW filter 340 or 350. In this case, a dynamic range increases, such that an increase in power consumption can be reduced or low power consumption can be provided.

The downconverter 7 of the fourth embodiment is suitable for the purpose of requiring a high image rejection ratio in a narrow radio scheme.

When a frequency of the second IF signal is changed in the downconverters 1a, 2a, 3a, 6a, and 7a, an image frequency is changed. In this case, power consumption may be reduced and an image rejection ratio may be ensured without correcting image rejection. Because interference does not occur even though an image rejection ratio is insufficient when a signal is absent at an image frequency, an identical image rejection ratio can be ensured. At the time, a digital signal process does not require high power consumption.

The dual-conversion downconverters 1a, 2a, 3a, 6a, and 7a set the frequency of the first IF signal higher than the frequency of the RF signal. When the frequency of the RF signal is not continuous and, for example, the RF signal covers discontinuous frequency bands of 800˜900 MHz and 1900˜2000 MHz, a frequency band of 900˜1900 MHz may be set to the frequency of the first IF signal. In this case, the following problems can be avoided. That is, a problem can be avoided in which an RF signal passes through when the frequency of the first IF signal is in an RF signal band. Moreover, a problem can be avoided in which power consumption increases and an IF filter with good characteristics cannot be manufactured when the first IF is set to be high without reason. It is preferred that the frequency of the first IF signal is set in a frequency band unused by an RF signal when a frequency band of the RF signal is discontinuous.

Z. First Embodiment of Upconverter of Low-IF Scheme

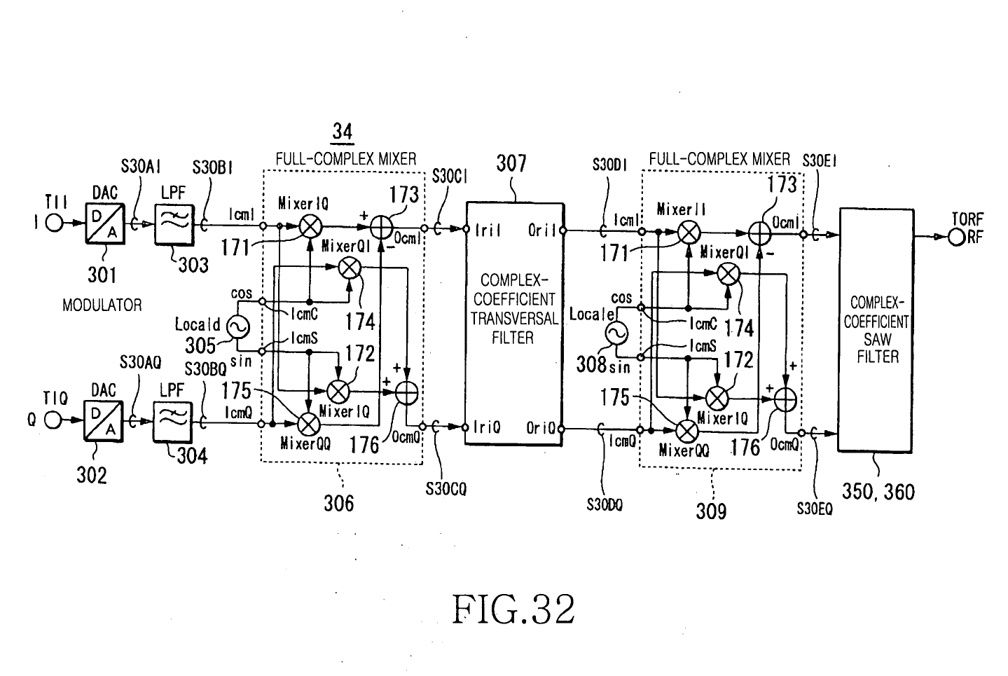

Next, a first embodiment of an upconverter of a low-IF scheme in accordance with the present invention will be described with reference to the accompanying drawings. FIG. 32 is a block diagram illustrating an upconverter 34 of the low-IF scheme in this embodiment. The upconverter 34 is similar to that of FIG. 21. However, the upconverter 34 is different from the upconverter 31 in that the upconverter 34 adopts the complex-coefficient SAW filter 350 or 360 as one means for implementing the complex-coefficient transversal filter 310. Next, the upconverter 34 of this embodiment will be described with reference to the accompanying drawings. The operation of the upconverter 34 in this embodiment is similar to that of the upconverter 31 in the example of the basic structure. The upconverter 34 is different from the upconverter 31 in that the upconverter 34 uses the complex-coefficient SAW filter 350 or 360 as one means for implementing the complex-coefficient transversal filter 310 to process a complex signal S30E corresponding to an output signal of the full-complex mixer 309.

As compared with the upconverter 31 in the example of the basic structure, the upconverter 34 in the first embodiment has the following merits.

That is, a filter with high accuracy can be manufactured and the performance of the overall device can be improved when the complex-coefficient transversal filter 310 is replaced with the complex-coefficient SAW filter 350 or 360. The complex-coefficient SAW filter 350 or 360 is slightly larger than a conventional SAW filter, but is very smaller than the conventional BPF, such that the overall device can be miniaturized. Moreover, the complex-coefficient SAW filter 350 or 360 is a passive device, such that power is not consumed and power for the overall device can be saved.

AA. Second Embodiment of Upconverter Based on Low-IF Scheme

Next a second embodiment of the upconverter based on the low-IF scheme in accordance with the present invention will be described with reference to the accompanying drawings. LPFs 303 and 304, a local oscillator (Locald) 395, and a full-complex mixer 306 will be described.

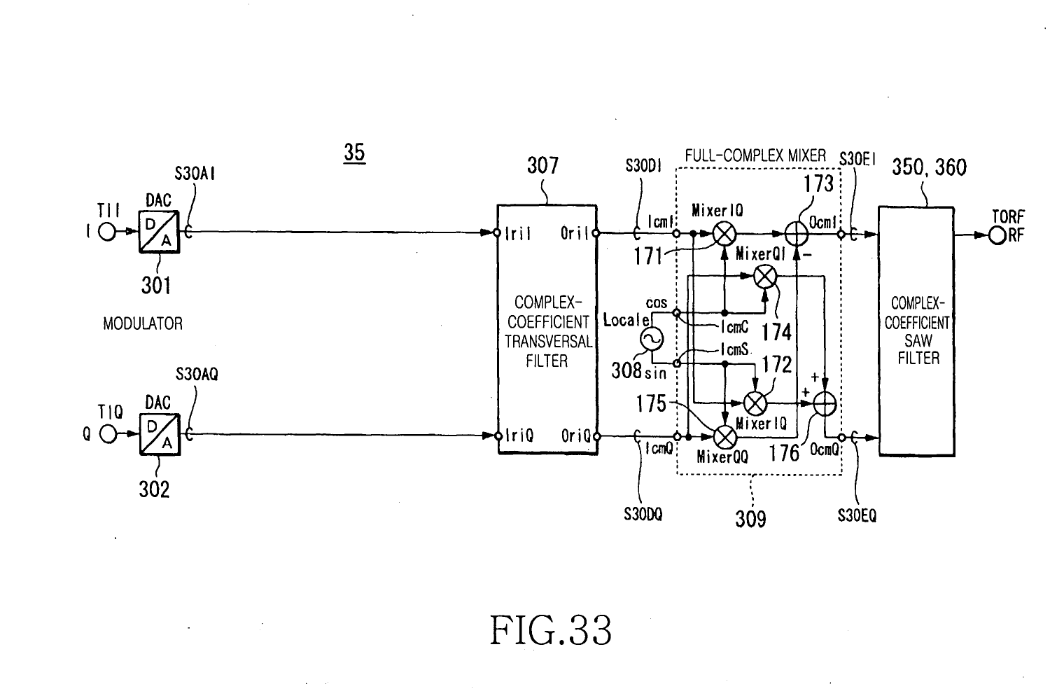

FIG. 33 is a block diagram illustrating an upconverter 35 of the low-IF scheme in this embodiment. A structure of the upconverter 35 is similar to that of FIG. 32. However, the upconverter 35 is different from the upconverter 34 of the first embodiment in that the LPFs 303 and 304 and the full-complex mixer 306 are deleted.

Next, the upconverter 35 in this embodiment will be described with reference to the accompanying drawings. The operation of the upconverter 35 in this embodiment is similar to that of the upconverter 34 in the first embodiment. However, the upconverter 35 is different from the upconverter 34 in that a frequency of a complex signal S30A is set as a frequency of an IF signal and a complex signal S30A is directly output from DACs 301 and 302 to a complex-coefficient transversal filter 307 without converting the complex signal S30A corresponding to the complex baseband signal output from the DACs 301 and 302 to a frequency of a local oscillator (Locald) 305 (or the frequency of the IF signal) in the full-complex mixer 306. That is, the upconverter 35 inputs a complex IF signal rather than the complex baseband signal from input terminals TII and TIQ.

As compared with the upconverter 34 in the first embodiment, the upconverter 35 in the second embodiment has the following merits. That is, when the complex IF signal rather than the complex baseband signal is input from the input terminals TII and TIQ, a baseband processing stage configured by the LPFs 303 and 304, the local oscillator (Locald) 305, and the full-complex mixer 306 is deleted. As compared with the upconverter 34 in the first embodiment, a compact or lightweight upconverter can be configured.

BB. Embodiment of Downconverter Based on Zero-IF Scheme or Quasi-Zero-IF Scheme

Next, an embodiment of the downconverter based on a zero-IF scheme or quasi-zero-IF scheme in accordance with the present invention will be described with reference to the accompanying drawings.

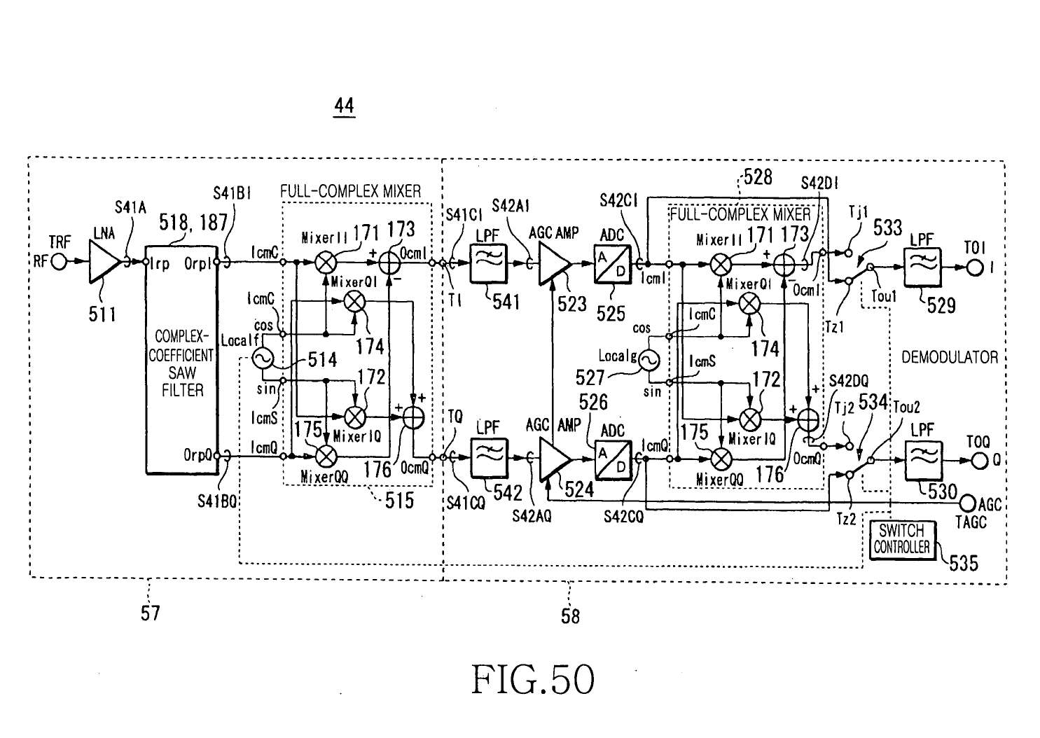

FIG. 50 is a block diagram illustrating a downconverter 44 of the zero-IF scheme or quasi-zero-IF scheme in this embodiment. The downconverter 44 is similar to that of FIG. 40. However, the structures and operations of an IF generator 57 and a baseband generator 58 are different from those of the IF generator 53 and the baseband generator 54 corresponding to the example of the basic structure.

Next, the downconverter 44 in this embodiment will be described with reference to the accompanying drawings.

The IF generator 57 is different from the IF generator 53 in the example of the basic structure in that the complex-coefficient filter 113 is replaced with a complex-coefficient SAW filter 518. In the IF generator 57, a local oscillator (Localf) 514 can output a frequency signal associated with the downconverter of the zero-IF scheme and the downconverter of the quasi-zero-IF scheme as described below. The IF generator 57 switches an oscillation frequency of the local oscillator (Localf) 514, thereby selecting a process of the downconverter of the zero-IF scheme or the quasi-zero-IF scheme.

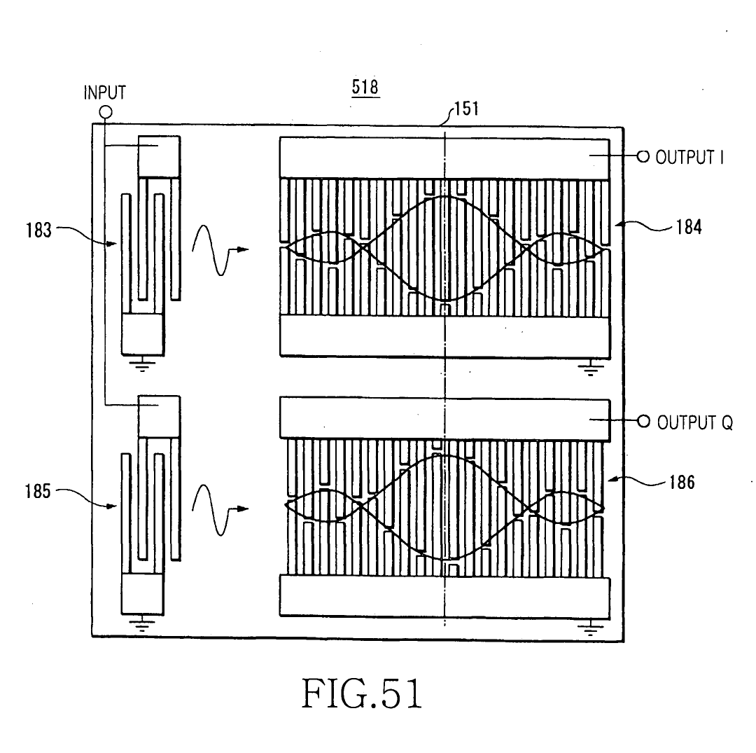

FIG. 51 illustrates a structure of the complex-coefficient SAW filter 518 of the IF generator 57 in the downconverter 44. Because the principle of an associated SAW filter is the same as that of the above-described complex-coefficient SAW filter 150, its description is omitted. Next, the structure and operation of the complex-coefficient SAW filter 518 adopted in the downconverter 44 will be described.

The complex-coefficient SAW filter 518 is configured by a piezoelectric substrate 151 and IDTs 183 to 186 in which an intersection width is different according to a position on the piezoelectric substrate 151. When the IDTs 183 and 185 commonly connected to an input terminal receive an impulse electric signal, they are mechanically distorted due to piezoelectricity and SAWs are excited and propagated in the left and right directions of the piezoelectric substrate 151. The IDT 184 is connected to an output terminal I for outputting a real part signal and is provided in a position capable of receiving the SAW from the IDT 183. The IDT 186 is connected to an output terminal Q for outputting an imaginary part signal and is provided in a position capable of receiving the SAW from the IDT 185. To perform a weighting process mapped to an impulse response of a real part, i.e., an even-symmetric impulse response, the IDT 184 is provided with an electrode finger such that even symmetry is made with respect to the envelope center. To perform a weighting process mapped to an impulse response of an imaginary part, i.e., an odd-symmetric impulse response, the IDT 186 is provided with an electrode finger such that odd symmetry is made with respect to the envelope center. According to this structure, a real RF signal can be converted to a complex RF signal with a phase difference of 90 degrees between the real part and the imaginary part.

Next, the operation of the complex-coefficient SAW filter 518 will be described. First, when a real RF signal is input to the input terminal, SAWs are excited and propagated from the IDTs 183 and 185. The SAWs propagated from the IDTs 183 and 185 are received by the IDTs 184 and 186 provided in propagation directions of the SAWs. A convolution integral is performed on the basis of impulse responses mapped to the SAWs, such that they are converted to electric signals. At this time, the IDT 184 outputs a real part signal of the RF signal through the output terminal I, and the IDT 186 outputs an imaginary part signal of the RF signal through the output terminal Q. According to this structure, a convolution integral process for the impulse responses and the input signals as illustrated in FIGS. 42 and 43 can output components of a complex signal with a phase difference of 90 degrees while suppressing a negative frequency band of a real RF signal.

Similarly, a complex signal can be output even when the IDTs 183 and 185 for which a weighting process mapped to an impulse response is performed are connected to the input terminal and the IDTs 184 and 186 are connected to the output terminals.

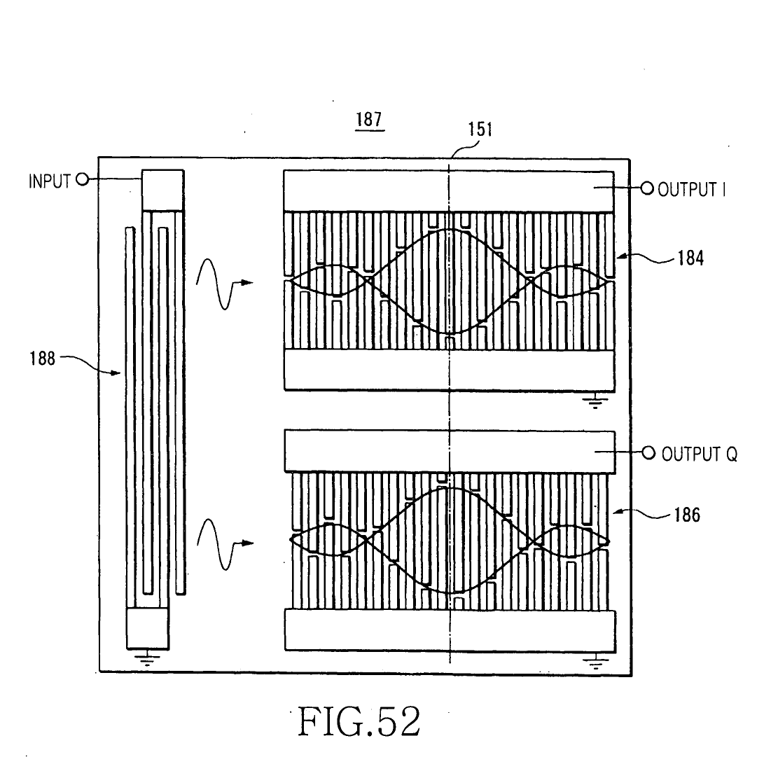

The complex-coefficient SAW filter 518 may be replaced with the complex-coefficient SAW filter 187 illustrated in FIG. 52. The complex-coefficient SAW filter 518 is provided with the two IDTs 183 and 185 in the input side. The complex-coefficient SAW filter 187 is provided with an IDT 188 of an input side placed across propagation paths of IDTs 184 and 186 connected to an output side. According to this structure, one IDT can be provided in the input side.

Again referring to FIG. 50, the baseband generator 58 is different from the baseband generator 54 of the example of the basic structure in that the complex-coefficient filter 522 is replaced with BPFs 541 and 542 and switches 533 and 534 and a switch controller 535 are added. Like the IF generator 57, the baseband generator 58 can select a process for a downconverter of the zero-IF scheme or the quasi-zero-IF scheme by performing a switching operation through the switches 533 and 534.

The switch controller 535 is connected to a control input terminal (not illustrated) of the switches 533 and 534 and controls a switching operation of the switches 533 and 534 if needed as described below. The switch controller 535 is connected to a control input terminal (not illustrated) of the local oscillator (Localf) 514 of the IF generator 57 and switches an oscillation frequency of the local oscillator (Localf) 514 according to the switching operation of the switches 533 and 534.

Here, an operation for controlling the switches 533 and 534 and the local oscillator (Localf) 514 in the switch controller 535 will be described in more detail.

The downconverter of the zero-IF scheme is best in that a structure is most simplified when a baseband signal is extracted from an RF signal as described above. To implement correct frequency conversion from an RF signal to the baseband signal, a circuit with a significantly high resolution is required. When a high-resolution frequency process cannot be performed at one time, the downconverter of the quasi-zero-IF scheme is provided to perform frequency conversion to an offset frequency, remove a component corresponding to an offset, and obtain a baseband signal. A difference between the downconverters of the zero-IF scheme and the quasi-zero-IF scheme depends upon whether the switch controller 533 can perfectly set the frequency of the local oscillator (Localf) 514 to the same value as that of the RF signal frequency or can only set the frequency of the local oscillator (Localf) 514 to a value close to the RF signal frequency for the above-described frequency conversion. The downconverter of the quasi-zero-IF scheme requires a frequency conversion circuit to remove a component corresponding to an offset.

A circuit structure is changed according to a relation between the frequency of the RF signal and a frequency capable of being set by the local oscillator (Localf) 514. As described below, the downconverter 44 is switched to the downconverter of the zero-IF scheme or the quasi-zero-IF scheme according to the switches 533 and 534, the switch controller 535, and the frequency set by the local oscillator (Localf) 514.

That is, when the downconverter 44 functions as the downconverter of the zero-IF scheme, the switch 533 is connected to a circuit such that terminals Tz1 and Tou1 are connected to each other and the switch 534 is connected to a circuit such that terminals Tz2 and Tou2 are connected to each other. In this case, a connection between the full-complex mixer 528 and the LPFs 529 and 530 is disconnected and a complex signal S42C is directly output from the ADCs 525 and 526 to the LPFs 529 and 530.

When the downconverter 44 functions as the downconverter of the quasi-zero-IF scheme, the switch 533 is connected to a circuit such that terminals Tj1 and Tou1 are connected to each other and the switch 534 is connected to a circuit such that terminals Tj2 and Tou2 are connected to each other. In this case, a connection between the full-complex mixer 528 and the LPFs 529 and 530 is disconnected and a complex signal S42D is output from the ADCs 525 and 526 to the LPFs 529 and 530 through the full-complex mixer 528.

Next, the operation of the downconverter 44 will be described. First, the operation of the downconverter based on the zero-IF scheme will be described. In the case of the downconverter based on the zero-IF scheme, the switch controller 535 first sets a coefficient in which the frequency of a signal output to the local oscillator (Localf) 514 is the same as that of the RF signal. The switch 533 is connected to a circuit such that the terminals Tz1 and Tou1 are connected to each other, and the switch 534 is connected to a circuit such that the terminals Tz2 and Tou2 are connected to each other. At this time, the full-complex mixer 528 is stopped.

The LNA 511 of the IF generator 57 receives an RF signal of a real signal from an antenna and amplifies and outputs the received RF signal to the complex-coefficient SAW filter 518 or 187. The complex-coefficient SAW filter 518 or 187 converts a real RF signal S41A amplified and output by the LNA 511 to a complex signal S41B corresponding to a complex RF signal configured by real and imaginary part signals with a phase difference of 90 degrees while suppressing a negative frequency band. The complex-coefficient SAW filter 518 or 187 outputs the complex signal S41B to the full-complex mixer 515. Here, a pass bandwidth of the complex-coefficient SAW filter 518 or 187 is set to ensure a radio system bandwidth.

The full-complex mixer 515 receives a complex local signal with a frequency equal to the frequency of the RF signal input from the local oscillator (Localf) 514, mixes the complex local signal and a real part of the complex signal S41B output from the complex-coefficient SAW filter 518 or 187, generates a complex baseband signal, and outputs a complex signal S41C corresponding to the generated signal from output terminals TI and TQ.

In the baseband generator 58, LPFs 541 and 542 band-limit the complex signal S41C input from the input terminals TI and TQ to a frequency band of a predetermined range based on the frequency zero and output a complex signal S42A corresponding to the complex baseband signal to the AGC amplifiers 523 and 524. The AGC amplifiers 523 and 524 adjust the amplitude of the complex signal S42A to levels suitable for inputs to the ADCs 525 and 526. The AGC amplifiers 523 and 524 output a complex signal to the ADCs 525 and 526. The ADCs 525 and 526 convert input signals to digital signals and then output the digital signals to the LPFs 529 and 530 through the switches 533 and 534. The LPFs 529 and 530 remove a high frequency component of the complex baseband signal, and output a real part signal I and an imaginary part signal Q of the complex baseband signal to output terminals TOI and TOQ, respectively.

Next, the operation of the downconverter based on the quasi-zero-IF scheme will be described. In the case of the downconverter based on the quasi-zero-IF scheme, the switch controller 535 first sets a coefficient in which the frequency of a signal output to the local oscillator (Localf) 514 is separated by an offset frequency from the frequency of the RF signal. The switch 533 is connected to a circuit such that the terminals Tj1 and Tou1 are connected to each other, and the switch 534 is connected to a circuit such that the terminals Tj2 and Tou2 are connected to each other.

The LNA 511 receives an RF signal of a real signal from an antenna through an input terminal TRF and amplifies and outputs the received RF signal. The complex-coefficient SAW filter 518 or 187 suppresses a negative frequency component of the real RF signal output from the LNA 511, performs conversion to a complex RF signal configured by real and imaginary part signals with a phase difference of 90 degrees, and outputs the complex signal to the full-complex mixer 515. The full-complex mixer 515 receives a complex local signal with a frequency separated by the offset frequency from the frequency of the RF signal output from the local oscillator (Localf) 514, mixes the complex local signal and the complex signal S41B output from the complex-coefficient SAW filter 518 or 187, generates a complex IF signal, and outputs a complex signal S41C corresponding to the generated signal from output terminals TI and TQ.

In the baseband generator 56, the LPFs 541 and 542 band-limit the complex signal S41C input from the input terminals TI and TQ to a frequency band of a predetermined range based on the center of the offset frequency and output a complex IF signal to the AGC amplifiers 523 and 524. The AGC amplifiers 523 and 524 adjust the amplitude of the complex signal to levels suitable for inputs to the ADCs 525 and 526. The AGC amplifiers 523 and 524 output a complex signal to the ADCs 525 and 526. The ADCs 525 and 526 convert input signals to a complex signal S42C corresponding to digital signals and then output the digital signals to the full-complex mixer 528.

The full-complex mixer 528 performs frequency conversion to a complex baseband signal whose center frequency is DC according to a complex local signal of a frequency C2 output from a local oscillator (Localh) 527, and outputs a complex signal S42D corresponding to a complex baseband signal after conversion to the LPFs 529 and 530 through the switches 533 and 534. The LPFs 529 and 530 remove a high frequency component of the complex signal S42D corresponding to the complex baseband signal, perform a waveform shaping process, and output a real part component I and an imaginary part component Q of the complex baseband signal to output terminals TOI and TOQ, respectively.

The structure of the downconverter 44 can perform both the zero-IF scheme and the quasi-zero-IF scheme in a small space. For example, the downconverter 44 can be applied to a mobile terminal requiring both the zero-IF scheme and the quasi-zero-IF scheme.

In the downconverter 44, EVM-related degradation may occur due to an error between I and Q signals occurring in the LPFs 541 and 542 and the ADCs 525 and 526. This error is not associated with the operation of the complex-coefficient SAW filter 518 or 187 and the full-complex mixer 528. The error can be avoided by employing means for compensating for the error between real and imaginary part signals according to a conventional digital signal process.

CC. Embodiment of Upconverter Based on Zero-IF Scheme or Quasi-Zero-IF Scheme

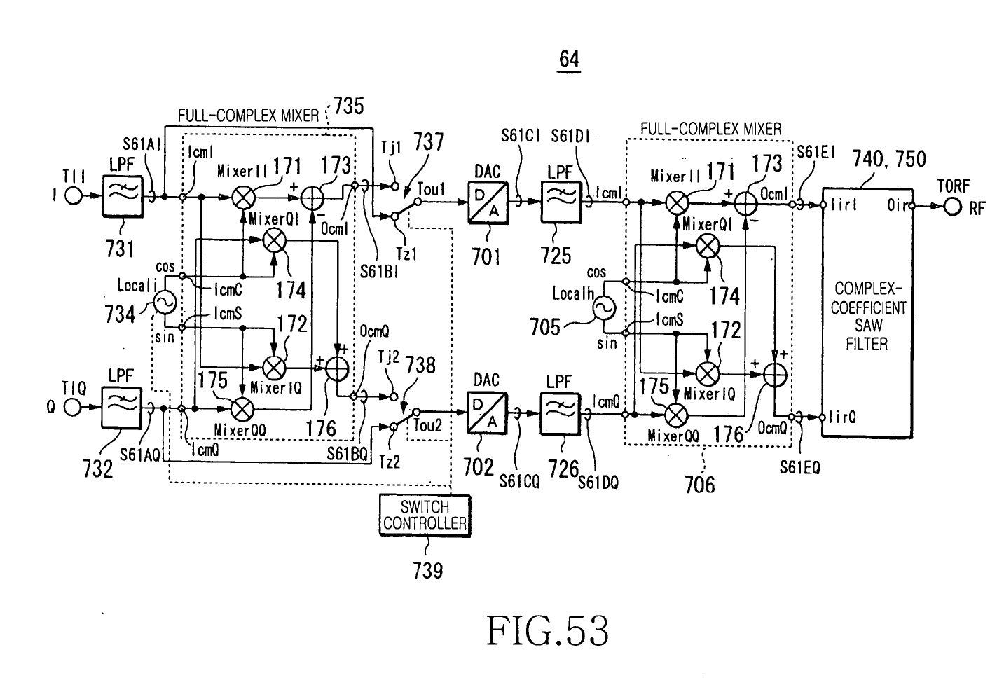

Next, an embodiment of an upconverter based on a zero-IF scheme or a quasi-zero-IF scheme in the present invention will be described with reference to the accompanying drawings. FIG. 53 is a block diagram illustrating a structure of an upconverter 64 of the zero-IF scheme or the quasi-zero-IF scheme in this embodiment. The upconverter 64 is similar to that of FIG. 49. However, the structure and operation of the upconverter 64 are different from those of the upconverter 63 of the quasi-zero-IF scheme corresponding to the example of the basic structure.

Next, the upconverter 64 in this embodiment will be described with reference to the accompanying drawings.

The upconverter 64 is different from the upconverter 63 in the example of the basic structure in that switches 737 and 738 and a switch controller 739 are added, a local oscillator (Locali) 734 outputs a frequency signal based on the upconverter of the zero-IF scheme or the quasi-zero-IF scheme, and the complex-coefficient filter 709 is replaced with a complex-coefficient SAW filter 740. The upconverter 64 can select a process for the upconverter of the zero-IF scheme or the quasi-zero-IF scheme by switching an oscillation frequency of the local oscillator (Locali) 734 and switching the switches 737 and 738.

The switch controller 739 is connected to a control input terminal (not illustrated) of the switches 737 and 738 and controls a switching operation of the switches 737 and 738 if needed as described below. The switch controller 739 is connected to a control input terminal (not illustrated) of the local oscillator (Locali) 734 and switches an oscillation frequency of the local oscillator (Locali) 734 according to the switching operation of the switches 737 and 738.

Here, an operation for controlling the switches 737 and 738 and the local oscillator (Locali) 734 in the switch controller 739 will be described in more detail. The upconverter of the zero-IF scheme is best in that a structure is most simplified when an RF signal is extracted from a baseband signal as described above. To implement correct frequency conversion from the baseband signal to the RF signal, a circuit with a significantly high resolution is required. When a high-resolution frequency process cannot be performed at a given time, the structure of the upconverter of the quasi-zero-IF scheme is similar to that of the downconverter of the quasi-zero-IF scheme. The upconverter of the quasi-zero-IF scheme performs a frequency conversion process for obtaining an RF signal from a frequency based on an offset, after frequency-converting the baseband signal to the frequency based on the offset corresponding to a frequency close to DC in a digital process.

Here, a difference between the upconverters of the zero-IF scheme and the quasi-zero-IF scheme depends upon whether the switch controller 739 can perfectly set the frequency of the local oscillator (Locali) 734 to the same value as that of the RF signal frequency or can only set the frequency of the local oscillator (Locali) 734 to a value close to the RF signal frequency for the above-described frequency conversion. The upconverter of the quasi-zero-IF scheme requires a circuit for frequency-converting the baseband signal to the frequency based on the offset.

Moreover, a difference between the upconverters of the zero-IF scheme and the quasi-zero-IF scheme depends upon whether an input signal band is across frequency zero. That is, a band of a signal input to the upconverter of the quasi-zero IF scheme is across the frequency zero, and a band of a signal input to the upconverter of the zero-IF scheme is not across the frequency zero.

For this reason, a circuit structure is changed according to a relation between the frequency of the RF signal and a frequency capable of being set by the local oscillator (Locali) 734. As described below, the upconverter 64 is switched to the upconverter of the zero-IF scheme or the quasi-zero-IF scheme according to the switches 737 and 738, the switch controller 739, and the frequency set by the local oscillator (Locali) 734.

That is, when the upconverter 64 functions as the upconverter of the zero-IF scheme, the switch 737 is connected to a circuit such that terminals Tz1 and Tou1 are connected to each other and the switch 738 is connected to a circuit such that terminals Tz2 and Tou2 are connected to each other. In this case, a connection between the full-complex mixer 735 and the DACs 701 and 702 is disconnected and a complex signal S61A is directly output from the LPFs 731 and 732 to the DACs 701 and 702.

When the upconverter 64 functions as the upconverter of the quasi-zero-IF scheme, the switch 737 is connected to a circuit such that terminals Tj1 and Tou1 are connected to each other and the switch 738 is connected to a circuit such that terminals Tj2 and Tou2 are connected to each other. In this case, a connection between the full-complex mixer 735 and the DACs 701 and 702 is disconnected and a complex signal S61B is output from the LPFs 731 and 732 to the DACs 701 and 702 through the full-complex mixer 735.

The upconverter 64 is provided with a structure of the upconverter 60 based on the zero-IF scheme and a structure of the upconverter 63 based on the quasi-zero-IF scheme.

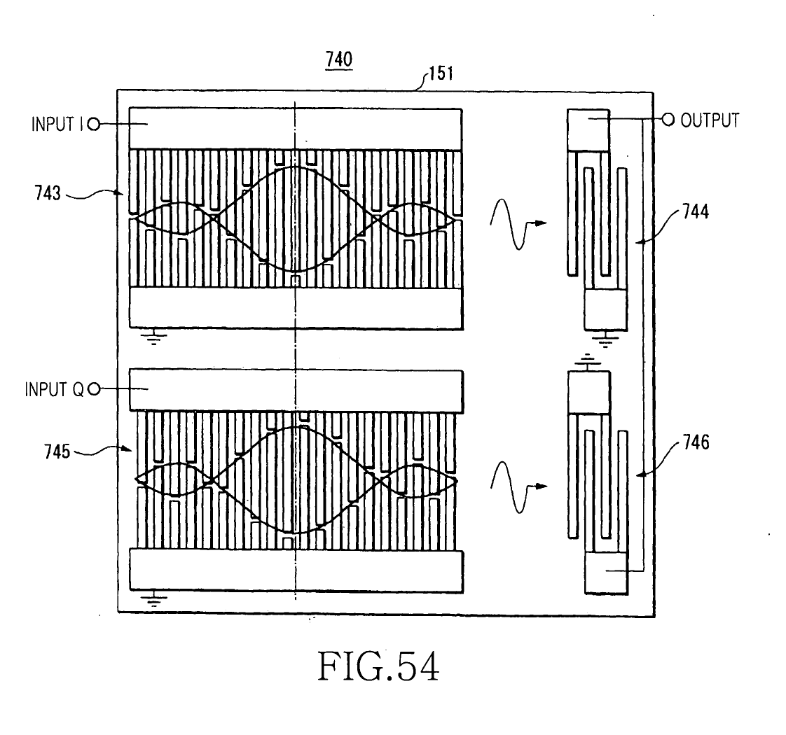

FIG. 54 illustrates a structure of the complex-coefficient SAW filter 740 of the upconverter 64. Because the principle of an associated SAW filter is the same as that of the above-described complex-coefficient SAW filter 360, its description is omitted. Next, the structure and operation of the complex-coefficient SAW filter 740 adopted in the upconverter 64 will be described.

The complex-coefficient SAW filter 740 is configured by a piezoelectric substrate 151 and IDTs 743 to 746 in which an intersection width is different according to a position on the piezoelectric substrate 151. The IDT 743 is connected to an input terminal I for receiving a real part signal and the IDT 745 is connected to an input terminal Q for receiving an imaginary part signal. When an impulse electric signal is received, the IDTs 734 and 735 are mechanically distorted due to piezoelectricity and SAWs are excited and propagated in the left and right directions of the piezoelectric substrate 151. To perform a weighting process mapped to an impulse response of a real part, i.e., an even-symmetric impulse response, the IDT 743 is provided with an electrode finger such that even symmetry is made with respect to the envelope center. To perform a weighting process mapped to an impulse response of an imaginary part, i.e., an odd-symmetric impulse response, the IDT 745 is provided with an electrode finger such that odd symmetry is made with respect to the envelope center. The IDT 744 is provided in a position capable of receiving the SAW from the IDT 743. The IDT 746 is provided in a position capable of receiving the SAW from the IDT 745. The IDTs 744 and 746 are commonly connected to an output terminal. Because the IDTs 744 and 746 are connected such that they have a reverse phase to each other, an imaginary part signal is subtracted from a real part signal and a real RF signal is output from the output terminal. Accordingly, the complex RF signal is converted to a real RF signal with a phase difference of 90 degrees between the real and imaginary parts.

Next, the operation of the complex-coefficient SAW filter 740 will be described. First, when a complex RF signal is input to the input terminals, SAWs are excited and propagated from the IDTs 743 and 745 while a convolution integral is performed on the basis of impulse responses. The SAWs propagated from the IDTs 743 and 745 are received by the IDTs 744 and 746 provided in propagation directions. The SAWs are converted to electric signals. At this time, the IDT 744 outputs a real part signal of the RF signal, and the IDT 746 outputs an imaginary part signal of the RF signal whose polarity is inverted. When the polarity of the output of the IDT 746 mapped to the imaginary part of the output side is inverted, the imaginary part signal is subtracted from the real part signal of the RF signal, such that a real RF signal is output from the output terminal.

According to this structure, a convolution integration process for the impulse responses and the complex RF signal as illustrated in FIGS. 42 and 43 can output a real RF signal with a phase difference of 90 degrees while suppressing a negative frequency band of the complex RF signal.

In the output sides of the complex-coefficient SAW filters 518 and 187 as illustrated in FIGS. 51 and 52, the two IDTs 184 and 186 for which a weighting process of an impulse response is made are provided. In the complex-coefficient SAW filter 740 as illustrated in FIG. 54, the input side is connected to the IDTs 743 and 745 for which a weighting process of an impulse response is made and the output terminal of the output side is connected to the IDTs 744 and 746 provided on the propagation paths of the IDTs 743 and 745. Here, a real RF signal can be output even when the output terminal is connected to the IDTs 744 and 746 for which a weighting process of an impulse response is made and the input terminals are connected to the IDTs 743 and 745.

The inverse polarity is not limited to the IDT 746 of the imaginary part, but the polarity of the IDT 744 of the real part may be inverted.

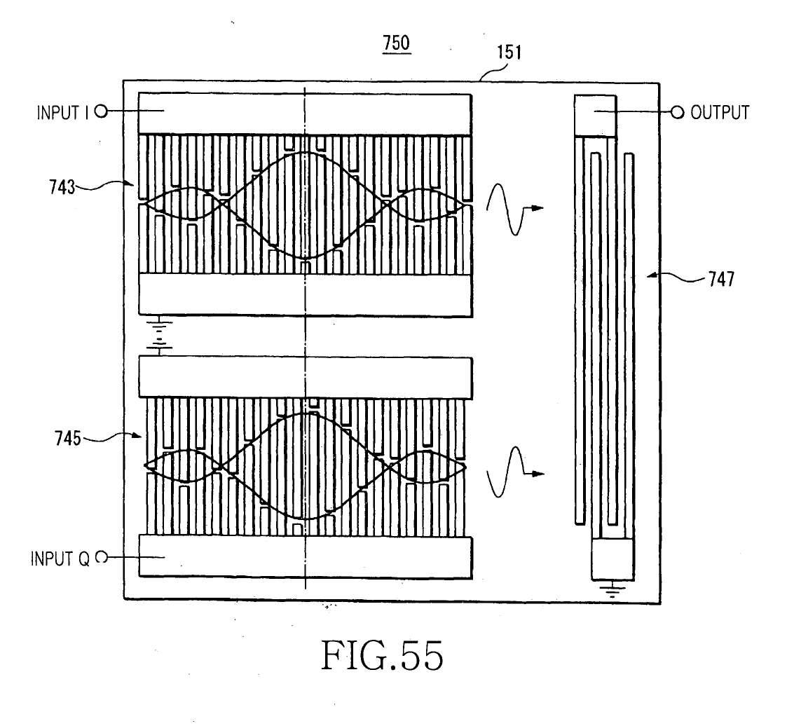

The complex-coefficient SAW filter 740 may be replaced with the complex-coefficient SAW filter 750 illustrated in FIG. 55. The complex-coefficient SAW filter 740 is provided with the two IDTs 744 and 745 in the output side. The complex-coefficient SAW filter 750 is provided with an IDT 747 of an output side placed across propagation paths of IDTs 743 and 745 connected to an input side. The SAW filter 750 is different from the SAW filter 740 in that the polarity of the IDT 745 of the SAW filter 750 is inverted in the input side of the imaginary part signal. According to this structure, one IDT can be provided in the output side.

Next, the operation of the upconverter 64 will be described. First, the operation of the upconverter based on the zero-IF scheme will be described. In the case of the upconverter based on the zero-IF scheme, the switch controller 739 first sets a coefficient in which the frequency of a signal output to the local oscillator (Locali) 734 is the same as that of the RF signal. The switch 737 is connected to a circuit such that the terminals Tz1 and Tou1 are connected to each other, and the switch 738 is connected to a circuit such that the terminals Tz2 and Tou2 are connected to each other. At this time, the full-complex mixer 735 is stopped.

The LPFs 731 and 732 remove a high-frequency component from a digital baseband signal input from the input terminals TII and TIQ and perform a waveform shaping process. The DACs 701 and 702 perform conversion to a complex signal S61C corresponding to an analog signal. The LPFs 725 and 726 remove a high-frequency component from the complex signal S61C and perform a waveform shaping process.

The full-complex mixer 706 frequency-converts a complex signal on the basis of a complex local signal with the same frequency as that of the RF signal input from the local oscillator (Localh) 705, and outputs a complex signal S61E corresponding to a complex RF signal with the frequency of the RF signal to the complex-coefficient SAW filter 740 or 750.

The complex-coefficient SAW filter 740 or 750 generates real and imaginary part signals of a complex RF signal while suppressing a negative frequency of the complex RF signal, subtracts the imaginary part signal from the real part signal, and outputs a real RF signal. Here, a pass bandwidth of the complex-coefficient SAW filter 740 or 750 is set to ensure a radio system bandwidth.

Next, the case where the upconverter 62 operates as the upconverter of the quasi-zero-IF scheme will be described. In the upconverter of the quasi-zero-IF scheme, a switch controller 739 first sets a coefficient in which the frequency of a signal output to the local oscillator (Locali) 734 is separated by an offset frequency from the frequency of the RF signal. The switch 737 is connected to a circuit such that the terminals Tj1 and Tou1 are connected to each other, and the switch 738 is connected to a circuit such that the terminals Tj2 and Tou2 are connected to each other.

The LPFs 720 and 721 remove a high-frequency component from a real part signal of a digital signal input from the input terminals TII and TIQ, perform a waveform shaping process, and output a complex signal to the full-complex mixer 735.

The full-complex mixer 735 performs a frequency conversion process in which an offset frequency is a center frequency according to a complex local signal of a frequency D2 output from the local oscillator (Locali) 734, and outputs a complex signal S61B corresponding to a complex IF signal to the DACs 701 and 702.

The DACs 701 and 702 convert the complex signal S61B output from the full-complex mixer 735 to an analog signal, and generate and output a complex signal S61C corresponding to an analog complex IF signal to the LPFs 725 and 726. The LPFs 725 and 726 remove a high-frequency component from the complex signal S61C, perform a waveform shaping process, and output a process result to the full-complex mixer 706.

The full-complex mixer 706 frequency-converts the complex signal S61D on the basis of a complex local signal with the frequency D1, separated by the offset frequency from the RF signal frequency, output from the local oscillator (Localh) 705, and outputs a complex signal S61E corresponding to a complex RF signal with an RF signal frequency to the complex-coefficient SAW filter 740 or 750. The complex-coefficient SAW filter 740 or 750 subtracts an imaginary part from a real part of the complex signal S61E while suppressing the negative frequency of the complex signal S61E, and extracts a real RF signal.

The structure of the upconverter 64 can have both functions of the zero-IF scheme and the quasi-zero-IF scheme in a small space. For example, the upconverter 64 can be applied to a mobile terminal requiring both the zero-IF scheme and the quasi-zero-IF scheme.

In the upconverter 64, EVM-related degradation may occur due to an error between real and imaginary part signals occurring in the DACs 701 and 702 and the LPFs 725 and 726. This error is not associated with the operation of the complex-coefficient SAW filter 740 or 750 and the full-complex mixer 706. The error can be avoided by employing means for compensating for the error between real and imaginary part signals according to a conventional digital signal process.

If flat group delay characteristics are required for the complex-coefficient transversal filter, an impulse response used for the complex-coefficient transversal filter must be exactly an even or odd symmetric impulse response. However, if flat group delay characteristics are not required, an asymmetric impulse response can also be accepted.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1. A downconverter for downconverting a Radio Frequency (RF) signal to a low frequency, comprising:
a complex-coefficient transversal filter for generating a real part of a complex RF signal by performing a convolution integral according to a generated impulse response based on an even function for an input RF signal, generating an imaginary part of the complex RF signal by performing a convolution integral according to a generated impulse response based on an odd function for the input RF signal, rejecting one side of a positive or negative frequency, and outputting the complex RF signal;
a local oscillator for outputting a complex local signal at a set frequency; and
a complex mixer, connected to the complex-coefficient transversal filter and the local oscillator, for performing a frequency conversion process by multiplying the complex RF signal output from the complex-coefficient transversal filter and the complex local signal output from the local oscillator, and outputting a complex signal of a frequency separated by the set frequency from a frequency of the RF signal.

2. The downconverter of claim 1, wherein the complex-coefficient transversal filter is a Surface Acoustic Wave (SAW) filter.

3. The downconverter of claim 1, wherein the set frequency has a frequency value out of a channel signal band of the RF signal.

4. The downconverter of claim 3, further comprising:
a frequency converter for downconverting the frequency of the RF signal and outputting a conversion result to the complex-coefficient transversal filter.

5. The downconverter of claim 3, further comprising:
a second complex-coefficient transversal filter, connected to the complex mixer, for rejecting a positive or negative frequency of the complex signal output from the complex mixer and outputting a rejection result.

6. The downconverter of claim 4, further comprising:
a second complex-coefficient transversal filter, connected to the complex mixer, for rejecting a positive or negative frequency of the complex signal output from the complex mixer and outputting a rejection result.

7. The downconverter of claim 5, wherein the second complex-coefficient transversal filter is a SAW filter.

8. The downconverter of claim 6, wherein the second complex coefficient transversal filter is a SAW filter.

9. The downconverter of claim 5, further comprising:
means for inverting a sign of an imaginary part signal of the complex signal output from the complex mixer, and generating a complex conjugate signal corresponding to a complex conjugate of the complex signal;
means for adjusting a level of the complex conjugate signal such that amplitude and phase relations between the complex signal and the complex conjugate signal are uniform; and
means for combining the complex signal output from the complex mixer and the complex conjugate signal whose level is adjusted.

10. The downconverter of claim 7, further comprising:
means for inverting a sign of an imaginary part signal of the complex signal output from the complex mixer, and generating a complex conjugate signal corresponding to a complex conjugate of the complex signal;
means for adjusting a level of the complex conjugate signal such that amplitude and phase relations between the complex signal and the complex conjugate signal are uniform; and
means for combining the complex signal output from the complex mixer and the complex conjugate signal whose level is adjusted.

11. The downconverter of claim 5, wherein the frequency separated by the set frequency from the frequency of the RF signal is set to a frequency of more than a half value of a difference between a frequency of a pass band end of the complex-coefficient transversal filter and the RF signal frequency.

12. The downconverter of claim 7, wherein the frequency separated by the set frequency from the frequency of the RF signal is set to a frequency of more than a half value of a difference between a frequency of a pass band end of the complex-coefficient transversal filter and the RF signal frequency.

13. The downconverter of claim 9, wherein the frequency separated by the set frequency from the frequency of the RF signal is set to a frequency of more than a half value of a difference between a frequency of a pass band end of the complex-coefficient transversal filter and the RF signal frequency.

14. An upconverter for converting a complex signal to a frequency of a Radio Frequency (RF) signal, comprising:
a local oscillator for outputting a complex local signal with a predetermined frequency;
a complex mixer, connected to the local oscillator, for performing a frequency conversion process by multiplying an input complex signal and the complex local signal output from the local oscillator, and outputting a complex RF signal; and
a complex-coefficient transversal filter, connected to the complex mixer, for performing a convolution integral according to a generated impulse response based on an even function for a real part of the complex RF signal output from the complex mixer, performing a convolution integral according to a generated impulse response based on an odd function for an imaginary part of the complex RF signal output from the complex mixer, rejecting one side of a positive or negative frequency, and outputting a real RF signal.

15. The upconverter of claim 14, wherein the complex-coefficient transversal filter is a Surface Acoustic Wave (SAW) filter.

16. The upconverter of claim 14, wherein a center frequency of the complex signal is a difference between a value of the RF signal frequency and a value of the set frequency, and wherein a value obtained by adding a value of the difference to the RF signal frequency is out of a channel signal band of the RF signal.

17. The upconverter of claim 15, wherein a center frequency of the complex signal is a difference between a value of the RF signal frequency and a value of the set frequency, and wherein a value obtained by adding a value of the difference to the RF signal frequency is out of a channel signal band of the RF signal.

18. The upconverter of claim 16, further comprising:
a second complex-coefficient transversal filter, connected to an input side of the complex mixer, for generating a real part of a complex signal by performing a convolution integral according to a generated impulse response based on an even function for the real part of an input complex signal, generating an imaginary part of the complex signal by performing a convolution integral according to a generated impulse response based on an odd function for the imaginary part of the input complex signal, rejecting one side of a positive or negative frequency, and outputting the complex signal to the complex mixer.

19. The upconverter of claim 16, wherein the second complex-coefficient transversal filter is a Surface Acoustic Wave (SAW) filter.

20. The upconverter of claim 18, wherein the second complex-coefficient transversal filter is a Surface Acoustic Wave (SAW) filter.
